(19) United States
(12) Patent Application Publication
(10) Pub. No.: US 2022/0067356 A1
(43) Pub. Date: Mar. 3, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Tadashi SUTO, Kanagawa (JP); Kengo TOKUCHI, Kanagawa (JP)

(73) Assignee: FUJIFILM Business Innovation Corp., Tokyo (JP)

(21) Appl. No.: 17/155,096

(22) Filed: Jan. 22, 2021

(30) Foreign Application Priority Data
Sep. 2, 2020 (JP) 2020-147771

(51) Int. Cl. G06K 9/00; G06T 7/20; G06T 7/70

(52) U.S. Cl. CPC G06K 9/00355; G06K 9/00664; G06T 19/006; G06T 7/70; G06T 7/20

(57) ABSTRACT

An information processing apparatus includes a processor configured to detect a command for a thickness or a density of a line or a group of lines being rendered while a user is rendering the line or the group of lines in midair by using a gesture, and store the detected thickness or the detected density in association with a trajectory.

### CROSS-REFERENCE TO RELATED APPLICATIONS

This application is based on and claims priority under 35 USC 119 from Japanese Patent Application No. 2020-147771 filed Sep. 2, 2020.

### BACKGROUND

### (i) Technical Field

The present disclosure relates to information processing apparatuses and non-transitory computer readable media.

### (ii) Related Art

A known technology involves detecting the trajectory of a fingertip moving in midair as an input to an augmented reality (AR) space. In this case, the trajectory of the fingertip is stored in association with coordinate points in the space. For example, see Japanese Unexamined Patent Application Publication No. 2016-45670.

### SUMMARY

When the detected trajectory of the fingertip is to be displayed on a display device, the detected trajectory of the fingertip is expressed with a thickness set in advance. In other words, the detected trajectory of the fingertip is expressed with a uniform line.

Aspects of non-limiting embodiments of the present disclosure relate to adjustability of the setting for each segment of a line or a group of lines when a user renders the line or the group of lines in midair by using a gesture.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to detect a command for a thickness or a density of a line or a group of lines being rendered while a user is rendering the line or the group of lines in midair by using a gesture, and store the detected thickness or the detected density in association with a trajectory.

### BRIEF DESCRIPTION OF THE DRAWINGS

Exemplary embodiments of the present disclosure will be described in detail based on the following figures, wherein:

FIG. 1 illustrates a usage example of a portable terminal according to a first exemplary embodiment;

FIG. 2 illustrates an example of a hardware configuration of the portable terminal used in the first exemplary embodiment;

FIG. 3 is a flowchart illustrating an example of a process executed in the portable terminal used in the first exemplary embodiment;

FIGS. 4A to 4C each illustrate a first specific example of a gesture used as a command for the thickness of a line to be rendered in the first exemplary embodiment, FIG. 4A illustrating an example of a gesture used as a command for a “thin line”, FIG. 4B illustrating an example of a gesture used as a command for a “medium-thick line”, FIG. 4C illustrating an example of a gesture used as a command for a “thick line”;

FIG. 5 illustrates an example of an AR image rendered when variations in the number of fingers are combined while the index finger is moved in midair;

FIG. 6 illustrates another example of an AR image rendered when variations in the number of fingers are combined while the index finger is moved in midair;

FIGS. 7A to 7C each illustrate a second specific example of a gesture used as a command for the thickness of a line to be rendered in the first exemplary embodiment, FIG. 7A illustrating an example of a gesture used as a command for a “thin line”, FIG. 7B illustrating an example of a gesture used as a command for a “medium-thick line”, FIG. 7C illustrating an example of a gesture used as a command for a “thick line”;

FIGS. 8A to 8C each illustrate another example in the first exemplary embodiment in a case where a command for the thickness of a line is given in accordance with the degree of opening between multiple fingers, FIG. 8A illustrating an example of a gesture used as a command for a “thin line”, FIG. 8B illustrating an example of a gesture used as a command for a “medium-thick line”, FIG. 8C illustrating an example of a gesture used as a command for a “thick line”;

FIGS. 9A to 9C each illustrate a third specific example of a gesture used as a command for the thickness of a line to be rendered in the first exemplary embodiment, FIG. 9A illustrating an example of a gesture used as a command for a “thin line”, FIG. 9B illustrating an example of a gesture used as a command for a “medium-thick line”, FIG. 9C illustrating an example of a gesture used as a command for a “thick line”;

FIGS. 10A to 10C each illustrate a fourth specific example of a gesture used as a command for the thickness of a line to be rendered in the first exemplary embodiment, FIG. 10A illustrating an example of a gesture used as a command for a “thin line”, FIG. 10B illustrating an example of a gesture used as a command for a “medium-thick line”, FIG. 10C illustrating an example of a gesture used as a command for a “thick line”;

FIGS. 11A to 11C each illustrate a fifth specific example of a gesture used as a command for the thickness of a line to be rendered in the first exemplary embodiment, FIG. 11A illustrating an example of a gesture used as a command for a “thin line”, FIG. 11B illustrating an example of a gesture used as a command for a “medium-thick line”, FIG. 11C illustrating an example of a gesture used as a command for a “thick line”;

FIGS. 12A to 12C each illustrate a sixth specific example of a gesture used as a command for the thickness of a line to be rendered in the first exemplary embodiment, FIG. 12A illustrating an example of a gesture used as a command for a “thin line”, FIG. 12B illustrating an example of a gesture used as a command for a “medium-thick line”, FIG. 12C illustrating an example of a gesture used as a command for a “thick line”;

FIGS. 13A to 13C each illustrate another example in the first exemplary embodiment in a case where a command for the thickness of a line is given in accordance with the degree of inclination of the index finger in the imaging direction, FIG. 13A illustrating an example of a gesture used as a command for a “thin line”, FIG. 13B illustrating an example of a gesture used as a command for a “medium-thick line”, FIG. 13C illustrating an example of a gesture used as a command for a “thick line”;

FIGS. 14A to 14C each illustrate a seventh specific example of a gesture used as a command for the thickness of a line to be rendered in the first exemplary embodiment, FIG. 14A illustrating an example of a gesture used as a command for a “thin line”, FIG. 14B illustrating an example of a gesture used as a command for a “medium-thick line”, FIG. 14C illustrating an example of a gesture used as a command for a “thick line”;

FIGS. 15A to 15C each illustrate an eighth specific example of a gesture used as a command for the thickness of a line to be rendered in the first exemplary embodiment, FIG. 15A illustrating an example of a gesture used as a command for a “thin line”, FIG. 15B illustrating an example of a gesture used as a command for a “medium-thick line”, FIG. 15C illustrating an example of a gesture used as a command for a “thick line”;

FIGS. 16A to 16C each illustrate a ninth specific example of a gesture used as a command for the thickness of a line to be rendered in the first exemplary embodiment, FIG. 16A illustrating an example of a gesture used as a command for a “thin line”, FIG. 16B illustrating an example of a gesture used as a command for a “medium-thick line”,

FIG. 16C illustrating an example of a gesture used as a command for a “thick line”;

FIG. 17 illustrates a usage example of a portable terminal according to a second exemplary embodiment;

FIGS. 18A to 18C each illustrate a first specific example of a gesture used as a command for the thickness of a line to be rendered in the second exemplary embodiment, FIG. 18A illustrating an example of a gesture used as a command for a “thin line”, FIG. 18B illustrating an example of a gesture used as a command for a “medium-thick line”, FIG. 18C illustrating an example of a gesture used as a command for a “thick line”;

FIG. 19 illustrates an example of a hardware configuration of a portable terminal used in a third exemplary embodiment;

FIG. 20 is a flowchart illustrating an example of a process executed in the portable terminal used in the third exemplary embodiment;

FIGS. 21A to 21C each illustrate a first specific example of feedback used in the third exemplary embodiment, FIG. 21A illustrating an example of a gesture used as a command for a “thin line”, FIG. 21B illustrating an example of a gesture used as a command for a “medium-thick line”, FIG. 21C illustrating an example of a gesture used as a command for a “thick line”;

FIGS. 22A to 22C each illustrate a second specific example of feedback used in the third exemplary embodiment, FIG. 22A illustrating an example of a gesture used as a command for a “thin line”, FIG. 22B illustrating an example of a gesture used as a command for a “medium-thick line”, FIG. 22C illustrating an example of a gesture used as a command for a “thick line”;

FIGS. 23A to 23F illustrate other specific examples of feedback, FIG. 23A illustrating an example of feedback using a belt buckle, FIG. 23B illustrating an example of feedback using a device worn on the stomach, a device worn around an arm, and a device worn around a leg, FIG. 23C illustrating an example of feedback using a shoe, FIG. 23D illustrating an example of feedback using a device worn around the wrist, FIG. 23E illustrating an example of feedback using a device worn on a finger, FIG. 23F illustrating an example of feedback using a device worn around the neck;

FIG. 24 illustrates an example of a hardware configuration of a portable terminal used in a fourth exemplary embodiment;

FIGS. 25A to 25C each illustrate a first specific example of a gesture used as a command for the thickness of a line to be rendered in the fourth exemplary embodiment, FIG. 25A illustrating an example of a gesture used as a command for a “thin line”, FIG. 25B illustrating an example of a gesture used as a command for a “medium-thick line”, FIG. 25C illustrating an example of a gesture used as a command for a “thick line”;

FIG. 26 illustrates a usage example of the portable terminal according to the fourth exemplary embodiment;

FIG. 27 is a flowchart illustrating an example of a process executed in a portable terminal used in a fifth exemplary embodiment;

FIGS. 28A to 28C each illustrate a specific example of a gesture used as a command for the density of a line to be rendered in the fifth exemplary embodiment, FIG. 28A illustrating an example of a gesture used as a command for a “faint line”, FIG. 28B illustrating an example of a gesture used as a command for a “slightly dark line”, FIG. 28C illustrating an example of a gesture used as a command for a “dark line”;

FIG. 29 illustrates an example of an AR image rendered when variations in the number of fingers are combined while the index finger is moved in midair;

FIG. 30 illustrates a usage example of a portable terminal according to a sixth exemplary embodiment;

FIGS. 31A to 31C each illustrate a first specific example of a gesture used as a command for the thickness of a line to be rendered in the sixth exemplary embodiment, FIG. 31A illustrating an example of a gesture used as a command for a “thin line”, FIG. 31B illustrating an example of a gesture used as a command for a “medium-thick line”, FIG. 31C illustrating an example of a gesture used as a command for a “thick line”;

FIGS. 32A to 32C each illustrate a second specific example of a gesture used as a command for the thickness of a line to be rendered in the sixth exemplary embodiment, FIG. 32A illustrating an example of a gesture used as a command for a “thin line”, FIG. 32B illustrating an example of a gesture used as a command for a “medium-thick line”, FIG. 32C illustrating an example of a gesture used as a command for a “thick line”;

FIGS. 33A to 33C each illustrate another example of a gesture used as a command for the thickness of a line to be rendered in the sixth exemplary embodiment, FIG. 33A illustrating an example of a gesture used as a command for a “thin line”, FIG. 33B illustrating an example of a gesture used as a command for a “medium-thick line”, FIG. 33C illustrating an example of a gesture used as a command for a “thick line”;

FIG. 34 illustrates a usage example of a portable terminal according to a seventh exemplary embodiment;

FIG. 35 illustrates a usage example of a portable terminal according to an eighth exemplary embodiment;

FIG. 36 illustrates a usage example of a portable terminal according to a ninth exemplary embodiment;

FIGS. 37A to 37C each illustrate a first specific example of a gesture used as a command for the thickness of a line to be rendered in the ninth exemplary embodiment, FIG. 37A illustrating an example of a gesture used as a command for a “thin line”, FIG. 37B illustrating an example of a gesture used as a command for a “medium-thick line”, FIG. 37C illustrating an example of a gesture used as a command for a “thick line”;

FIGS. 38A to 38C each illustrate a second specific example of a gesture used as a command for the thickness of a line to be rendered in the ninth exemplary embodiment, FIG. 38A illustrating an example of a gesture used as a command for a “thin line”, FIG. 38B illustrating an example of a gesture used as a command for a “medium-thick line”, FIG. 38C illustrating an example of a gesture used as a command for a “thick line”;

FIGS. 39A to 39C each illustrate a third specific example of a gesture used as a command for the thickness of a line to be rendered in the ninth exemplary embodiment, FIG. 39A illustrating an example of a gesture used as a command for a “thin line”, FIG. 39B illustrating an example of a gesture used as a command for a “medium-thick line”, FIG. 39C illustrating an example of a gesture used as a command for a “thick line”;

FIG. 40 illustrates a usage example of a portable terminal according to a tenth exemplary embodiment;

FIG. 41 is a flowchart illustrating an example of a process executed in the portable terminal used in the tenth exemplary embodiment;

FIGS. 42A to 42C each illustrate a specific example of a gesture used as a command for the thickness of a line to be rendered in the tenth exemplary embodiment, FIG. 42A illustrating an example of a gesture used as a command for a “thin line”, FIG. 42B illustrating an example of a gesture used as a command for a “medium-thick line”, FIG. 42C illustrating an example of a gesture used as a command for a “thick line”;

FIG. 43 illustrates a usage example of a portable terminal according to an eleventh exemplary embodiment;

FIGS. 44A to 44C each illustrate a specific example of a gesture used as a command for the thickness of a line to be rendered in the eleventh exemplary embodiment, FIG. 44A illustrating an example of a gesture used as a command for a “thin line”, FIG. 44B illustrating an example of a gesture used as a command for a “medium-thick line”, FIG. 44C illustrating an example of a gesture used as a command for a “thick line”;

FIG. 45 illustrates a usage example of a portable terminal according to a twelfth exemplary embodiment;

FIGS. 46A to 46C each illustrate a first specific example of a gesture used as a command for the thickness of a line to be rendered in the twelfth exemplary embodiment, FIG. 46A illustrating an example of a gesture used as a command for a “thin line”, FIG. 46B illustrating an example of a gesture used as a command for a “medium-thick line”, FIG. 46C illustrating an example of a gesture used as a command for a “thick line”;

FIGS. 47A to 47C each illustrate a second specific example of a gesture used as a command for the thickness of a line to be rendered in the twelfth exemplary embodiment, FIG. 47A illustrating an example of a gesture used as a command for a “thin line”, FIG. 47B illustrating an example of a gesture used as a command for a “medium-thick line”, FIG. 47C illustrating an example of a gesture used as a command for a “thick line”;

FIG. 48 illustrates a usage example of a portable terminal according to a thirteenth exemplary embodiment; and

FIG. 49 illustrates an example of an AR system used in a fourteenth exemplary embodiment.

### DETAILED DESCRIPTION

Exemplary embodiments of the disclosure will be described below with reference to the drawings.

### First Exemplary Embodiment

### Usage Example

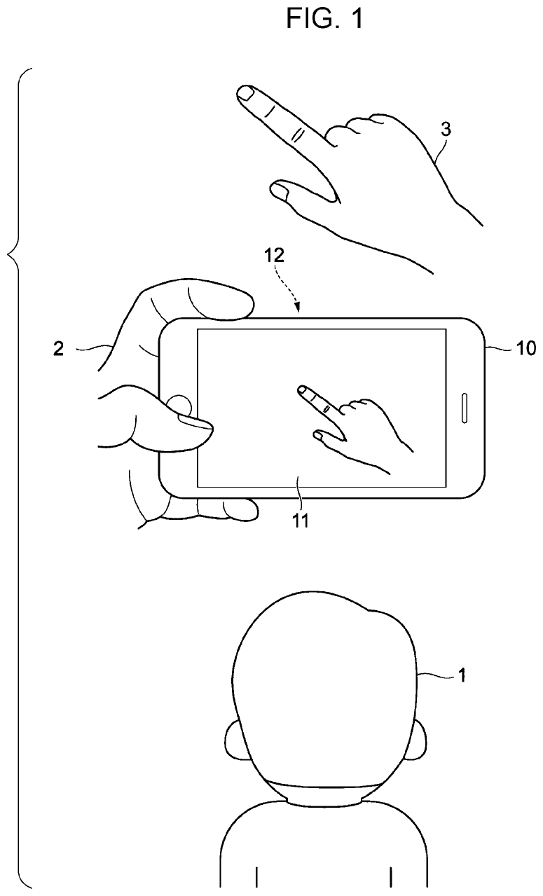

FIG. 1 illustrates a usage example of a portable terminal 10 according to a first exemplary embodiment. The portable terminal 10 in FIG. 1 is a smartphone.

The portable terminal 10 according to this exemplary embodiment combines information acquired from a captured image of a user's gesture with an image of reality space and displays the combined image. In this exemplary embodiment, an image corresponding to acquired information will be referred to as “AR image” as an extension of an image of real space.

In this exemplary embodiment, the portable terminal 10 extracts the trajectory of a user's fingertip from the captured image of the user's gesture. Information is acquired from the extracted fingertip trajectory. The acquired information is a text character, a symbol, or a graphic pattern expressed with a line or a group of lines (referred to as “line or lines, etc.” hereinafter). In the following description, a text character, a symbol, or a graphic pattern expressed with a line or lines, etc. may also be referred to as “object”. A period, a comma, a colon, a semicolon, and so on are also treated as types of lines.

In this exemplary embodiment, the trajectory along which the user's fingertip moves in midair is extracted from within a screen, but the target to be extracted is not limited to the user's fingertip. For example, the target to be extracted may be a physical object designated in advance. In addition to the user's fingertip, the target to be extracted may be, for example, a user's finger, hand, or foot, a rod-shaped item, or an item attached to the user's body.

In the case of FIG. 1, a user 1 supports the portable terminal 10 with his/her left hand 2 and moves a fingertip of his/her right hand 3 in empty space in midair.

In the case of the portable terminal 10 used in this exemplary embodiment, a camera 12 that captures an image of the user's gesture is provided at a surface opposite a touchscreen 11. Therefore, the user 1, the portable terminal 10, and the user's right hand 3 are positioned in that order from the front side toward the rear side of the drawing.

In the case of this exemplary embodiment, an object acquired from the user's gesture is displayed on the touchscreen 11 and is linked with the coordinates of the reality space (also referred to as “real space” hereinafter). The coordinates in this case are absolute coordinates. Therefore, even when an image of the same space is captured at a time point different from the time point at which the object is rendered, the previously-acquired object is read from the portable terminal 10 and is displayed on the touchscreen 11.

As an alternative to the example in FIG. 1 in which it is assumed that the portable terminal 10 is a smartphone, the portable terminal 10 may be a portable telephone. As another alternative, the portable terminal 10 may be a tablet-type terminal so long as an image of the movement of one hand may be captured while the terminal is held with the other hand.

The portable terminal 10 according to this exemplary embodiment is an example of an information processing apparatus.

Apparatus Configuration

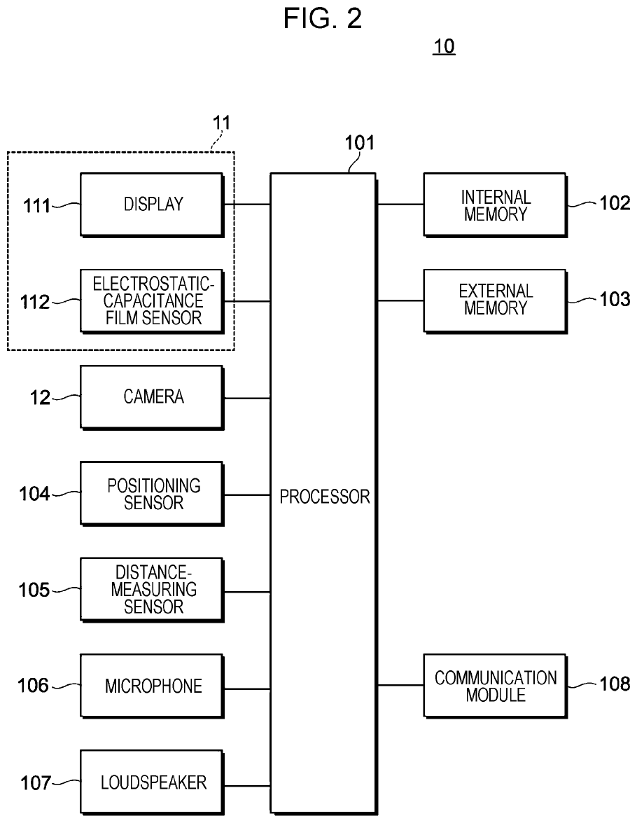

FIG. 2 illustrates an example of a hardware configuration of the portable terminal 10 used in the first exemplary embodiment.

The portable terminal 10 shown in FIG. 2 has a processor 101, an internal memory 102, an external memory 103, the touchscreen 11, the camera 12, a positioning sensor 104 that measures the position of the portable terminal 10, a distance-measuring sensor 105 that measures the distance from the portable terminal 10 to a physical object located in the vicinity of the portable terminal 10, a microphone 106 used for calling and recording, a loudspeaker 107 used for outputting sound, and a communication module 108 used for communicating with an external apparatus.

The devices shown in FIG. 2 are some of the devices provided in the portable terminal 10.

The processor 101 is constituted of, for example, a central processing unit (CPU). The processor 101 realizes various types of functions by executing application programs (referred to as “applications” hereinafter) and firmware. In the following description, the applications and firmware will collectively be referred to as “programs”.

Each of the internal memory 102 and the external memory 103 is a semiconductor memory. The internal memory 102 has a read-only memory (ROM) having a basic input/output system (BIOS) stored therein, and a random access memory (RAM) used as a principal storage device. The processor 101 and the internal memory 102 constitute a so-called computer. The processor 101 uses the RAM as a work space for a program. The external memory 103 is an auxiliary storage device and stores programs therein.

The touchscreen 11 is constituted of a display 111 that displays images and other information and an electrostatic-capacitance film sensor 112 that detects an operation performed on the display 111 by a user.

The display 111 is, for example, an electroluminescent display or a liquid crystal display. The display 111 displays various types of images and information. The images in this case include an image captured by the camera 12.

The electrostatic-capacitance film sensor 112 is disposed at the front face of the display 111. The electrostatic-capacitance film sensor 112 has enough light transmissivity to not interfere with observation of an image and information displayed on the display 111, and detects a position operated by the user through a change in electrostatic capacitance.

The camera 12 is, for example, a complementary metal oxide semiconductor (CMOS) image sensor or a charge-coupled device (CCD) image sensor.

As an alternative to this exemplary embodiment in which the camera 12 is integrally attached to the portable terminal 10, the camera 12 may be externally attached thereto as an accessory device.

The camera 12 may be a single camera or multiple cameras. The camera 12 according to this exemplary embodiment includes at least one camera provided at a surface opposite the surface provided with the touchscreen 11. Additionally, a self-image-capturing camera may be provided at the surface provided with the touchscreen 11.

The positioning sensor 104 is constituted of, for example, an indoor positioning module or a Global Positioning System (GPS) module that measures the position of the portable terminal 10 by detecting a GPS signal.

Examples of an indoor positioning module include a module that measures the position of the portable terminal 10 by receiving a Bluetooth Low Energy (BLE) beacon, a module that measures the position of the portable terminal 10 by receiving a WiFi (registered trademark) signal, a module that measures the position of the portable terminal 10 in accordance with autonomous navigation, and a module that measures the position of the portable terminal 10 by receiving an Indoor Messaging System (IMES) signal.

For example, if the camera 12 includes stereo cameras, the distance-measuring sensor 105 used is a module that calculates the distance to a physical object by using a parallax between the multiple cameras 12. Another example of the distance-measuring sensor 105 used is a module that calculates the distance to a physical object by measuring the time it takes for radiated light to return after being reflected by the physical object. The latter module is also called a time-of-flight (TOF) sensor.

The microphone 106 is a device that converts user's voice or ambient sound into an electric signal.

The loudspeaker 107 is a device that converts the electric signal into sound and outputs the sound.

The communication module 108 used is, for example, a communication module compliant with universal serial bus (USB), a communication module compliant with a mobile communication system, or a communication module compliant with a wireless local area network (LAN). The same applies to other exemplary embodiments.

The mobile communication system according to this exemplary embodiment may be any one of a fourth generation (i.e., 4G) mobile communication system, a fifth generation (i.e., 5G) mobile communication system, and a sixth generation (i.e., 6G) mobile communication system.

In this exemplary embodiment, the wireless LAN uses any one of 11a, 11b, 11g, 11n, 11ac, 11ad, and 11ax of the IEEE 802.11 family. The same applies to other exemplary embodiments.

Process

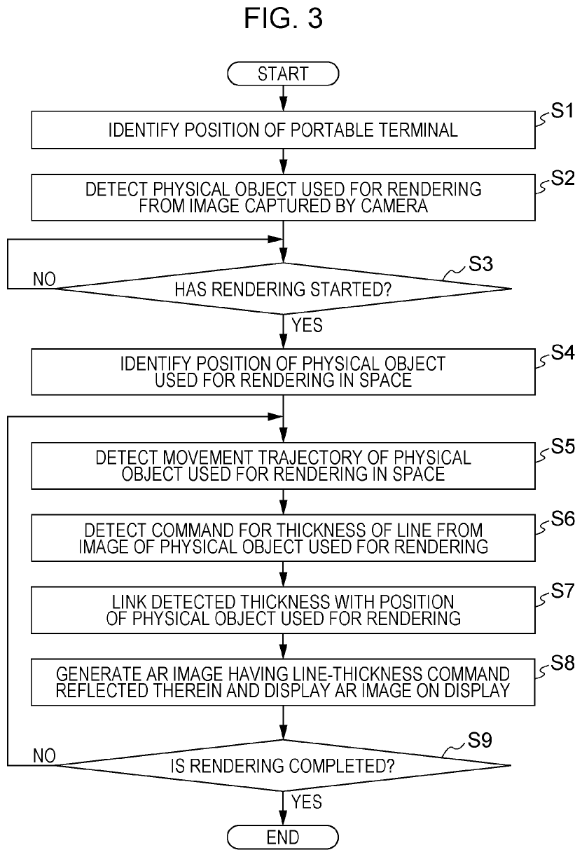

FIG. 3 is a flowchart illustrating an example of a process executed in the portable terminal 10 used in the first exemplary embodiment. The process shown in FIG. 3 is executed by the processor 101 (see FIG. 2). In FIG. 3, a symbol “S” denotes a step.

In this exemplary embodiment, a function for extracting a line or lines, etc. rendered in midair by a user's gesture from an image captured by the camera 12 is executed when the user activates a specific application. The specific application activated by the user is not limited to an application that renders an AR image in midair in accordance with a user's gesture, and may be another application that invokes the specific application.

First, in step S1, the processor 101 identifies the position of the portable terminal 10. The position of the portable terminal 10 is identified by using information given from the positioning sensor 104.

Then, in step S2, the processor 101 detects a physical object used for rendering from an image captured by the camera 12 (see FIG. 2). As mentioned above, the physical object used for the rendering is designated in advance. An example of the physical object used for the rendering is a user's fingertip.

Subsequently, in step S3, the processor 101 determines whether or not the rendering has started.

For example, if the physical object used for the rendering is stationary in midair, the processor 101 determines that the rendering has started. The term “stationary” in this exemplary embodiment does not refer to stationary in a strict sense, but refers to a state where the physical object continues to remain near a certain position. In other words, this refers to a state where the moving speed of the physical object has decreased to a value lower than a predetermined threshold value.

For example, if it is determined that the user's fingertip remains at a certain position in the screen for a predetermined time period or longer, the processor 101 obtains a positive result in step S3.

The time period used for determining that the user's fingertip is stationary is also set in view of user-friendliness. For example, one second is set as the threshold value. It is desirable that the threshold value be changeable by the user.

Furthermore, for example, the processor 101 may determine that the rendering has started when a specific gesture is detected.

The specific gesture may be midair tapping, double tapping, or swiping in empty space.

Moreover, the processor 101 may detect a start command based on user's voice.

If a determination condition is not satisfied, the processor 101 obtains a negative result in step S3.

If a positive result is obtained in step S3, the processor 101 identifies the position of the physical object used for the rendering in the space in step S4. In this case, the position is given as, for example, absolute coordinates.

When the processor 101 measures the distance to the physical object in the space, the processor 101 identifies the position of the physical object in the space in accordance with the relationship between the position of the portable terminal 10 and the imaging direction of the portable terminal 10. The distance to the physical object used for the rendering is measured by using information given from the distance-measuring sensor 105 (see FIG. 2). The position of the physical object in the space may be identified simultaneously with the detection of the physical object in step S2.

In step S5, the processor 101 detects the movement trajectory of the physical object used for the rendering in the space. In this case, the movement trajectory is detected as a command for the direction of a rendered line.

Then, in step S6, the processor 101 detects a command for the thickness of the line from an image of the physical object used for the rendering. Specifically, the processor 101 simultaneously detects the command for the thickness of the line being rendered through the action of the user performing the rendering.

An example of the command for the thickness of the line (sometimes referred to as “line-thickness command” hereinafter) is a specific motion appearing in the hand used for the rendering. Examples of a specific motion appearing in the hand include the number of fingers used for the rendering, the degree by which multiple fingers used for the rendering are spread out, and the orientation of a finger used for the rendering.

Another example of the line-thickness command is a change in feature appearing at the tip of the physical object used for the rendering. In this case, the physical object also includes a part of the user's body. Therefore, the physical object naturally includes user's hand and fingertip.

The feature includes a structure, an image, text, a shape, a color, or a combination thereof used for designating the thickness of the line. Examples of the image and shape used for designating the thickness of the line include a mark, an icon, a pattern, a symbol, and a code. In this case, the image may be directly printed on the physical object used for the rendering, may be bonded as a sticker, may be applied to a target area in the form of a manicure, or may be attached in the form of a bag-like member covering a hand or a finger. The term “structure” refers to a design that is visually confirmed in accordance with the colors of components constituting an item, irregular surfaces of the components, different materials of the components, and a combination thereof.

When the thickness command is detected, the processor 101 links the detected thickness with the position of the physical object used for the rendering in step S7. As a result of this linkage, the thickness of the line becomes changeable during the rendering process.

In step S8, the processor 101 generates an AR image having the line-thickness command reflected therein, and displays the AR image on the display 111. Accordingly, the user may simultaneously confirm an object being rendered in midair and the thickness of a line by viewing the display 111.

Subsequently, the processor 101 determines in step S9 whether or not the rendering is completed.

For example, if the physical object moving in midair becomes stationary in midair, the processor 101 determines that the rendering is completed.

For example, if it is determined that the user's fingertip remains at a certain position in the screen for a predetermined time period or longer, the processor 101 obtains a positive result in step S9. The time period used for determining that the user's fingertip is stationary may be the same as or different from the time period used for determining that the rendering has started. For example, one second is set as the threshold value. It is desirable that the threshold value be changeable by the user.

Furthermore, for example, the processor 101 may determine that the rendering is completed when a specific gesture is detected.

The specific gesture may be midair tapping, double tapping, or swiping in empty space. The gesture used for determining that the rendering is completed may be different from the gesture used for determining that the rendering has started.

Moreover, the processor 101 may detect a start command and an end command based on user's voice.

If a determination condition is not satisfied, the processor 101 obtains a negative result in step S9 and returns to step S5.

### Specific Examples Used as Command for Thickness of Line

Specific examples of gestures assumed in step S6 (see FIG. 3) will be described below.

### First Specific Example

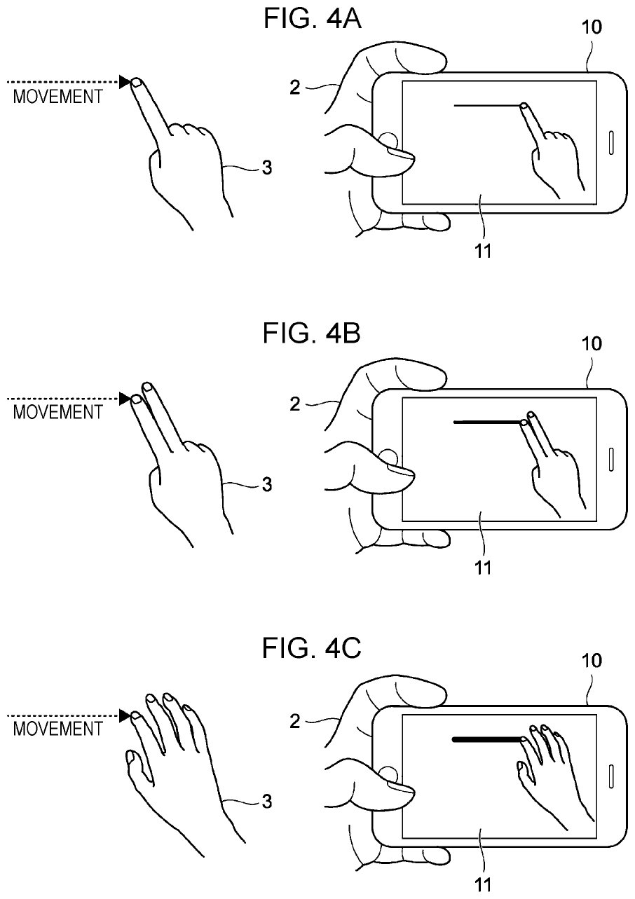

FIGS. 4A to 4C each illustrate a first specific example of a gesture used as a command for the thickness of a line to be rendered in the first exemplary embodiment. Specifically, FIG. 4A illustrates an example of a gesture used as a command for a “thin line”, FIG. 4B illustrates an example of a gesture used as a command for a “medium-thick line”, and FIG. 4C illustrates an example of a gesture used as a command for a “thick line”.

In each of FIGS. 4A to 4C, the left column indicates an example of a gesture used for simultaneously giving a command for the rendering of a line and a command for the thickness of the line, and the right column indicates an example of an AR image displayed on the display 111 of the portable terminal 10.

In FIGS. 4A to 4C, the fingertip of the index finger of the right hand 3 is used for rendering the line. Furthermore, in FIGS. 4A to 4C, the command for the thickness of the line is given in accordance with the number of fingers used for the rendering.

In FIG. 4A, a “thin line” is rendered on the display 111 in conjunction with the rendering using the index finger.

In FIG. 4B, a “medium-thick line” is rendered on the display 111 in conjunction with the rendering using two fingers, namely, the index finger and the middle finger.

In FIG. 4C, a “thick line” is rendered on the display 111 in conjunction with the rendering using the five fingers in a spread-out state.

In this specific example, the thickness of the rendered line increases with increasing number of fingers. Alternatively, with the same number of fingers, commands for different thicknesses may be given by varying the combination of fingers used for the rendering. For example, a command for rendering a “thin line” may be given by using two fingers, namely, the index finger and the little finger, and a command for rendering a “thick line” may be given by using two fingers, namely, the index finger and the thumb.

Although a line is rendered by tracking the fingertip of the index finger of the right hand 3 in FIGS. 4A to 4C, the little finger or the thumb may be used for rendering a line. The selection of any of the fingers to be used for rendering a line may be made in advance. The same applies to other specific examples to be described later.

Furthermore, instead of using a fingertip or fingertips for rendering a line, the entire right hand 3 may be used. In this case, the trajectory of the center of gravity of the right hand 3 or the center of the right hand 3 may be displayed as an AR image. The same applies to other specific examples to be described later.

Moreover, although the right hand 3 that is freely movable is used for rendering a line in FIGS. 4A to 4C since the portable terminal 10 is supported with the left hand 2, the left hand 2 may be used for rendering a line if the portable terminal 10 is supported with the right hand 3. The same applies to other specific examples to be described later.

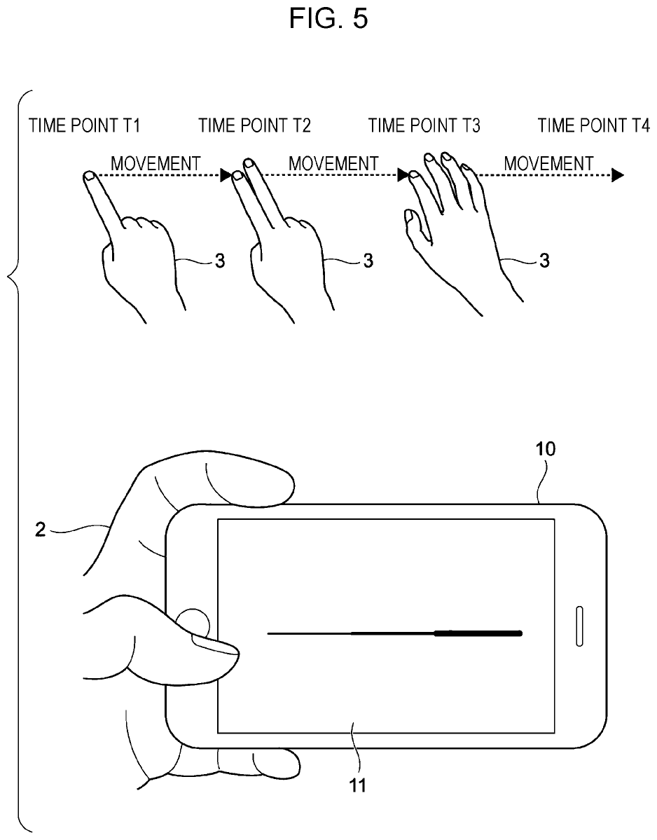

FIG. 5 illustrates an example of an AR image rendered when variations in the number of fingers are combined while the index finger is moved in midair.

In FIG. 5, the rendering process involves using one finger between a time point T1 and a time point T2, using two fingers between the time point T2 and a time point T3, and using five fingers between the time point T3 and a time point T4.

Therefore, the touchscreen 11 of the portable terminal 10 displays a group of lines that increase in thickness in a stepwise manner.

In the case of FIG. 5, lines with thicknesses corresponding to commands from the user are directly displayed. Therefore, the line thickness changes in a stepwise manner. Alternatively, the line thickness may be processed for a smooth appearance so that the positions where the thickness changes are made less noticeable. Specifically, a smoothing process may be additionally performed.

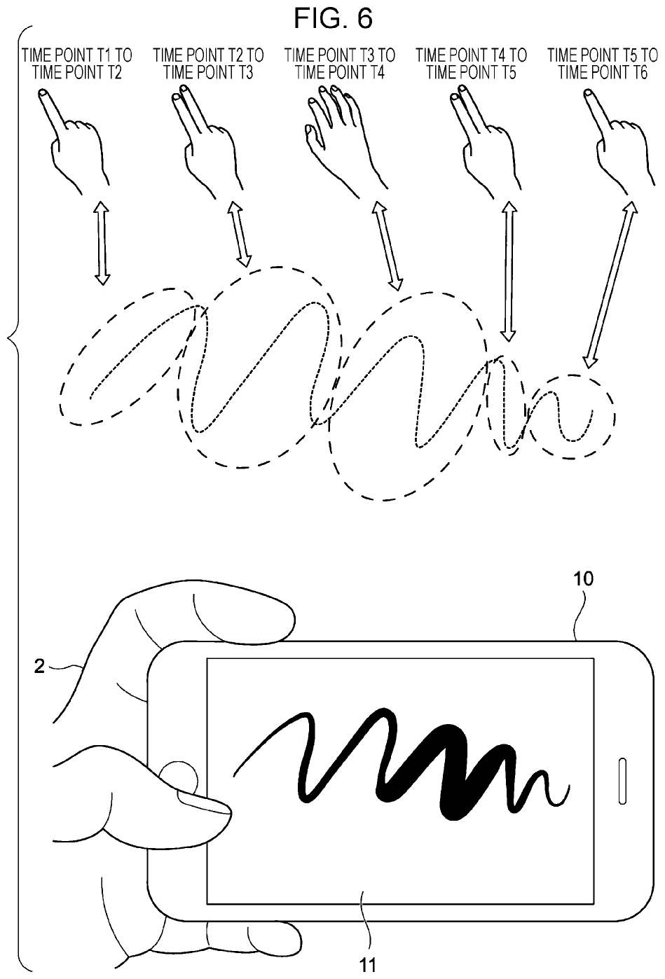

FIG. 6 illustrates another example of an AR image rendered when variations in the number of fingers are combined while the index finger is moved in midair.

In FIG. 6, the rendering process involves using one finger between a time point T1 and a time point T2, using two fingers between the time point T2 and a time point T3, using five fingers between the time point T3 and a time point T4, using two fingers between the time point T4 and a time point T5, and using one finger between the time point T5 and a time point T6.

In the example in FIG. 6, the AR image displayed on the touchscreen 11 has undergone a smoothing process such that the changes in the line thickness appear to be natural.

As shown in FIG. 6, in this exemplary embodiment, the thickness of the line being rendered is changeable as desired by the user. In the related art, the expressiveness of lines to be rendered is limited since only lines with the same thickness may be rendered during the rendering process. In contrast, in this exemplary embodiment, the line thickness is freely changeable, so that an object that reflects user's uniqueness and sensitivity may be readily rendered.

### Second Specific Example

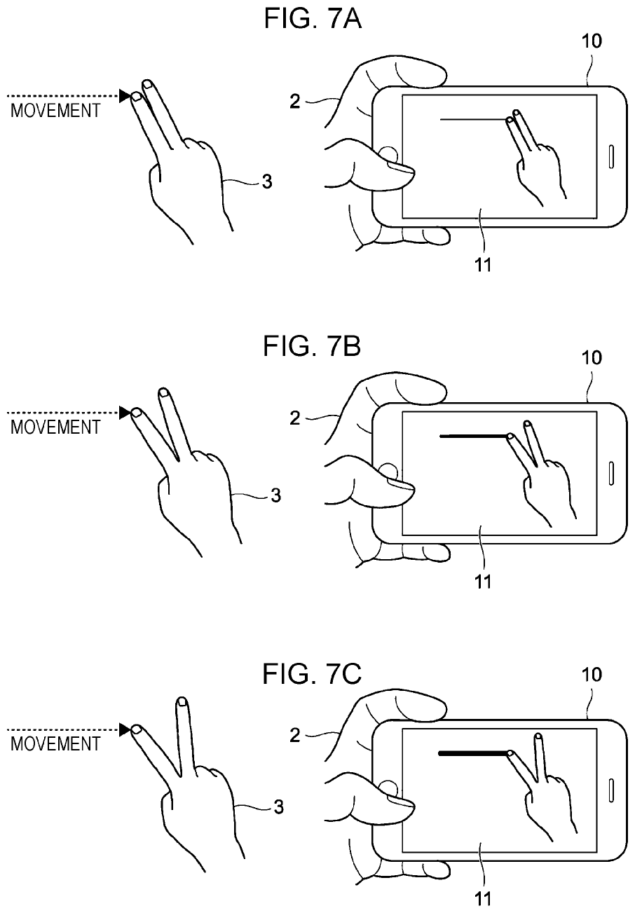

FIGS. 7A to 7C each illustrate a second specific example of a gesture used as a command for the thickness of a line to be rendered in the first exemplary embodiment. Specifically, FIG. 7A illustrates an example of a gesture used as a command for a “thin line”, FIG. 7B illustrates an example of a gesture used as a command for a “medium-thick line”, and FIG. 7C illustrates an example of a gesture used as a command for a “thick line”.

In each of FIGS. 7A to 7C, the left column indicates an example of a gesture used for simultaneously giving a command for the rendering of a line and a command for the thickness of the line, and the right column indicates an example of an AR image displayed on the touchscreen 11 of the portable terminal 10.

In FIGS. 7A to 7C, the fingertip of the index finger of the right hand 3 is used for rendering the line. However, in FIGS. 7A to 7C, the degree of opening between the index finger and the middle finger during the rendering is used as the command for the thickness of the line.

In FIG. 7A, the index finger and the middle finger are closed. Therefore, a “thin line” is rendered on the touchscreen 11 in conjunction with movement of the index finger.

In FIG. 7B, there is a slight gap between the index finger and the middle finger. Therefore, a “medium-thick line” is rendered on the touchscreen 11 in conjunction with movement of the index finger.

In FIG. 7C, the gap between the index finger and the middle finger is further increased. Therefore, a “thick line” is rendered on the touchscreen 11 in conjunction with movement of the index finger.

As an alternative to the example in FIGS. 7A to 7C in which the degree of opening between the index finger and the middle finger is used as the command for the thickness of the line, the degree of opening between other multiple fingers may be used.

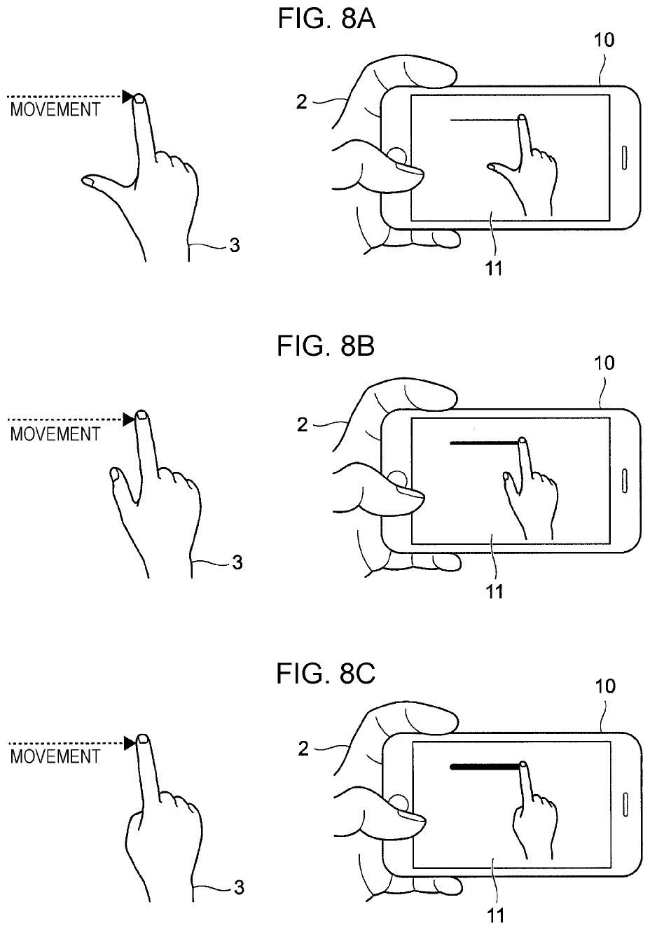

FIGS. 8A to 8C each illustrate another example in the first exemplary embodiment in a case where the command for the thickness of the line is given in accordance with the degree of opening between multiple fingers. Specifically, FIG. 8A illustrates an example of a gesture used as a command for a “thin line”, FIG. 8B illustrates an example of a gesture used as a command for a “medium-thick line”, and FIG. 8C illustrates an example of a gesture used as a command for a “thick line”.

In the example in each of FIGS. 8A to 8C, the line thickness is designated in accordance with the degree of opening of a gap between two fingers, namely, the index finger and the thumb.

In FIG. 8A, the index finger and the thumb are opened at substantially 90°. Therefore, a “thin line” is rendered on the touchscreen 11 in conjunction with movement of the index finger.

In FIG. 8B, there is a slight gap between the index finger and the thumb. Therefore, a “medium-thick line” is rendered on the touchscreen 11 in conjunction with movement of the index finger.

In FIG. 8C, the index finger and the thumb are closed. Therefore, a “thick line” is rendered on the touchscreen 11 in conjunction with movement of the index finger.

In FIGS. 8A to 8C, the relationship of the degree of opening used as the line-thickness command is opposite from that in FIGS. 7A to 7C. Alternatively, in FIGS. 8A to 8C, a thin line may be rendered when the index finger and the thumb are closed, and a thick line may be rendered when the index finger and the thumb are open.

Needless to say, the rendering method described with reference to FIGS. 7A to 7C may match the rendering method in FIGS. 8A to 8C. Specifically, a thick line may be rendered when the index finger and the middle finger are closed, and a thin line may be rendered when the index finger and the middle finger are open.

### Third Specific Example

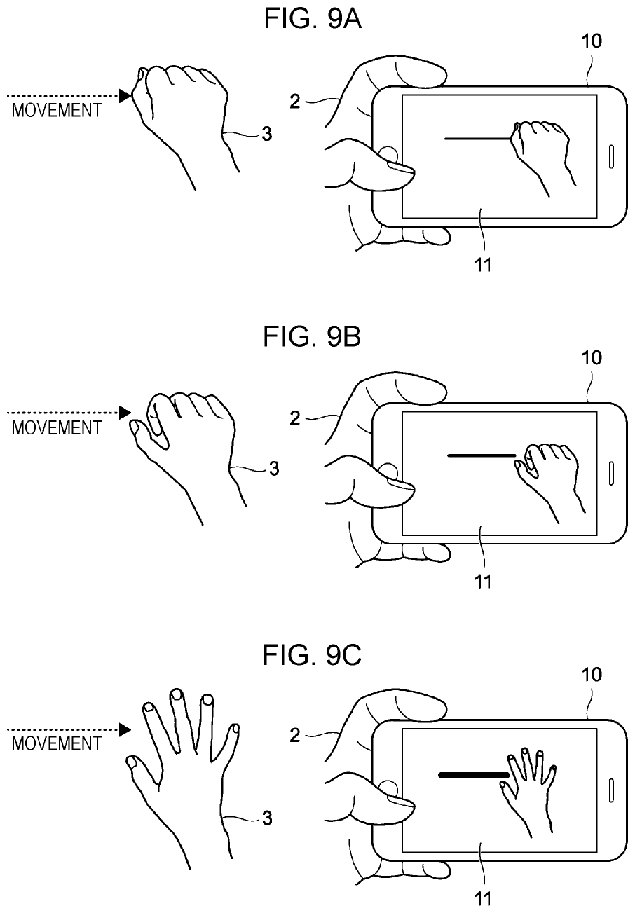

FIGS. 9A to 9C each illustrate a third specific example of a gesture used as a command for the thickness of a line to be rendered in the first exemplary embodiment. Specifically, FIG. 9A illustrates an example of a gesture used as a command for a “thin line”, FIG. 9B illustrates an example of a gesture used as a command for a “medium-thick line”, and FIG. 9C illustrates an example of a gesture used as a command for a “thick line”.

In each of FIGS. 9A to 9C, the left column indicates an example of a gesture used for simultaneously giving a command for the rendering of a line and a command for the thickness of the line, and the right column indicates an example of an AR image displayed on the touchscreen 11 of the portable terminal 10. In each of FIGS. 9A to 9C, the command for the thickness of the line is given in accordance with the shape of the right hand 3. Furthermore, the position of the center of the right hand 3 or the position of the center of gravity thereof is used for rendering the line.

In FIG. 9A, the fingers of the right hand 3 are closed. Specifically, in FIG. 9A, the right hand 3 has the shape of a fist. A “thin line” is rendered on the touchscreen 11 in conjunction with movement of the fisted right hand 3.

In FIG. 9B, the right hand 3 has the shape of a loose fist. In other words, the right hand 3 is in a loosely fisted state from the aforementioned fisted state. A “medium-thick line” is rendered on the touchscreen 11 in conjunction with movement of the right hand 3 having this shape.

In FIG. 9C, the right hand 3 is in an open state. A “thick line” is rendered on the touchscreen 11 in conjunction with movement of the right hand 3 having this shape.

In this specific example, the relationship between the shape of the right hand 3 and the thickness of the line to be rendered may be opposite from that in FIGS. 9A to 9C. Specifically, the right hand 3 in the fisted state may correspond to a thick line, and the right hand 3 in the open state may correspond to a thin line.

### Fourth Specific Example

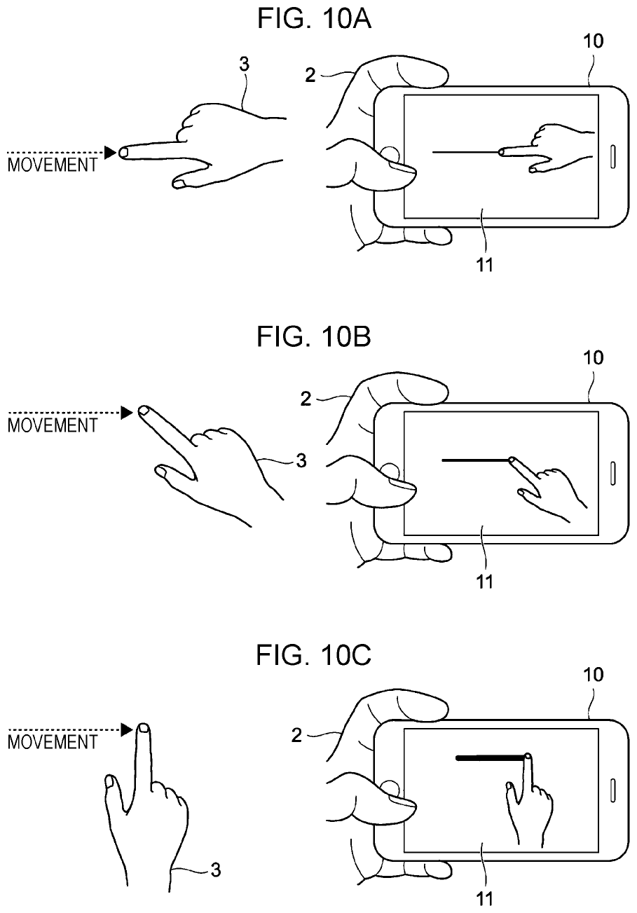

FIGS. 10A to 10C each illustrate a fourth specific example of a gesture used as a command for the thickness of a line to be rendered in the first exemplary embodiment. Specifically, FIG. 10A illustrates an example of a gesture used as a command for a “thin line”, FIG. 10B illustrates an example of a gesture used as a command for a “medium-thick line”, and FIG. 10C illustrates an example of a gesture used as a command for a “thick line”.

In each of FIGS. 10A to 10C, the left column indicates an example of a gesture used for simultaneously giving a command for the rendering of a line and a command for the thickness of the line, and the right column indicates an example of an AR image displayed on the touchscreen 11 of the portable terminal 10.

In FIGS. 10A to 10C, the fingertip of the index finger is used for rendering the line. Furthermore, in FIGS. 10A to 10C, the orientation of the index finger is used as the command for the thickness of the line.

In FIG. 10A, the index finger is oriented in the horizontal direction. Specifically, the index finger is oriented substantially parallel to the long side of the portable terminal 10. When the right hand 3 is moved rightward while this orientation is maintained, a “thin line” is rendered on the touchscreen 11 in conjunction with the movement of the right hand 3.

In FIG. 10B, the index finger is oriented toward the upper left side. Specifically, the index finger is oriented at substantially 45° relative to the long side of the portable terminal 10. When the right hand 3 is moved rightward while this orientation is maintained, a “medium-thick line” is rendered on the touchscreen 11 in conjunction with the movement of the right hand 3.

In FIG. 10C, the index finger is oriented upward. Specifically, the index finger is oriented substantially parallel to the short side of the portable terminal 10. When the right hand 3 is moved rightward while this orientation is maintained, a “thick line” is rendered on the touchscreen 11 in conjunction with the movement of the right hand 3.

In this specific example, the relationship between the orientation of the index finger and the thickness of the line to be rendered may be opposite from that in FIGS. 10A to 10C. Specifically, the index finger oriented in the horizontal direction may correspond to a thick line, and the index finger oriented upward may correspond to a thin line.

In FIGS. 10A to 10C, the orientation of a specific fingertip is used as the command for the thickness of the line. Alternatively, if the right hand 3 in the fisted state is to be used for rendering a line, the thickness of the line may be identified by identifying the orientation of the hand from the orientation of the arm connected to the wrist.

### Fifth Specific Example

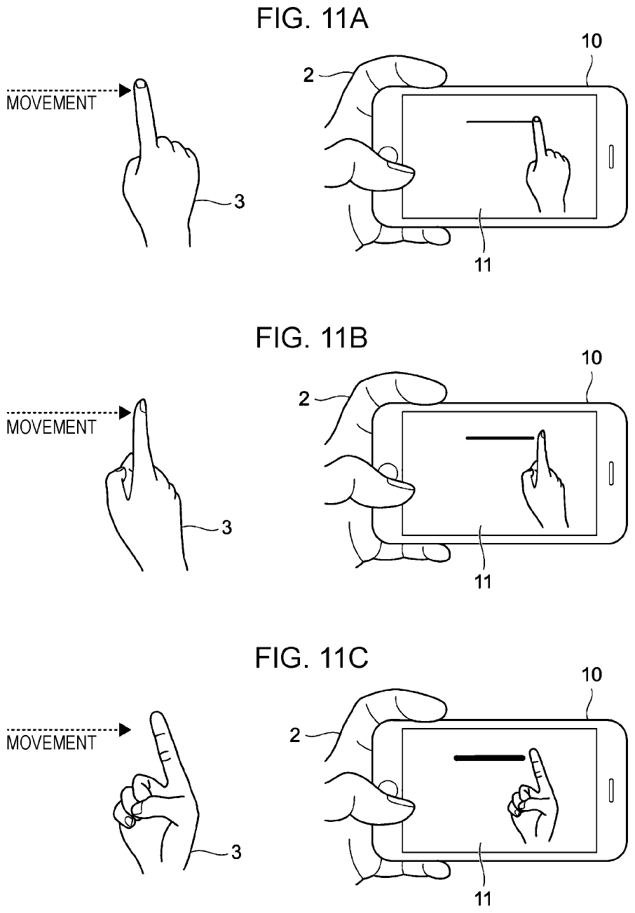

FIGS. 11A to 11C each illustrate a fifth specific example of a gesture used as a command for the thickness of a line to be rendered. Specifically, FIG. 11A illustrates an example of a gesture used as a command for a “thin line”, FIG. 11B illustrates an example of a gesture used as a command for a “medium-thick line”, and FIG. 11C illustrates an example of a gesture used as a command for a “thick line”.

In each of FIGS. 11A to 11C, the left column indicates an example of a gesture used for simultaneously giving a command for the rendering of a line and a command for the thickness of the line, and the right column indicates an example of an AR image displayed on the touchscreen 11 of the portable terminal 10.

In FIGS. 11A to 11C, the fingertip of the index finger is used for rendering the line. However, in FIGS. 11A to 11C, a rotational angle of the right wrist is used as the command for the thickness of the line. In other words, the command for the thickness of the line is given in accordance with variations in how the index finger appears or how the hand appears.

In FIG. 11A, the back of the right hand 3 is substantially facing the portable terminal 10. In other words, the front of the index finger is oriented in the same direction as the imaging direction of the camera 12 (see FIG. 2) provided in the portable terminal 10. In this case, a “thin line” is rendered on the touchscreen 11 in conjunction with movement of the index finger. In this case, the imaging direction corresponds to the depth direction as viewed from the user. The same applies hereinafter.

In FIG. 11B, the wrist is slightly rotated such that an image of a side surface of the index finger is captured by the camera 12. The rotational axis extends vertically upward. In this case, a “medium-thick line” is rendered on the touchscreen 11 in conjunction with movement of the index finger.

In FIG. 11C, the wrist is further rotated such that an image of the front of the index finger is captured by the camera 12. In this case, a “thick line” is rendered on the touchscreen 11 in conjunction with movement of the index finger.

In this specific example, the relationship between the appearance of the index finger and the thickness of the line to be rendered may be opposite from that in FIGS. 11A to 11C. Specifically, the state where the back of the right hand 3 substantially faces the portable terminal 10 may correspond to a thick line, and the state where the front of the index finger is viewable from the portable terminal 10 may correspond to a thin line.

### Sixth Specific Example

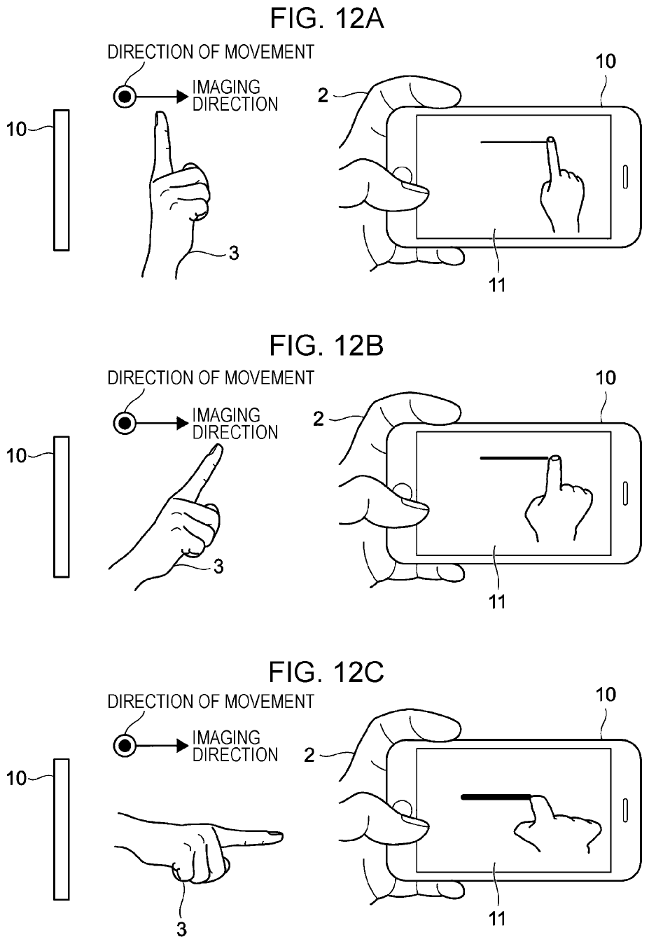

FIGS. 12A to 12C each illustrate a sixth specific example of a gesture used as a command for the thickness of a line to be rendered in the first exemplary embodiment. Specifically, FIG. 12A illustrates an example of a gesture used as a command for a “thin line”, FIG. 12B illustrates an example of a gesture used as a command for a “medium-thick line”, and FIG. 12C illustrates an example of a gesture used as a command for a “thick line”.

In each of FIGS. 12A to 12C, the left column indicates an example of a gesture used for simultaneously giving a command for the rendering of a line and a command for the thickness of the line, and the right column indicates an example of an AR image displayed on the touchscreen 11 of the portable terminal 10.

In FIGS. 12A to 12C, the fingertip of the index finger of the right hand 3 is used for rendering the line. However, in FIGS. 12A to 12C, the command for the thickness of the line is given in accordance with variations in the degree of inclination of the right hand 3 in the imaging direction. In other words, the command for the thickness of the line is given in accordance with variations in how the index finger appears or how the back of the right hand 3 appears.

In contrast to the example in FIGS. 10A to 10C in which the command for the thickness of the line is given in accordance with variations in the orientation of the index finger within a plane in which the imaging direction of the portable terminal 10 is defined as the normal, the command for the thickness of the line is given in the example in FIGS. 12A to 12C based on variations in the orientation of the index finger within a plane defined by the imaging direction and the vertical direction. Therefore, unlike the other specific examples described above, the left column in each of FIGS. 12A to 12C indicates the positional relationship when the portable terminal 10 and the right hand 3 are observed from a side surface.

In FIG. 12A, the index finger is oriented vertically upward. In other words, the index finger and the back of the right hand 3 are entirely viewable through the camera 12 (see FIG. 2) provided in the portable terminal 10. In this case, a “thin line” is rendered on the touchscreen 11 in conjunction with movement of the index finger.

In FIG. 12B, the index finger is inclined at substantially 45° relative to the imaging direction. In other words, the index finger and the back of the right hand 3 within a captured image appear to be shorter in the height direction than in FIG. 12A. In this case, a “medium-thick line” is rendered on the touchscreen 11 in conjunction with movement of the index finger.

In FIG. 12C, the index finger is inclined to be substantially parallel to the imaging direction. In other words, the index finger appears to be substantially hidden behind the back of the right hand 3. In this case, a “thick line” is rendered on the touchscreen 11 in conjunction with movement of the index finger.

In this specific example, the relationship between the appearance of the index finger and the thickness of the line to be rendered may be opposite from that in FIGS. 12A to 12C. Specifically, the index finger oriented vertically upward may correspond to a thick line, and the index finger oriented in the imaging direction may correspond to a thin line.

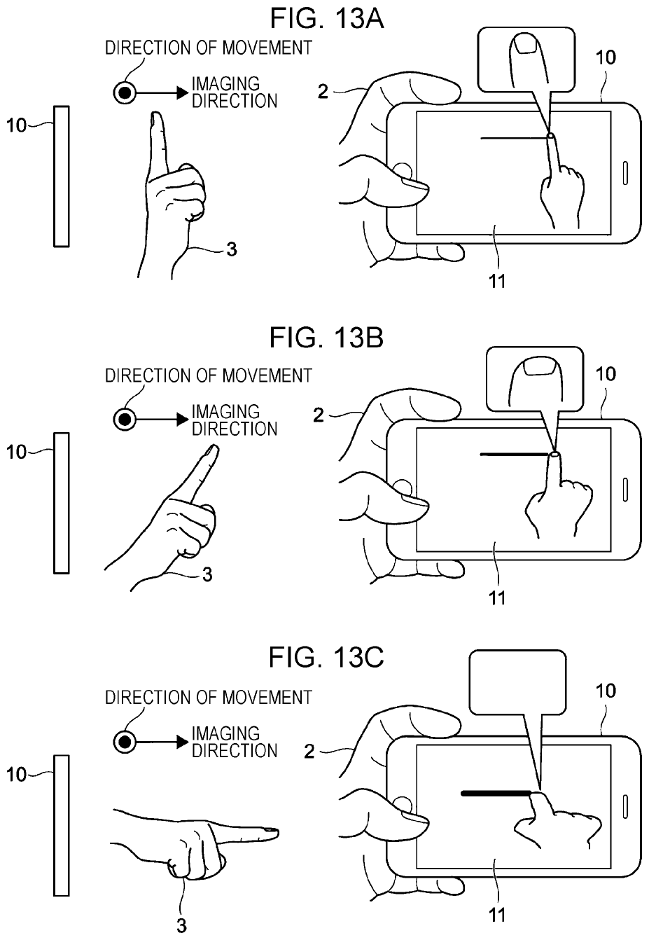

FIGS. 13A to 13C each illustrate another example in a case where a command for the thickness of a line is given in accordance with the degree of inclination of the index finger in the imaging direction. Specifically, FIG. 13A illustrates an example of a gesture used as a command for a “thin line”, FIG. 13B illustrates an example of a gesture used as a command for a “medium-thick line”, and FIG. 13C illustrates an example of a gesture used as a command for a “thick line”.

In FIGS. 13A to 13C, sections corresponding to those in FIGS. 12A to 12C are given the corresponding reference signs.

In contrast to FIGS. 12A to 12C in which the command for the thickness of the line is given in accordance with variations in how the index finger appears or how the back of the right hand 3 appears, the command for the thickness of the line is received based on variations in how the nail of the index finger appears.

For example, in FIG. 13A, the area of the nail of the index finger extracted from an image is larger than a first threshold value TH1. In this case, a “thin line” is rendered on the touchscreen 11 in conjunction with movement of the index finger.

In FIG. 13B, the area of the nail of the index finger extracted from an image is smaller than the first threshold value TH1 but larger than a second threshold value TH2 (<TH1). In this case, a “medium-thick line” is rendered on the touchscreen 11 in conjunction with movement of the index finger.

In FIG. 13C, the area of the nail of the index finger within an image is smaller than the second threshold value TH2. In this case, a “thick line” is rendered on the touchscreen 11 in conjunction with movement of the index finger.

The size of the nail varies depending on the user. Therefore, in order to enhance the determination accuracy, it is desirable to set a determination threshold value for each user. For example, a threshold-value calibration process is executed before using this application. In the calibration process, images of the nail of the user's index finger are captured in various orientations through a guidance message, such as “please point index finger upward”. When the images of the nail of the index finger are completely captured, the first threshold value TH1 and the second threshold value TH2 used for determining the area of the image-captured nail are registered.

For the determination, the shape of the nail may be used as an alternative. For example, in the aforementioned calibration process, the shape of the nail for each direction may be registered for each user in place of the area of the nail or in addition to the area of the nail.

The line thickness may be determined based on, for example, variations in the degree of similarity between the shape of the image-captured nail and the registered shape of the nail.

In this specific example, the relationship between the appearance of the index finger and the thickness of the line to be rendered may be opposite from that in FIGS. 13A to 13C. Specifically, the state where the area of the nail of the right hand 3 is larger than the threshold value may correspond to a thick line, and the state where the front of the index finger with the minimal area of the nail is viewable from the portable terminal 10 may correspond to a thin line.

### Seventh Specific Example

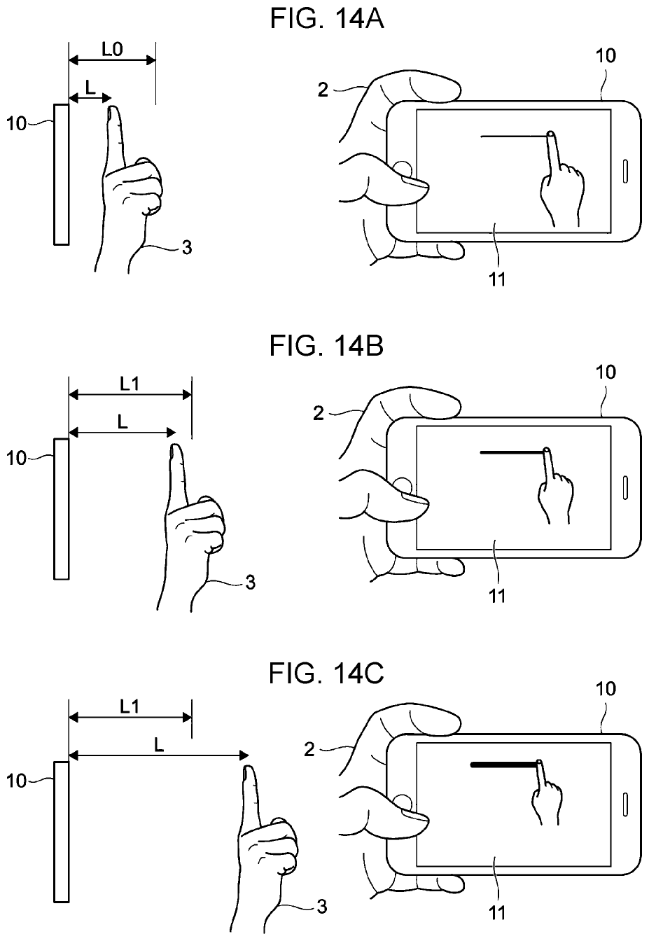

FIGS. 14A to 14C each illustrate a seventh specific example of a gesture used as a command for the thickness of a line to be rendered in the first exemplary embodiment. Specifically, FIG. 14A illustrates an example of a gesture used as a command for a “thin line”, FIG. 14B illustrates an example of a gesture used as a command for a “medium-thick line”, and FIG. 14C illustrates an example of a gesture used as a command for a “thick line”. In FIGS. 14A to 14C, sections corresponding to those in FIGS. 12A to 12C are given the corresponding reference signs.

In each of FIGS. 14A to 14C, the left column indicates an example of a gesture used for simultaneously giving a command for the rendering of a line and a command for the thickness of the line, and the right column indicates an example of an AR image displayed on the touchscreen 11 of the portable terminal 10.

In FIGS. 14A to 14C, the fingertip of the index finger of the right hand 3 is used for rendering the line. However, in FIGS. 14A to 14C, the command for the thickness of the line is given in accordance with variations in the distance between the portable terminal 10 and the index finger. Therefore, similar to the case of the sixth specific example, the left column in each of FIGS. 14A to 14C indicates the positional relationship when the portable terminal 10 and the right hand 3 are observed from a side surface.

In FIG. 14A, a distance L between the portable terminal 10 and the index finger is smaller than a first threshold value L0. In this case, a “thin line” is rendered on the display 111 in conjunction with movement of the index finger.

In FIG. 14B, the distance L between the portable terminal 10 and the index finger is larger than or equal to the first threshold value L0 but smaller than a second threshold value L1 (>L0). In this case, a “medium-thick line” is rendered on the touchscreen 11 in conjunction with movement of the index finger.

In FIG. 14C, the distance L between the portable terminal 10 and the index finger is larger than or equal to the second threshold value L1. In this case, a “thick line” is rendered on the touchscreen 11 in conjunction with movement of the index finger.

The first threshold value L0 and the second threshold value L1 are set in advance, but are desirably changeable by the user.

In this specific example, the relationship between the distance L and the line thickness may be opposite from that in FIGS. 14A to 14C. Specifically, the case where the distance L between the portable terminal 10 and the index finger is smaller than the first threshold value L0 may correspond to a thick line, and the case where the distance L between the portable terminal 10 and the index finger is larger than or equal to the second threshold value L1 may correspond to a thin line.

### Eighth Specific Example

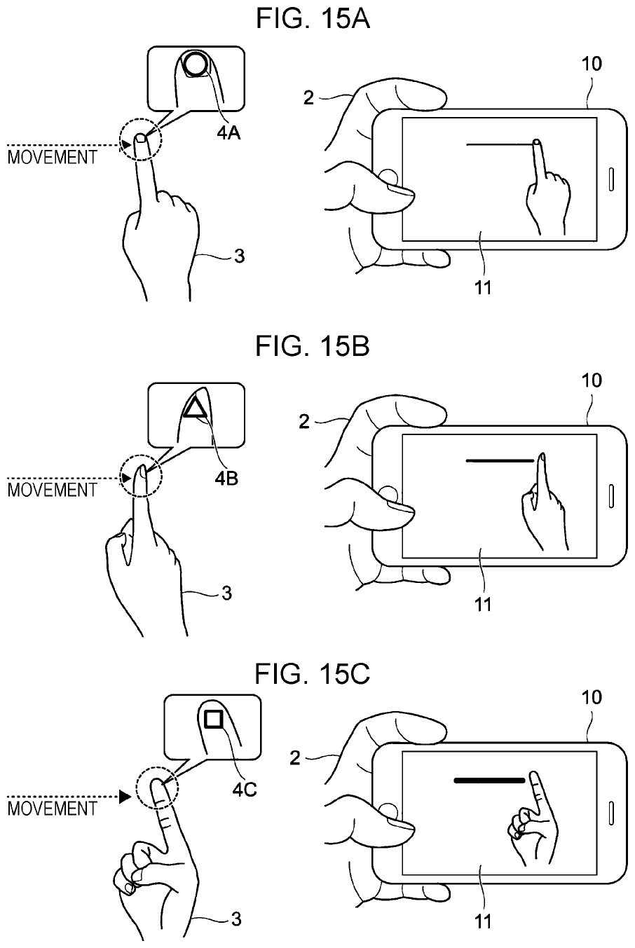

FIGS. 15A to 15C each illustrate an eighth specific example of a gesture used as a command for the thickness of a line to be rendered in the first exemplary embodiment. Specifically, FIG. 15A illustrates an example of a gesture used as a command for a “thin line”, FIG. 15B illustrates an example of a gesture used as a command for a “medium-thick line”, and FIG. 15C illustrates an example of a gesture used as a command for a “thick line”. In FIGS. 15A to 15C, sections corresponding to those in FIGS. 11A to 11C are given the corresponding reference signs.

In each of FIGS. 15A to 15C, the left column indicates an example of a gesture used for simultaneously giving a command for the rendering of a line and a command for the thickness of the line, and the right column indicates an example of an AR image displayed on the touchscreen 11 of the portable terminal 10.

In FIGS. 15A to 15C, the fingertip of the index finger of the right hand 3 is used for rendering the line. However, this specific example is different from the fifth specific example in that a gesture for rotating the right wrist during the rendering process is combined with a thickness-designation mark. Specifically, in this specific example, a thickness-designation mark is printed, adhered, or attached to an area to be image-captured in accordance with rotation of the wrist. In this case, the mark is an example of a feature appearing at the tip of a physical object used for rendering.

In FIG. 15A, the back of the right hand 3 is substantially facing the portable terminal 10. In other words, an image of the nail of the index finger is captured by the camera 12 (see FIG. 2) provided in the portable terminal 10. In FIG. 15A, a circular mark 4A is adhered to the nail of the index finger. In this specific example, this circular mark 4A corresponds to a thin line. Therefore, a “thin line” is rendered on the touchscreen 11 in conjunction with movement of the index finger.

In FIG. 15B, the wrist is slightly rotated such that an image of a side surface of the index finger is captured by the camera 12. In FIG. 15B, a triangular mark 4B is adhered to the side surface of the index finger. In this specific example, the triangular mark 4B corresponds to a medium-thick line. Therefore, a “medium-thick line” is rendered on the touchscreen 11 in conjunction with movement of the index finger.

In FIG. 15C, the wrist is further rotated such that an image of the front of the index finger is captured by the camera 12. In FIG. 15C, a rectangular mark 4C is adhered to the front of the index finger. In this specific example, the rectangular mark 4C corresponds to a thick line. Therefore, a “thick line” is rendered on the touchscreen 11 in conjunction with movement of the index finger.

In this specific example, the relationship between the appearance of the index finger and the thickness of the line to be rendered may be opposite from that in FIGS. 15A to 15C. Specifically, the mark 4A to be image-captured in a state where the back of the right hand 3 is substantially facing the portable terminal 10 may correspond to a thick line, and the mark 4C to be image-captured in a state where the front of the index finger is viewable from the portable terminal 10 may correspond to a thin line.

The shape of each mark mentioned above is merely an example, and may be a different shape. Furthermore, each of the marks may be replaced with a barcode or a QR code (registered trademark), or may be replaced with text or an icon. The barcode mentioned here is also an example of a feature appearing at the tip of a physical object used for rendering.

As an alternative to FIGS. 15A to 15C in which the three marks 4A, 4B, and 4C are printed around the index finger, the marks 4A to 4C may be printed on multiple fingers. In this case, a thickness command may be given by switching between the marked fingers to be image-captured during the rendering process. Furthermore, in this case, the rendering may be continued by tracking the fingertip of the marked finger. In order to prevent the rendering positions from being unnatural due to the switching of the fingers, a smoothing process may be additionally performed.

Furthermore, the same mark may be given to multiple fingers. In that case, instead of using the mark for indicating the line thickness, the thickness may be detected in accordance with the image-captured marked finger.

If the marks 4A, 4B, and 4C are printed on the index finger, the middle finger, and the ring finger, respectively, a mark that corresponds to a thicker line may be prioritized if multiple marks are simultaneously image-captured. For example, a case where the mark 4A on the index finger and the mark 4B on the middle finger are simultaneously image-captured may be treated as a case where a command for a “medium-thick line” is given.

Furthermore, the same mark may be printed on multiple fingers. In this case, the line thickness may be increased in proportional to the number of image-captured marks. For example, a “medium-thick line” may be rendered if the mark on the index finger and the mark on the middle finger are simultaneously image-captured, and a “thick line” may be rendered if the mark on the index finger, the mark on the middle finger, and the mark on the ring finger are simultaneously image-captured. Although this example is substantially the same as the example where the line thickness is proportional to the number of image-captured fingers, this example is different therefrom in that the detection target is the number of marks.

### Ninth Specific Example

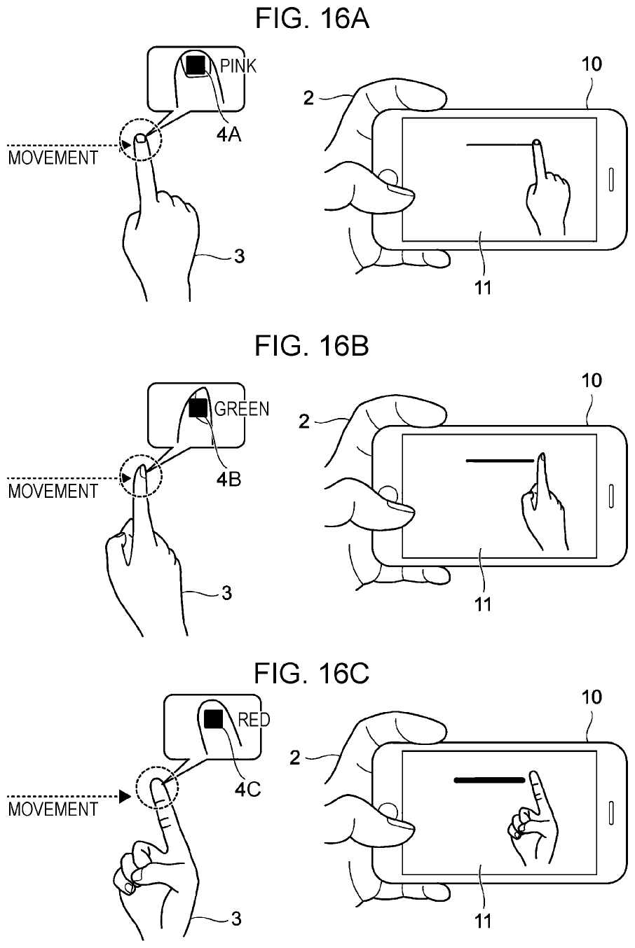

FIGS. 16A to 16C each illustrate a ninth specific example of a gesture used as a command for the thickness of a line to be rendered in the first exemplary embodiment. Specifically, FIG. 16A illustrates an example of a gesture used as a command for a “thin line”, FIG. 16B illustrates an example of a gesture used as a command for a “medium-thick line”, and FIG. 16C illustrates an example of a gesture used as a command for a “thick line”. In FIGS. 16A to 16C, sections corresponding to those in FIGS. 15A to 15C are given the corresponding reference signs.

In each of FIGS. 16A to 16C, the left column indicates an example of a gesture used for simultaneously giving a command for the rendering of a line and a command for the thickness of the line, and the right column indicates an example of an AR image displayed on the touchscreen 11 of the portable terminal 10.

In FIGS. 16A to 16C, the fingertip of the index finger of the right hand 3 is used for rendering the line. This specific example is different from the eighth specific example in that a gesture for rotating the right wrist during the rendering process is combined with a thickness-designation color. In contrast to the eighth specific example in which the marks have different shapes, the marks in this specific example have the same shape but have different colors for different thicknesses.

Specifically, in this specific example, a colored mark for each thickness is printed, adhered, or attached to an area to be image-captured in accordance with rotation of the wrist. In this case, the mark is an example of a feature appearing at the tip of a physical object used for rendering.

In FIG. 16A, the back of the right hand 3 is substantially facing the portable terminal 10. In other words, an image of the nail of the index finger is captured by the camera 12 (see FIG. 2) provided in the portable terminal 10. In FIG. 16A, a pink-colored rectangular mark 4A is adhered to the nail of the index finger. In this specific example, the pink-colored mark 4A corresponds to a thin line. Therefore, a “thin line” is rendered on the touchscreen 11 in conjunction with movement of the index finger.

In FIG. 16B, the wrist is slightly rotated such that an image of a side surface of the index finger is captured by the camera 12. In FIG. 16B, a green-colored rectangular mark 4B is adhered to the side surface of the index finger. In this specific example, the green-colored mark 4B corresponds to a medium-thick line. Therefore, a “medium-thick line” is rendered on the touchscreen 11 in conjunction with movement of the index finger.

In FIG. 16C, the wrist is further rotated such that an image of the front of the index finger is captured by the camera 12. In FIG. 16C, a red-colored rectangular mark 4C is adhered to the front of the index finger. In this specific example, the red-colored mark 4C corresponds to a thick line. Therefore, a “thick line” is rendered on the touchscreen 11 in conjunction with movement of the index finger.

In this specific example, the relationship between the appearance of the index finger and the thickness of the line to be rendered may be opposite from that in FIGS. 16A to 16C. Specifically, the pink-colored mark 4A to be image-captured in a state where the back of the right hand 3 is substantially facing the portable terminal 10 may correspond to a thick line, and the red-colored mark 4C to be image-captured in a state where the front of the index finger is viewable from the portable terminal 10 may correspond to a thin line.

Similar to the eighth specific example, with regard to the colored marks, marks with different colors may be individually printed on multiple fingers or marks with the same color may be printed on multiple fingers.

### Second Exemplary Embodiment

Usage Example and Apparatus Configuration

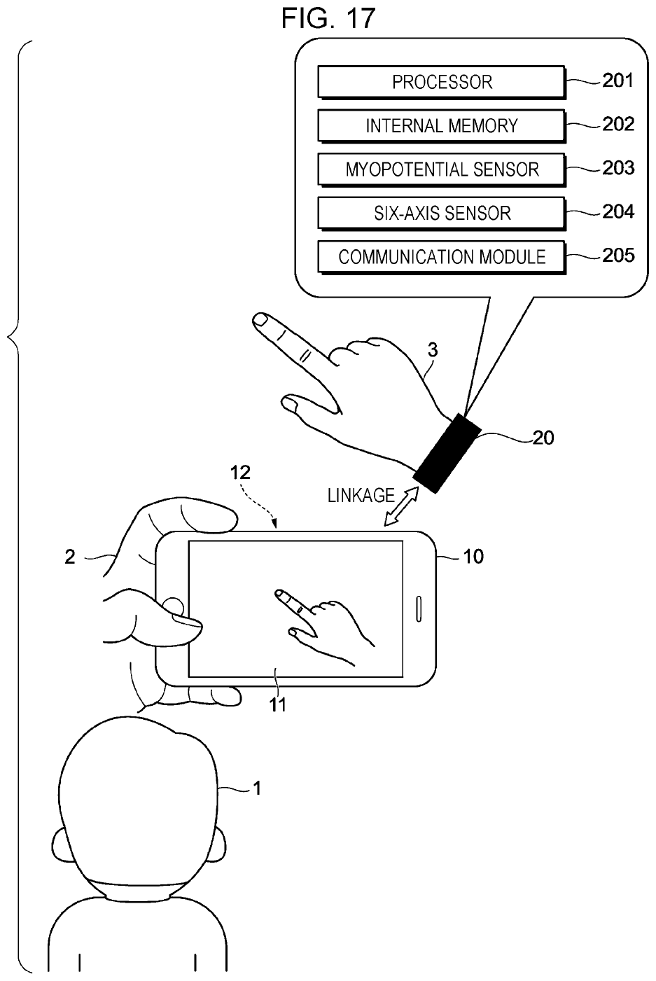

FIG. 17 illustrates a usage example of a portable terminal 10 according to a second exemplary embodiment. In FIG. 17, sections corresponding to those in FIG. 1 are given the corresponding reference signs.

In this exemplary embodiment, a wearable terminal 20 worn around the wrist of the right hand 3 used for giving a command for the direction of a line and the portable terminal 10 operate in cooperation with each other to give a command for the thickness of the line being rendered.

The wearable terminal 20 is, for example, a smartwatch or a bracelet.

The wearable terminal 20 shown in FIG. 17 has a processor 201, an internal memory 202, a myopotential sensor 203, a six-axis sensor 204, and a communication module 205 used for communicating with external apparatuses. One of the external apparatuses is the portable terminal 10.

The processor 201 is constituted of, for example, a CPU. The processor 201 realizes various types of functions by executing applications and firmware.

The internal memory 202 is a semiconductor memory. The internal memory 202 has a ROM having a BIOS stored therein, and a RAM used as a principal storage device. The processor 201 and the internal memory 202 constitute a so-called computer. The processor 201 uses the RAM as a work space for a program.

The myopotential sensor 203 measures the amount of activity of muscles intentionally moved by the user while the user renders a line in midair. For example, when the user moves the index finger in midair, the myopotential sensor 203 measures an electric signal produced as a result of the user making a tight first or a loose fist, and outputs the electric signal.

The six-axis sensor 204 measures acceleration along three axes (i.e., X axis, Y axis, and Z axis) and angular velocities along the same three axes. The six-axis sensor 204 is also used for measuring the moving direction and the moving speed of the wrist.

The communication module 205 used is, for example, a USB-compliant communication module, a communication module compliant with Bluetooth (registered trademark), a communication module compliant with a mobile communication system, or a communication module compliant with a wireless LAN.

### Specific Examples Used as Command for Thickness of Line

In this exemplary embodiment, an intensity value of an electric signal measured by the myopotential sensor 203 when a gesture is being made for rendering a line is reported from the wearable terminal 20 to the portable terminal 10, and is used for displaying an AR image.

A process executed in the portable terminal 10 is the same as that in the first exemplary embodiment. Specifically, the portable terminal 10 operates in accordance with the flowchart shown in FIG. 3. However, for the detection of the line thickness in step S6 (see FIG. 3), the value of the electric signal reported from the myopotential sensor 203 of the wearable terminal 20 is used.

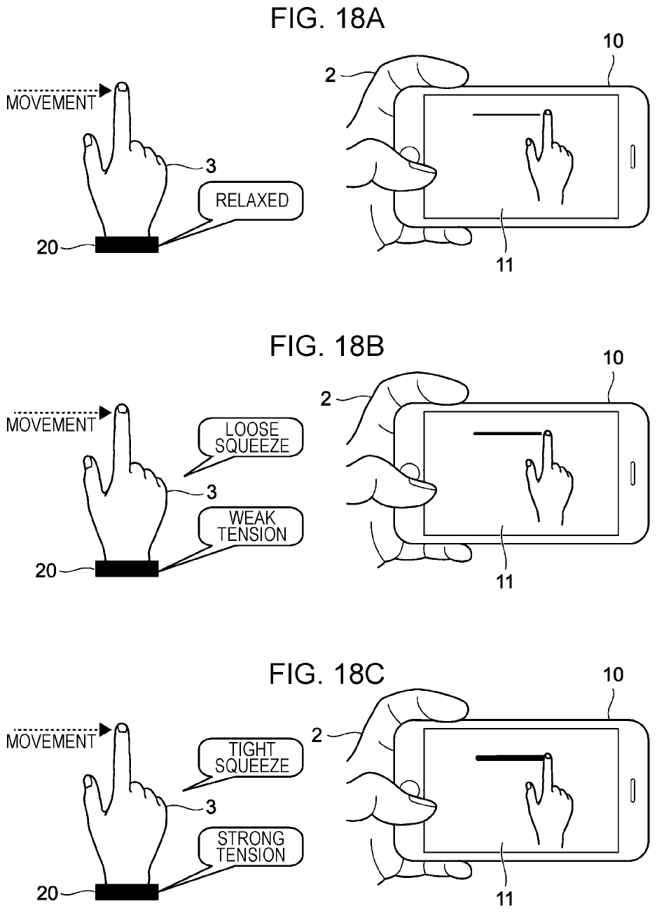

FIGS. 18A to 18C each illustrate a first specific example of a gesture used as a command for the thickness of a line to be rendered in the second exemplary embodiment. Specifically, FIG. 18A illustrates an example of a gesture used as a command for a “thin line”, FIG. 18B illustrates an example of a gesture used as a command for a “medium-thick line”, and FIG. 18C illustrates an example of a gesture used as a command for a “thick line”.

In each of FIGS. 18A to 18C, the left column indicates an example of a gesture used for simultaneously giving a command for the rendering of a line and a command for the thickness of the line, and the right column indicates an example of an AR image displayed on the touchscreen 11 of the portable terminal 10.

In FIGS. 18A to 18C, the fingertip of the index finger of the right hand 3 is used for rendering the line. In FIGS. 18A to 18C, the degree of tension in the wrist during the rendering process is used as the command for the thickness of the line.

In FIG. 18A, a line is rendered in midair by using the index finger while the wrist is maintained in a relaxed state. In this case, a “thin line” is rendered on the touchscreen 11 in conjunction with the rendering using the index finger.

In FIG. 18B, a line is rendered in midair by using the index finger while weak tension is applied to the wrist. In FIG. 18B, the magnitude of force applied to the first is expressed as “loose squeeze”. In this case, a “medium-thick line” is rendered on the display 111 in conjunction with the rendering using the index finger.

In FIG. 18C, a line is rendered in midair by using the index finger while strong tension is applied to the wrist. In FIG. 18C, the magnitude of force applied to the first is expressed as “tight squeeze”. In the case in FIG. 18C, the tension on the wrist is increased by making a tighter first than in the case in FIG. 18B. In this case, a “thick line” is rendered on the touchscreen 11 in conjunction with the rendering using the index finger.

Although a line is rendered by tracking the fingertip of the index finger of the right hand 3 in FIGS. 18A to 18C, another finger may be used for rendering a line. For example, the thumb or the little finger may be used.

Furthermore, instead of using a fingertip or fingertips for rendering a line, the entire right hand 3 may be used. In that case, the trajectory of the center of gravity of the right hand 3 or the center of the right hand 3 may be displayed as an AR image.

Moreover, although the right hand 3 is used for rendering a line in FIGS. 18A to 18C since the portable terminal 10 is supported with the left hand 2, the left hand 2 may be used for rendering a line if the portable terminal 10 is held with the right hand 3.

The magnitude of the value of the electric signal used for determining the line thickness and the degree of tension on the wrist has to be set for each user. For example, a threshold-value calibration process is executed before using this application. In the calibration process, a value of an electric signal measured at the wrist of the user is recorded through a guidance message, such as “please apply force to wrist when rendering thin line”. When the value of the electric signal is recorded for each line thickness, the processor 101 (see FIG. 2) sets a differentiation threshold value and uses the threshold value for the determination process in step S6.

### Third Exemplary Embodiment

Apparatus Configuration

The following description of a third exemplary embodiment relates to an apparatus configuration obtained by adding a feedback function to the first and second exemplary embodiments described above.

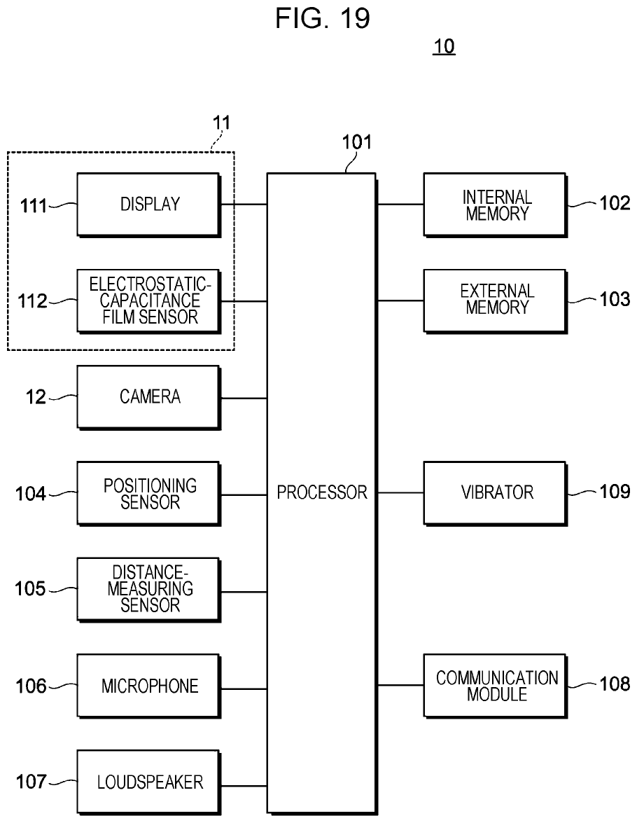

FIG. 19 illustrates an example of a hardware configuration of a portable terminal 10 used in the third exemplary embodiment. In FIG. 19, sections corresponding to those in FIG. 2 are given the corresponding reference signs.

The portable terminal 10 shown in FIG. 19 is different from the portable terminal 10 described in the first exemplary embodiment in having a vibrator 109. The vibrator 109 generates vibration with an intensity or pattern corresponding to the received thickness. In this exemplary embodiment, the user experiences feedback of the received thickness through vibration of the portable terminal 10.

Process

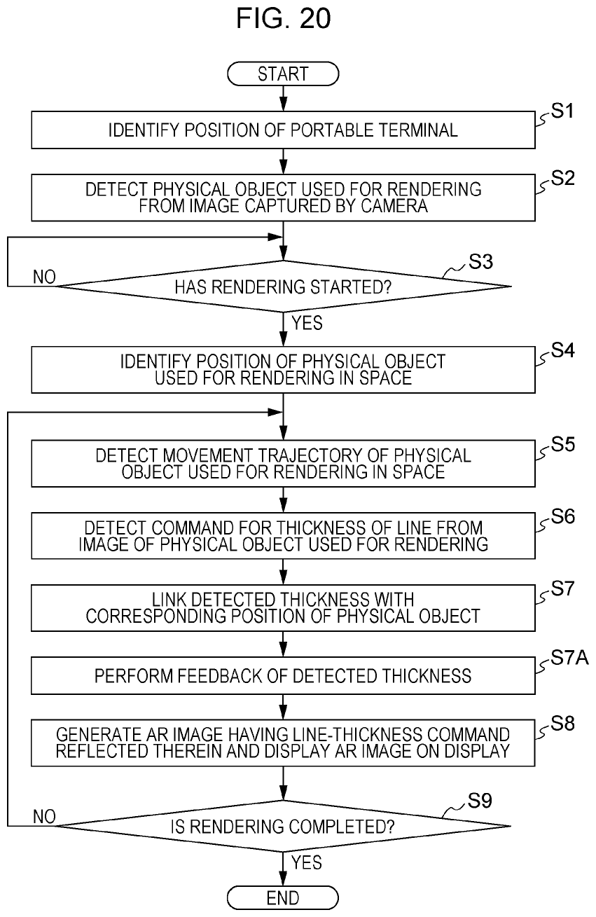

FIG. 20 is a flowchart illustrating an example of a process executed in the portable terminal 10 used in the third exemplary embodiment. In FIG. 20, sections corresponding to those in FIG. 3 are given the corresponding reference signs.

The process shown in FIG. 20 is executed by the processor 101 (see FIG. 19). In FIG. 20, a symbol “S” denotes a step.

Referring to FIG. 20, after step S7, feedback of the detected thickness is performed in step S7A, and step S8 is subsequently executed. Alternatively, the feedback of the thickness may be executed between step S6 and step S7.

In this exemplary embodiment, the feedback involves the use of vibration of the portable terminal 10. As mentioned above, the feedback involves the use of vibration with an intensity or pattern corresponding to the detected thickness. The number of vibration intensities or patterns prepared is equal to the number of types of thicknesses handled by the application.

### Specific Examples of Feedback

### First Specific Example

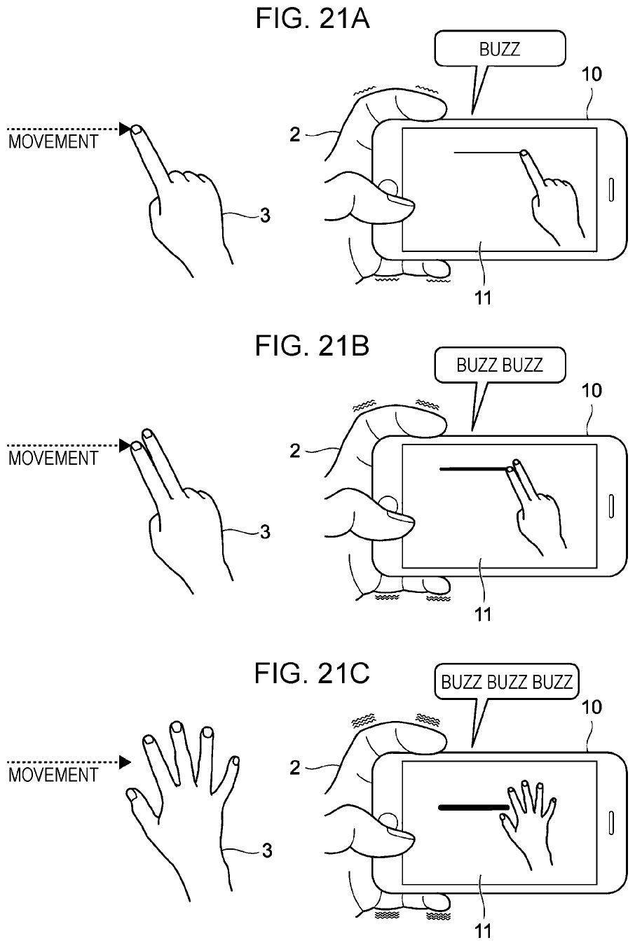

FIGS. 21A to 21C each illustrate a first specific example of feedback used in the third exemplary embodiment. Specifically, FIG. 21A illustrates an example of a gesture used as a command for a “thin line”, FIG. 21B illustrates an example of a gesture used as a command for a “medium-thick line”, and FIG. 21C illustrates an example of a gesture used as a command for a “thick line”.

In FIGS. 21A to 21C, sections corresponding to those in FIGS. 4A to 4C are given the corresponding reference signs.

In each of FIGS. 21A to 21C, the left column indicates an example of a gesture used for simultaneously giving a command for the rendering of a line and a command for the thickness of the line, and the right column indicates an example of an AR image displayed on the touchscreen 11 of the portable terminal 10.

In FIGS. 21A to 21C, the fingertip of the index finger of the right hand 3 is used for rendering the line. Furthermore, in FIGS. 21A to 21C, the command for the thickness of the line is given in accordance with the number of fingers used for the rendering.

In FIG. 21A, a “thin line” is rendered on the touchscreen 11 in conjunction with the rendering using the index finger. At the same time, the portable terminal 10 generates vibration with an intensity corresponding to the “thin line”. In FIG. 21A, the vibration is generated once in the form of “buzz”. This vibration is generated with a predetermined intensity.

In FIG. 21B, a “medium-thick line” is rendered on the touchscreen 11 in conjunction with the rendering using two fingers, namely, the index finger and the middle finger. At the same time, the portable terminal 10 generates vibration with an intensity corresponding to the “medium-thick line”. In FIG. 21B, the vibration is generated twice in the form of “buzz buzz”. This vibration is generated with a predetermined intensity. In addition to the larger number of times the vibration is generated, the intensity of the vibration may be larger than that in the case of the “thin line”.

In FIG. 21C, a “thick line” is rendered on the touchscreen 11 in conjunction with the rendering using the five fingers in a spread-out state. At the same time, the portable terminal 10 generates vibration with an intensity corresponding to the “thick line”. In FIG. 21C, the vibration is generated three times in the form of “buzz buzz buzz”. This vibration is generated with a predetermined intensity. In addition to the larger number of times the vibration is generated, the intensity of the vibration may be larger than that in the case of the “medium-thick line”.

In this specific example, the vibration is transmitted to the user through the left hand holding the portable terminal 10.

### Second Specific Example

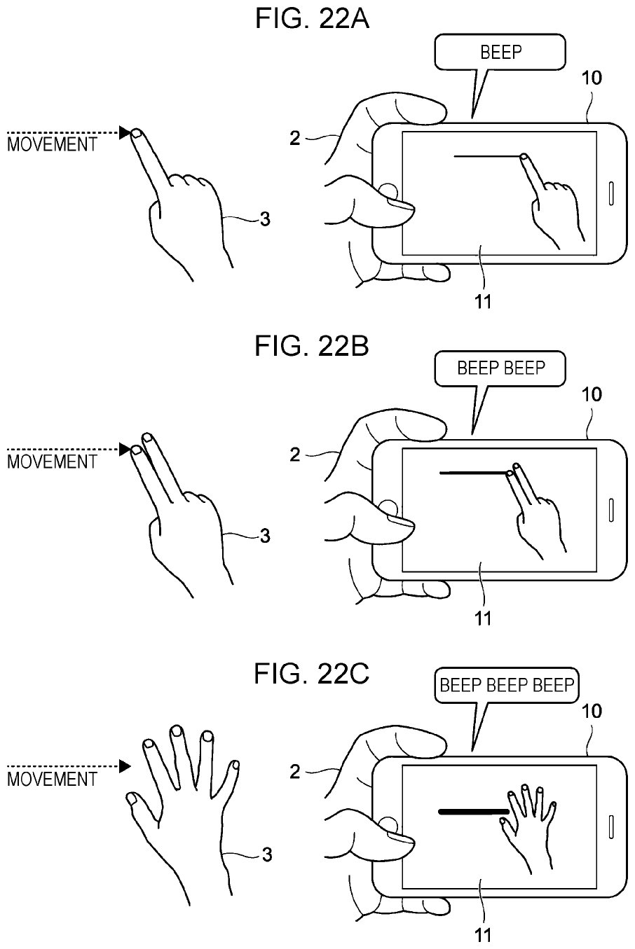

FIGS. 22A to 22C each illustrate a second specific example of feedback used in the third exemplary embodiment. Specifically, FIG. 22A illustrates an example of a gesture used as a command for a “thin line”, FIG. 22B illustrates an example of a gesture used as a command for a “medium-thick line”, and FIG. 22C illustrates an example of a gesture used as a command for a “thick line”.

In FIGS. 22A to 22C, sections corresponding to those in FIGS. 4A to 4C are given the corresponding reference signs.

In each of FIGS. 22A to 22C, the left column indicates an example of a gesture used for simultaneously giving a command for the rendering of a line and a command for the thickness of the line, and the right column indicates an example of an AR image displayed on the touchscreen 11 of the portable terminal 10.

In FIGS. 22A to 22C, the fingertip of the index finger of the right hand 3 is used for rendering the line. Furthermore, in FIGS. 22A to 22C, the command for the thickness of the line is given in accordance with the number of fingers used for the rendering.

In FIG. 22A, a “thin line” is rendered on the touchscreen 11 in conjunction with the rendering using the index finger. At the same time, the portable terminal 10 generates sound for the number of times corresponding to the “thin line”. In FIG. 22A, the sound is generated once in the form of “beep”. The sound is output from the loudspeaker 107 (see FIG. 19). This sound is generated with a predetermined sound volume.

In FIG. 22B, a “medium-thick line” is rendered on the touchscreen 11 in conjunction with the rendering using two fingers, namely, the index finger and the middle finger. At the same time, the portable terminal 10 generates sound for the number of times corresponding to the “medium-thick line”. In FIG. 22B, the sound is generated twice in the form of “beep beep”. This sound is generated with a predetermined sound volume. The sound volume may be greater than that in the case of the “thin line”.

In FIG. 22C, a “thick line” is rendered on the touchscreen 11 in conjunction with the rendering using the five fingers in a spread-out state. At the same time, the portable terminal 10 generates sound for the number of times corresponding to the “thick line”. In FIG. 22C, the sound is generated three times in the form of “beep beep beep”. This sound is generated with a predetermined sound volume. The sound volume may be greater than that in the case of the “medium-thick line”. Alternatively, the frequency of the sound or the melody may be changed in accordance with the line thickness.

### Other Specific Examples

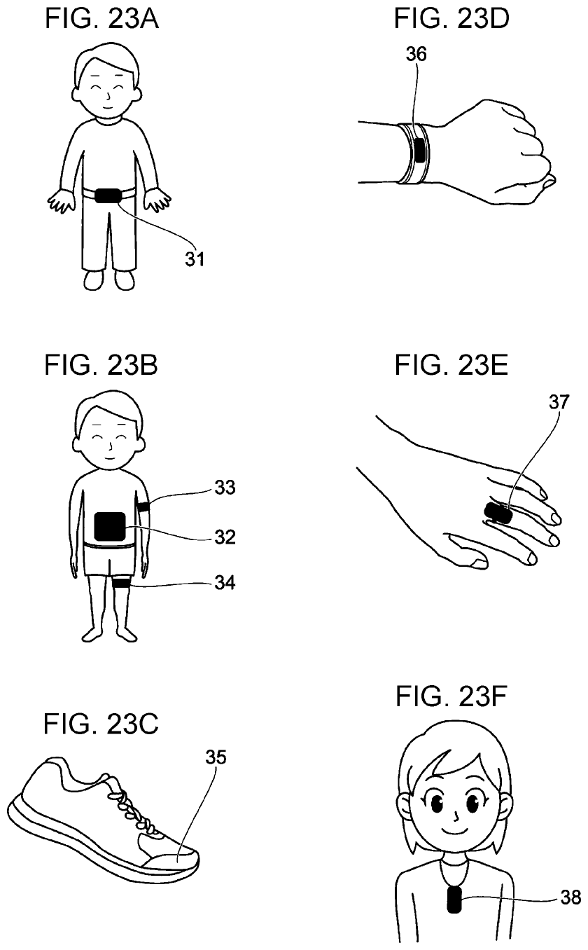

FIGS. 23A to 23F illustrate other specific examples of feedback. Specifically, FIG. 23A illustrates an example of feedback using a belt buckle 31, FIG. 23B illustrates an example of feedback using a device 32 worn on the stomach, a device 33 worn around an arm, and a device 34 worn around a leg, FIG. 23C illustrates an example of feedback using a shoe 35, FIG. 23D illustrates an example of feedback using a device 36 worn around a wrist, FIG. 23E illustrates an example of feedback using a device 37 worn on a finger, and FIG. 23F illustrates an example of feedback using a device 38 worn around the neck.

Each of the devices shown in FIGS. 23A to 23F is linked with the portable terminal 10 via a communication interface (not shown), and receives a notification about the line thickness received by the portable terminal 10 so as to cause an internal loudspeaker or vibrator to operate.

Similar to the first and second specific examples, the vibration intensity or pattern, the sound volume, or the number of times sound is to be output may be changed so that the user may be notified how the line-thickness command given using the gesture during the rendering process is received.

### Fourth Exemplary Embodiment

Apparatus Configuration

The following description of a fourth exemplary embodiment relates to a mechanism for performing feedback of information about the received line thickness to the index finger during a rendering process.

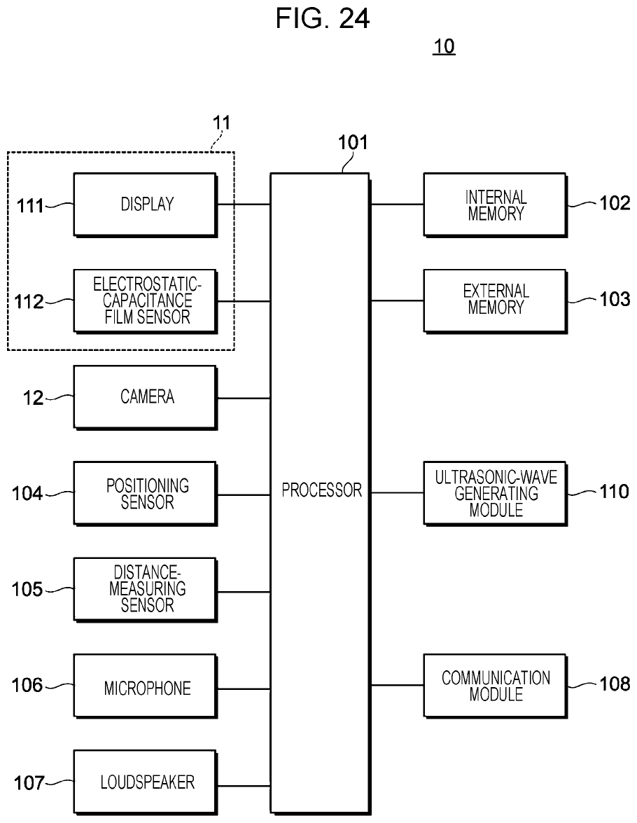

FIG. 24 illustrates an example of a hardware configuration of a portable terminal 10 used in the fourth exemplary embodiment. In FIG. 24, sections corresponding to those in FIG. 19 are given the corresponding reference signs.

In the portable terminal 10 shown in FIG. 24, an ultrasonic-wave generating module 110 is used in place of the vibrator 109 (see FIG. 19). The ultrasonic-wave generating module 110 is a group of multiple ultrasonic-wave vibrators. In this exemplary embodiment, the ultrasonic-wave generating module 110 radiates an ultrasonic wave onto the fingertip of the index finger so as to provide haptic feedback corresponding to the received thickness.

### Specific Examples of Feedback

### First Specific Example

A process executed in the portable terminal 10 used in this exemplary embodiment is the same as that in the third exemplary embodiment. Specifically, the portable terminal 10 operates in accordance with the flowchart shown in FIG. 3. However, for the detection of the line thickness in step S6 (see FIG. 3), a user's gesture is used, as in the first exemplary embodiment.

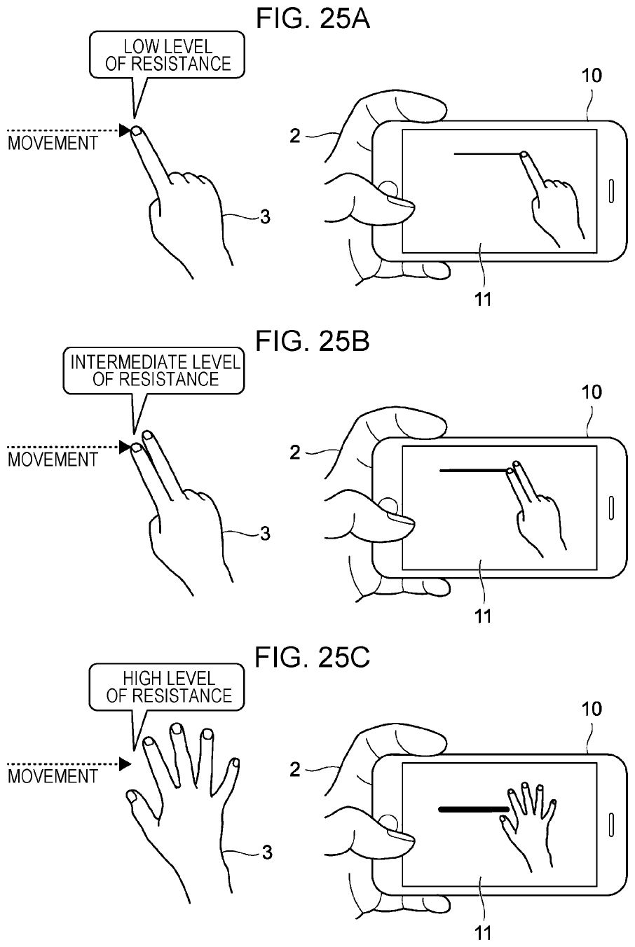

FIGS. 25A to 25C each illustrate a first specific example of a gesture used as a command for the thickness of a line to be rendered in the fourth exemplary embodiment. Specifically, FIG. 25A illustrates an example of a gesture used as a command for a “thin line”, FIG. 25B illustrates an example of a gesture used as a command for a “medium-thick line”, and FIG. 25C illustrates an example of a gesture used as a command for a “thick line”.

In each of FIGS. 25A to 25C, the left column indicates an example of a gesture used for simultaneously giving a command for the rendering of a line and a command for the thickness of the line, and the right column indicates an example of an AR image displayed on the touchscreen 11 of the portable terminal 10.

In FIGS. 25A to 25C, the fingertip of the index finger of the right hand 3 is used for rendering the line. Furthermore, in FIGS. 25A to 25C, the command for the thickness of the line is given in accordance with the number of fingers used for the rendering.

In FIG. 25A, a “thin line” is rendered on the touchscreen 11 in conjunction with the rendering using the index finger. In this case, the index finger of the user receives, for example, a force, vibration, or motion called “acoustic radiation pressure” in accordance with an ultrasonic wave radiated from the ultrasonic-wave generating module 110 (see FIG. 24). This technology is also called midair haptics. In FIG. 25A, the fingertip moving in midair experiences feedback with a low level of resistance against the movement of the fingertip.

In FIG. 25B, a “medium-thick line” is rendered on the touchscreen 11 in conjunction with the rendering using two fingers, namely, the index finger and the middle finger. In this case, the index finger and the middle finger of the user experience feedback with an intermediate level of resistance against the movement of the fingertips.

In FIG. 25C, a “thick line” is rendered on the touchscreen 11 in conjunction with the rendering using the five fingers in a spread-out state. In this case, the user's hand experiences feedback with a high level of resistance against the movement of the fingertips.

### Second Specific Example

In contrast to the first specific example in which an ultrasonic wave is radiated onto the fingertip or fingertips during the rendering from the portable terminal 10, the ultrasonic wave may be radiated onto the fingertip or fingertips during the rendering from a different apparatus linked with the portable terminal 10.

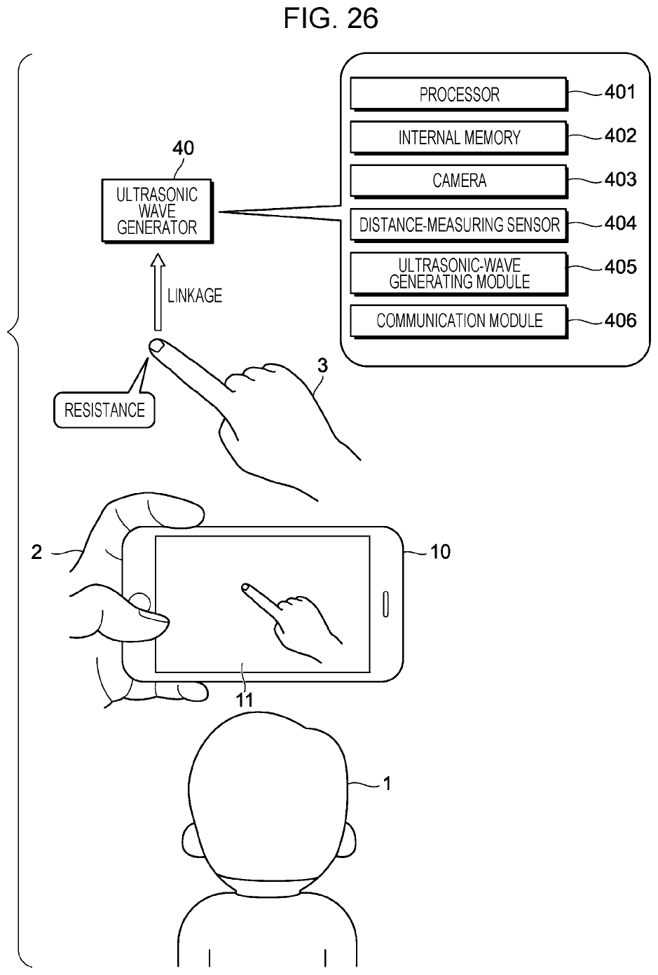

FIG. 26 illustrates a usage example of the portable terminal 10 according to the fourth exemplary embodiment. In FIG. 26, sections corresponding to those in FIG. 17 are given the corresponding reference signs.

The portable terminal 10 shown in FIG. 26 has a mechanism different from that in the first specific example in that the portable terminal 10 transmits the line thickness detected in step S7 (see FIG. 20) or a control signal corresponding to the line thickness to an ultrasonic wave generator 40 linked with the portable terminal 10 via wireless communication.

The ultrasonic wave generator 40 may be disposed in a space as a dedicated apparatus or may be contained in an electrical household appliance or a video apparatus.

The ultrasonic wave generator 40 shown in FIG. 26 has a processor 401, an internal memory 402, a camera 403, a distance-measuring sensor 404, an ultrasonic-wave generating module 405, and a communication module 406 used for communicating with external apparatuses. One of the external apparatuses is the portable terminal 10.

The processor 401 is constituted of, for example, a CPU. The processor 401 realizes various types of functions by executing applications and firmware.

The internal memory 402 is a semiconductor memory. The internal memory 402 has a ROM having a BIOS stored therein, and a RAM used as a principal storage device. The processor 401 and the internal memory 402 constitute a so-called computer. The processor 401 uses the RAM as a work space for a program.

The camera 403 is used for detecting an irradiation destination for an ultrasonic wave. In the case of this specific example, the irradiation destination is the fingertip used for the rendering.

The distance-measuring sensor 404 measures the distance from the ultrasonic wave generator 40 to the fingertip used for the rendering. For example, if the camera 403 includes stereo cameras, the distance-measuring sensor 404 used is a module that calculates the distance to the fingertip by using a parallax between the multiple cameras 403. Another example of the distance-measuring sensor 404 used is a module that calculates the distance to the fingertip by measuring the time it takes for radiated light to return after being reflected by a physical object.

The ultrasonic-wave generating module 405 is a group of multiple ultrasonic wave vibrators and radiates an ultrasonic wave toward the fingertip identified by the camera 403 and the distance-measuring sensor 404 during the rendering. In this case, the type and intensity of the ultrasonic wave to be radiated are determined in accordance with the line thickness detected by the portable terminal 10.

An image of the fingertip serving as the irradiation target and the absolute coordinates of the fingertip are given from the portable terminal 10. For example, if the local coordinate system of the ultrasonic wave generator 40 is matched with the absolute coordinate system, an ultrasonic wave is radiated toward the absolute coordinates given from the portable terminal 10, so that the fingertip used for the rendering may receive feedback.

The communication module 406 used is, for example, a USB-compliant communication module, a communication module compliant with Bluetooth (registered trademark), a communication module compliant with a mobile communication system, or a communication module compliant with a wireless LAN.

In this specific example, the fingertip used for the rendering receives feedback with an intensity or pattern corresponding to the line thickness designated by the user, so that the fingertip used for the rendering experiences feedback corresponding to the detected line thickness.

### Fifth Exemplary Embodiment

Apparatus Configuration and Process

The following description of a fifth exemplary embodiment relates to a mechanism for changing the density of a line rendered in midair during the rendering process based on a captured image of a user's gesture.

In this exemplary embodiment, the portable terminal 10 described above with reference to FIG. 1 is used. Therefore, the hardware configuration of the portable terminal 10 is identical to that in the first exemplary embodiment. The difference is in the process performed by the processor 101.

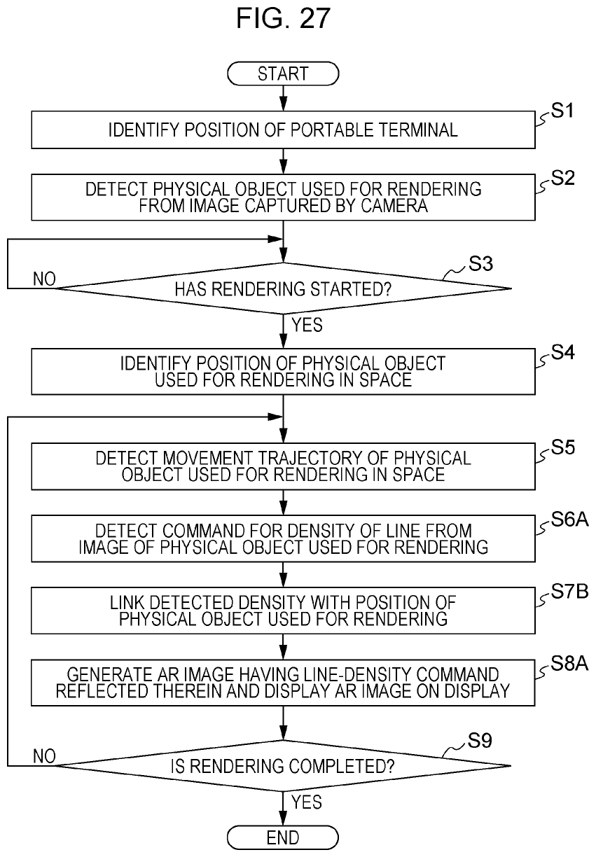

FIG. 27 is a flowchart illustrating an example of the process executed in the portable terminal 10 used in the fifth exemplary embodiment. In FIG. 27, sections corresponding to those in FIG. 3 are given the corresponding reference signs.

The process shown in FIG. 27 is different from that in FIG. 3 in terms of the process after step S5.

Referring to FIG. 27, after step S5, the processor 101 detects a command for the density of a line (sometimes referred to as “line-density command” hereinafter) from the image of the physical object used for the rendering in step S6A. In contrast to step S6 in FIG. 3 in which a line-thickness command is detected, a line-density command is detected in this exemplary embodiment. The line-density command may be given by using the methods described in the first to ninth specific examples of the first exemplary embodiment.

When the line-density command is detected, the processor 101 links the detected density with the position of the physical object used for the rendering in step S7B. As a result of this linkage, the density of the line becomes changeable during the rendering process.

In step S8A, the processor 101 generates an AR image having the line-density command reflected therein, and displays the AR image on the display 111. Accordingly, the user may simultaneously confirm an object being rendered in midair and the density of a line by viewing the touchscreen 11.

Subsequently, the processor 101 determines in step S9 whether or not the rendering is completed. For example, if the physical object moving in midair becomes stationary in midair, the processor 101 determines that the rendering is completed.

For example, if it is determined that the user's fingertip remains at a certain position in the screen for a predetermined time period or longer, the processor 101 obtains a positive result in step S9. The time period used for determining that the user's fingertip is stationary may be the same as or different from the time period used for determining that the rendering has started. For example, one second is set as the threshold value. It is desirable that the threshold value be changeable by the user.

Furthermore, for example, the processor 101 may determine that the rendering is completed when a specific gesture is detected.

The specific gesture may be midair tapping, double tapping, or swiping in empty space. The gesture used for determining that the rendering is completed may be different from the gesture used for determining that the rendering has started.

Moreover, the processor 101 may detect a start command and an end command based on user's voice.

If a determination condition is not satisfied, the processor 101 obtains a negative result in step S9 and returns to step S5.

### Specific Examples Used as Command for Density of Line

Specific examples of gestures assumed in step S6A (see FIG. 27) will be described below.

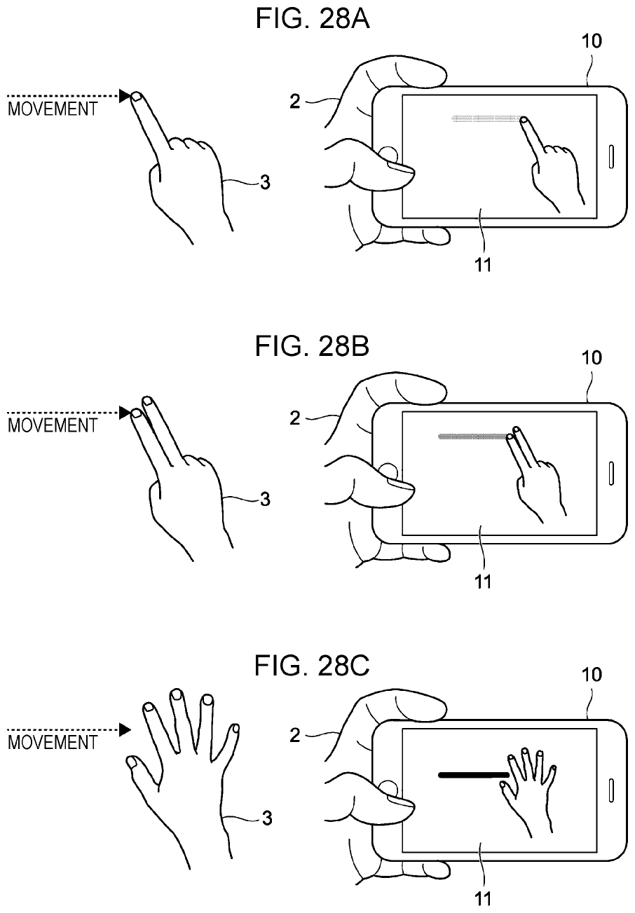

FIGS. 28A to 28C each illustrate a specific example of a gesture used as a command for the density of a line to be rendered in the fifth exemplary embodiment. Specifically, FIG. 28A illustrates an example of a gesture used as a command for a “faint line”, FIG. 28B illustrates an example of a gesture used as a command for a “slightly dark line”, and FIG. 28C illustrates an example of a gesture used as a command for a “dark line”.

In each of FIGS. 28A to 28C, the left column indicates an example of a gesture used for simultaneously giving a command for the rendering of a line and a command for the density of the line, and the right column indicates an example of an AR image displayed on the touchscreen 11 of the portable terminal 10.

In FIGS. 28A to 28C, the fingertip of the index finger of the right hand 3 is used for rendering the line. Furthermore, in FIGS. 28A to 28C, the command for the density of the line is given in accordance with the number of fingers used for the rendering.

In FIG. 28A, a “faint line” is rendered on the touchscreen 11 in conjunction with the rendering using the index finger.

In FIG. 28B, a “slightly dark line” is rendered on the touchscreen 11 in conjunction with the rendering using two fingers, namely, the index finger and the middle finger. The term “slightly dark line” refers to a line with a density higher than that of a “faint line”.

In FIG. 28C, a “dark line” is rendered on the touchscreen 11 in conjunction with the rendering using the five fingers in a spread-out state. The term “dark line” refers to a line with a density higher than that of a “slightly dark line”.

In this specific example, the density of the rendered line increases with increasing number of fingers. Alternatively, with the same number of fingers, commands for different densities may be given by varying the combination of fingers used for the rendering. For example, a command for rendering a “faint line” may be given by using two fingers, namely, the index finger and the little finger, and a command for rendering a “dark line” may be given by using two fingers, namely, the index finger and the thumb.

Although a line is rendered by tracking the fingertip of the index finger of the right hand 3 in FIGS. 28A to 28C, the little finger or the thumb may be used for rendering a line. The selection of any of the fingers to be used for rendering a line may be made in advance.

Furthermore, instead of using a fingertip or fingertips for rendering a line, the entire right hand 3 may be used. In that case, the trajectory of the center of gravity of the right hand 3 or the center of the right hand 3 may be displayed as an AR image. The same applies to other specific examples to be described below.

Moreover, although the right hand 3 is used for rendering a line in FIGS. 28A to 28C since the portable terminal 10 is held with the left hand 2, the left hand 2 may be used for rendering a line if the portable terminal 10 is held with the right hand 3.

As mentioned above, a line-thickness command in each of the second to ninth specific examples in the first exemplary embodiment may be read as a line-density command. In detail, in each specific example, a “thin line” may be read as a “faint line”, a “medium-thick line” may be read as a “slightly dark line”, and a “thick line” may be read as a “dark line”.

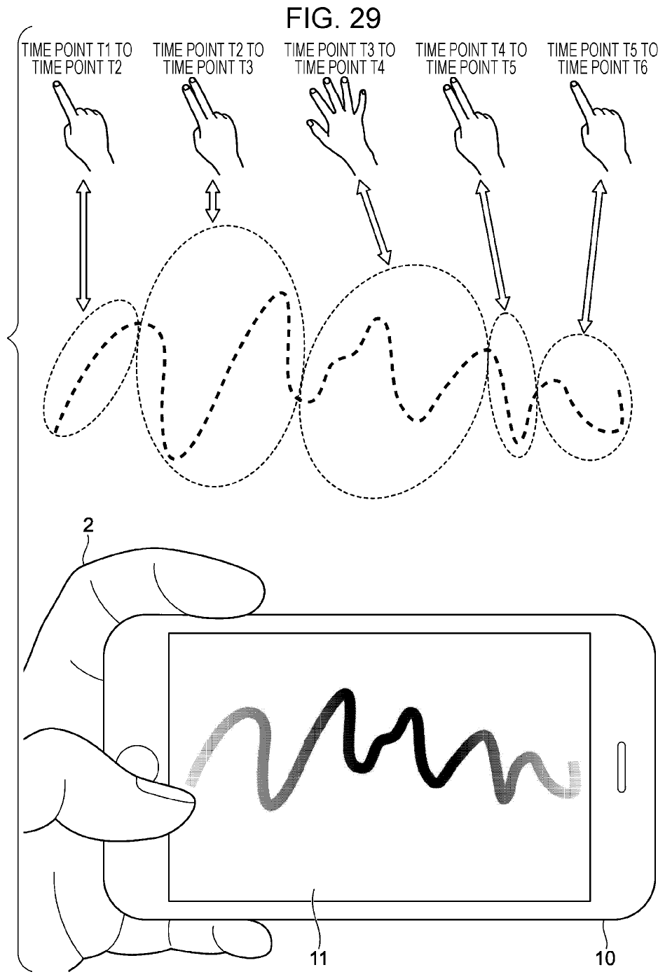

FIG. 29 illustrates an example of an AR image rendered when variations in the number of fingers are combined while the index finger is moved in midair. In FIG. 29, sections corresponding to those in FIG. 6 are given the same reference signs.

In FIG. 29, the rendering process involves using one finger between a time point T1 and a time point T2, using two fingers between the time point T2 and a time point T3, using five fingers between the time point T3 and a time point T4, using two fingers between the time point T4 and a time point T5, and using one finger between the time point T5 and a time point T6.

In the example in FIG. 29, the line density changes while the line thickness remains to be the same. The AR image displayed on the touchscreen 11 may undergo a density-change smoothing process such that the changes in the line density appear to be natural.

As shown in FIG. 29, in this exemplary embodiment, the density of a line being rendered is changeable as desired by the user. In the related art, the expressiveness of lines to be rendered is limited since only lines with the same density may be rendered during the rendering process. In contrast, in this exemplary embodiment, the line density is freely changeable, so that an object that reflects user's uniqueness and sensitivity may be readily rendered.

### Sixth Exemplary Embodiment

### Usage Example

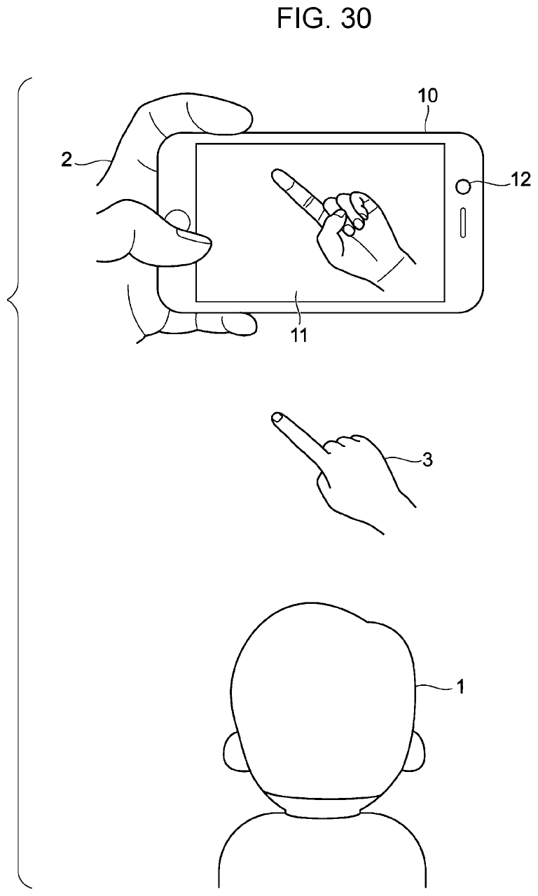

FIG. 30 illustrates a usage example of a portable terminal 10 according to a sixth exemplary embodiment. In FIG. 30, sections corresponding to those in FIG. 1 are given the corresponding reference signs.

This exemplary embodiment is different from the first to fifth exemplary embodiments described above in that a finger used for rendering is positioned between the user 1 and the portable terminal 10. Other features are identical to those in the first to fifth exemplary embodiments, including the hardware configuration of the portable terminal 10 and the process performed therein. Specifically, this exemplary embodiment is the same as the first to fifth exemplary embodiments except for the positional relationship among the user 1, the right hand 3 used for the rendering, and the portable terminal 10.

### Specific Examples Used as Command for Thickness and Density of Line

Specific examples of gestures assumed in step S6 (see FIG. 3) will be described below.

### First Specific Example

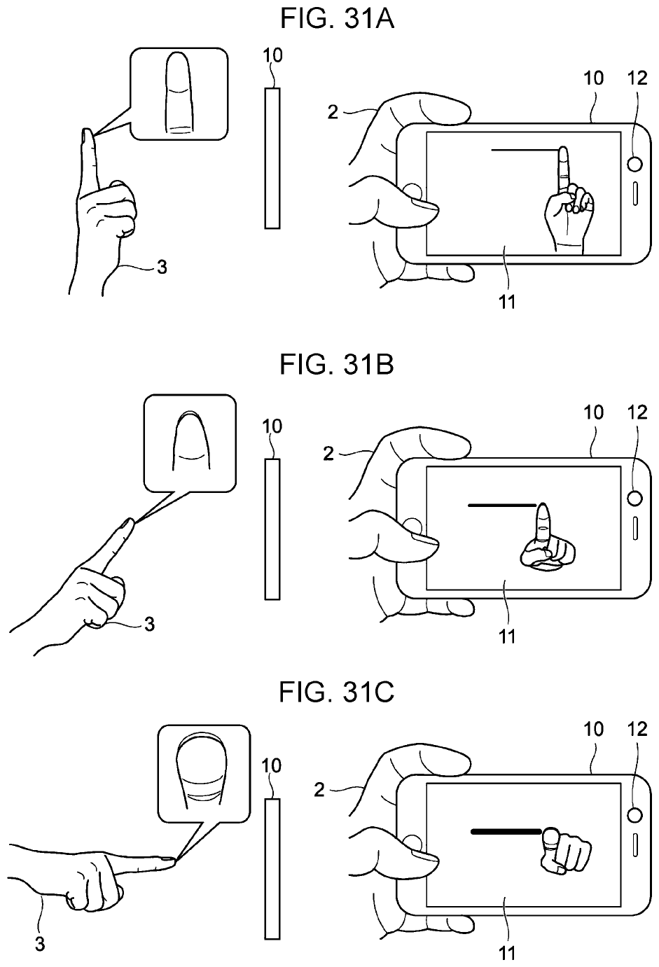

FIGS. 31A to 31C each illustrate a first specific example of a gesture used as a command for the thickness of a line to be rendered in the sixth exemplary embodiment. Specifically, FIG. 31A illustrates an example of a gesture used as a command for a “thin line”, FIG. 31B illustrates an example of a gesture used as a command for a “medium-thick line”, and FIG. 31C illustrates an example of a gesture used as a command for a “thick line”.

In each of FIGS. 31A to 31C, the left column indicates an example of a gesture used for simultaneously giving a command for the rendering of a line and a command for the thickness of the line, and the right column indicates an example of an AR image displayed on the touchscreen 11 of the portable terminal 10.

In FIGS. 31A to 31C, the touchscreen 11 of the portable terminal 10 displays an image captured by the camera 12 that is provided at the same surface as the touchscreen 11. This feature is different from the first to fifth exemplary embodiments in which the touchscreen 11 displays an image captured by the camera 12 that is provided at the surface opposite the touchscreen 11.

In FIGS. 31A to 31C, the fingertip of the index finger of the right hand 3 is used for rendering the line. However, in FIGS. 31A to 31C, the command for the thickness of the line is given in accordance with variations in the degree of inclination of the right hand 3. In other words, the command for the thickness of the line is given in accordance with variations in how the index finger appears or how the back of the right hand 3 appears.

The command for the thickness of the line is given in the example in FIGS. 31A to 31C based on variations in the orientation of the index finger within a plane defined by the direction of the normal to the touchscreen 11 of the portable terminal 10 and by the vertical direction. Therefore, the left column in each of FIGS. 31A to 31C indicates the positional relationship when the portable terminal 10 and the right hand 3 are observed from a side surface.

In FIG. 31A, the index finger is oriented vertically upward. In other words, the palm of the right hand 3 is entirely viewable through the camera 12 (see FIG. 2) provided in the portable terminal 10. In this case, a “thin line” is rendered on the touchscreen 11 in conjunction with movement of the index finger.

In FIG. 31B, the index finger is inclined at substantially 45° relative to the direction of the portable terminal 10. In other words, the height from the tip of the index finger to the wrist appears to be smaller than that in FIG. 31A. In this case, a “medium-thick line” is rendered on the touchscreen 11 in conjunction with movement of the index finger.

In FIG. 31C, the index finger is inclined to be substantially parallel to the imaging direction. In other words, the index finger and the back of the right hand 3 are substantially non-viewable. In this case, a “thick line” is rendered on the touchscreen 11 in conjunction with movement of the index finger.

In this specific example, the relationship between the appearance of the index finger and the thickness of the line to be rendered may be opposite from that in FIGS. 31A to 31C. Specifically, the index finger oriented vertically upward may correspond to a thick line, and the index finger oriented in the imaging direction may correspond to a thin line.

With the same gesture, the line density may be designated instead of the line thickness. Furthermore, the user may receive feedback of the detected line thickness or line density through vibration or haptic feedback during the rendering process.

### Second Specific Example

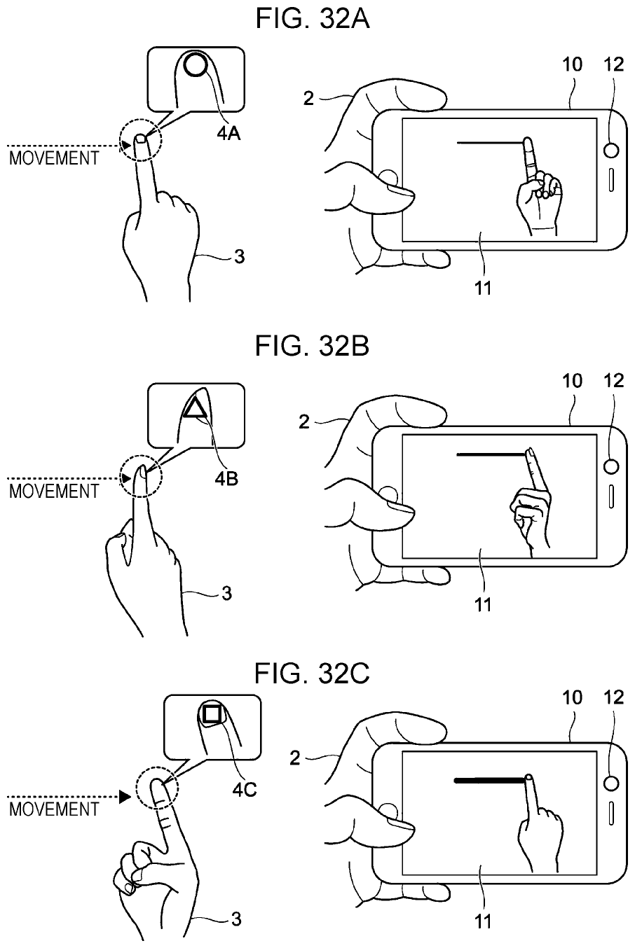

FIGS. 32A to 32C each illustrate a second specific example of a gesture used as a command for the thickness of a line to be rendered in the sixth exemplary embodiment. Specifically, FIG. 32A illustrates an example of a gesture used as a command for a “thin line”, FIG. 32B illustrates an example of a gesture used as a command for a “medium-thick line”, and FIG. 32C illustrates an example of a gesture used as a command for a “thick line”. In FIGS. 32A to 32C, sections corresponding to those in FIGS. 15A to 15C are given the corresponding reference signs.

In each of FIGS. 32A to 32C, the left column indicates an example of a gesture used for simultaneously giving a command for the rendering of a line and a command for the thickness of the line, and the right column indicates an example of an AR image displayed on the touchscreen 11 of the portable terminal 10. The left column shows the state of the right hand 3, as viewed from the user. The right column displays an image captured by the camera 12 that is provided at the same surface as the touchscreen 11.

In FIGS. 32A to 32C, the fingertip of the index finger of the right hand 3 is used for rendering the line. However, in this specific example, a gesture of rotating the right wrist during the rendering process is combined with a thickness-designation mark. Specifically, in this specific example, a thickness-designation mark is printed, adhered, or attached to an area to be image-captured in accordance with rotation of the wrist. In this case, the mark is an example of a feature appearing at the tip of a physical object used for rendering.

In FIG. 32A, the front of the index finger is substantially facing the portable terminal 10. Therefore, an image of the circular mark 4A printed on the front of the index finger is captured by the camera 12 provided in the portable terminal 10. In this specific example, the circular mark 4A corresponds to a thin line. Therefore, a “thin line” is rendered on the touchscreen 11 in conjunction with movement of the index finger.

In FIG. 32B, the wrist is slightly rotated such that an image of a side surface of the index finger is captured by the camera 12. In FIG. 32B, the triangular mark 4B is adhered to the side surface of the index finger. This triangular mark 4B corresponds to a medium-thick line. Therefore, a “medium-thick line” is rendered on the touchscreen 11 in conjunction with movement of the index finger.

In FIG. 32C, the wrist is further rotated such that an image of the nail of the index finger is captured by the camera 12. In FIG. 32C, the rectangular mark 4C is adhered to the nail of the index finger. This rectangular mark 4C corresponds to a thick line. Therefore, a “thick line” is rendered on the touchscreen 11 in conjunction with movement of the index finger.

In this specific example, the relationship between the appearance of the index finger and the thickness of the line to be rendered may be opposite from that in FIGS. 32A to 32C. Specifically, the mark 4A to be image-captured in a state where the front of the right hand 3 is substantially facing the portable terminal 10 may correspond to a thick line, and the mark 4C to be image-captured in a state where the nail of the index finger is viewable from the portable terminal 10 may correspond to a thin line.

The shape of each mark mentioned above is merely an example, and may be a different shape. Furthermore, each of the marks may be replaced with a barcode or a QR code (registered trademark), or may be replaced with text or an icon. The barcode mentioned here is also an example of a feature appearing at the tip of a physical object used for rendering.

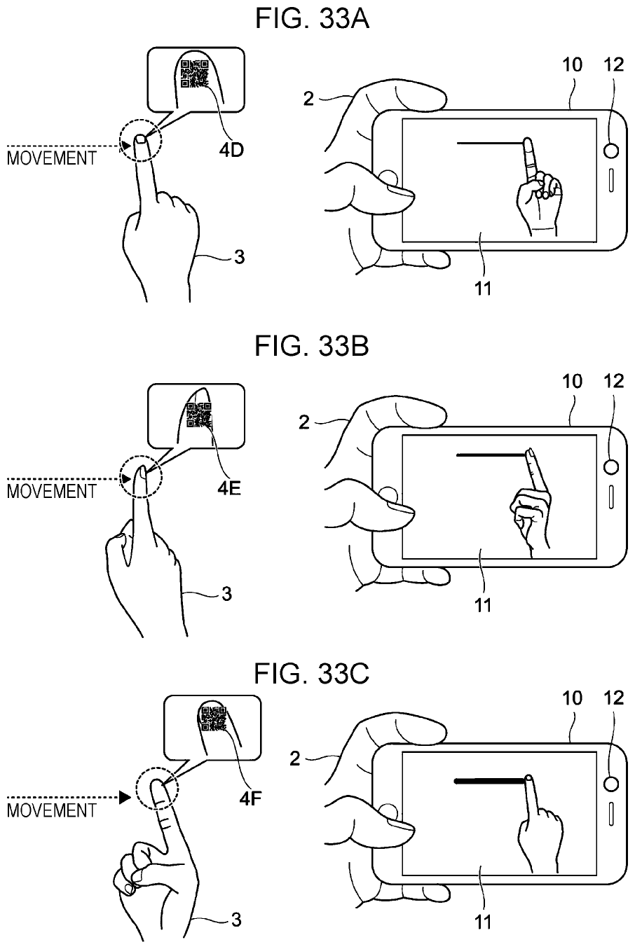

FIGS. 33A to 33C illustrate cases where multiple types of QR codes are disposed at the fingertip.

FIGS. 33A to 33C each illustrate another example of a gesture used as a command for the thickness of a line to be rendered in the sixth exemplary embodiment. Specifically, FIG. 33A illustrates an example of a gesture used as a command for a “thin line”, FIG. 33B illustrates an example of a gesture used as a command for a “medium-thick line”, and FIG. 33C illustrates an example of a gesture used as a command for a “thick line”. In FIGS. 33A to 33C, sections corresponding to those in FIGS. 32A to 32C are given the corresponding reference signs.

QR codes 4D, 4E, and 4F respectively correspond to different line thicknesses. Therefore, the portable terminal 10 determines the line thickness by analyzing a barcode image-captured simultaneously with movement of a finger rendering a line in midair.

With the same gesture, the line density may be designated instead of the line thickness. Furthermore, the user may receive feedback of the detected line thickness or line density through vibration or haptic feedback during the rendering process.

### Seventh Exemplary Embodiment

In the above exemplary embodiments, a line rendered in midair and the thickness of the line are determined by using an image captured by the camera 12 provided in the portable terminal 10. Alternatively, a line rendered in midair and the thickness of the line may be determined by using an image captured by a different camera linked with the portable terminal 10.

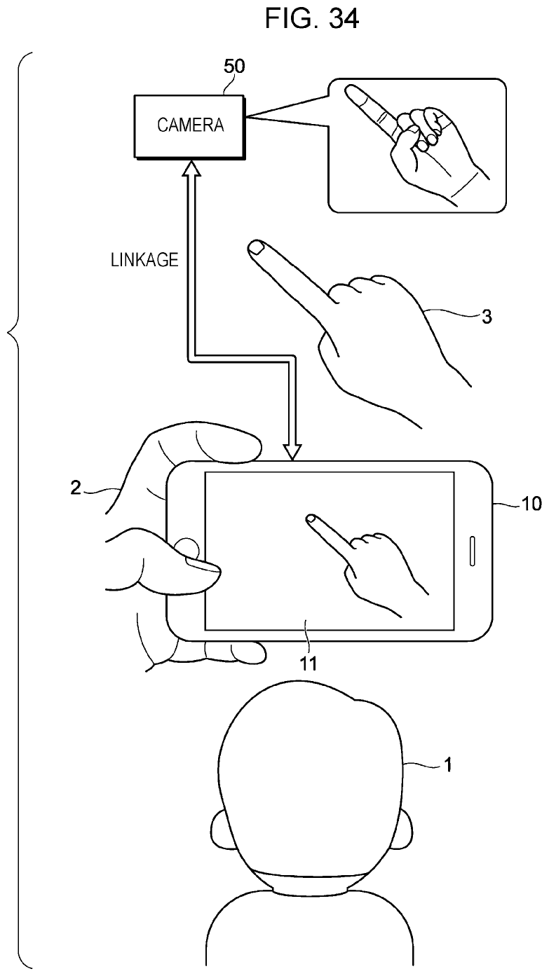

FIG. 34 illustrates a usage example of a portable terminal 10 according to a seventh exemplary embodiment. In FIG. 34, sections corresponding to those in FIG. 1 are given the corresponding reference signs.

In FIG. 34, the portable terminal 10 uses the camera 12 provided therein to capture an image of the direction in which a fingertip used for rendering moves in midair and displays the image on the touchscreen 11, but the thickness of the rendered line is determined by analyzing an image captured by a camera 50.

In this case, the camera 50 may be, for example, an electrical household appliance or a security camera. Furthermore, the camera 50 may be a camera 12 provided in a wirelessly-connected portable terminal 10 of another user.

In this exemplary embodiment, the positional relationship between the camera 50 and the portable terminal 10 may be arbitrary.

For example, the camera 50 may capture an image of the right hand 3 of the user 1 from the same side as the portable terminal 10. In this case, if the portable terminal 10 captures an image of the back of the right hand 3, the camera 50 also captures an image of the back of the right hand 3.

In contrast, as shown in FIG. 34, an image of the right hand 3 of the user 1 may be captured from the opposite side from the portable terminal 10. In this case, if the portable terminal 10 captures an image of the back of the right hand 3, the camera 50 captures an image of the palm of the right hand 3.

In this exemplary embodiment, the processor 101 (see FIG. 2) of the portable terminal 10 links the detected line thickness with a corresponding segment of the line being rendered in accordance with time information added to an image captured by the camera 12 or the camera 50 and the absolute coordinates of the right hand 3 identified from the image.

An image captured by the camera 12 provided in the portable terminal 10 may be used only for display on the touchscreen 11, and the direction of a line rendered in midair may be determined by using an image captured by the camera 50.

Furthermore, the line thickness may be determined by using a processor (not shown) provided in the camera 50, and the information about the determined thickness may be transmitted to the portable terminal 10. In this case, the camera 50 may execute the process described in any of the above exemplary embodiments.

### Eighth Exemplary Embodiment

In contrast to the above exemplary embodiments in which the thickness of a line to be rendered in midair is designated with a gesture using a hand or a finger, the following description relates to a case where a foot is used.

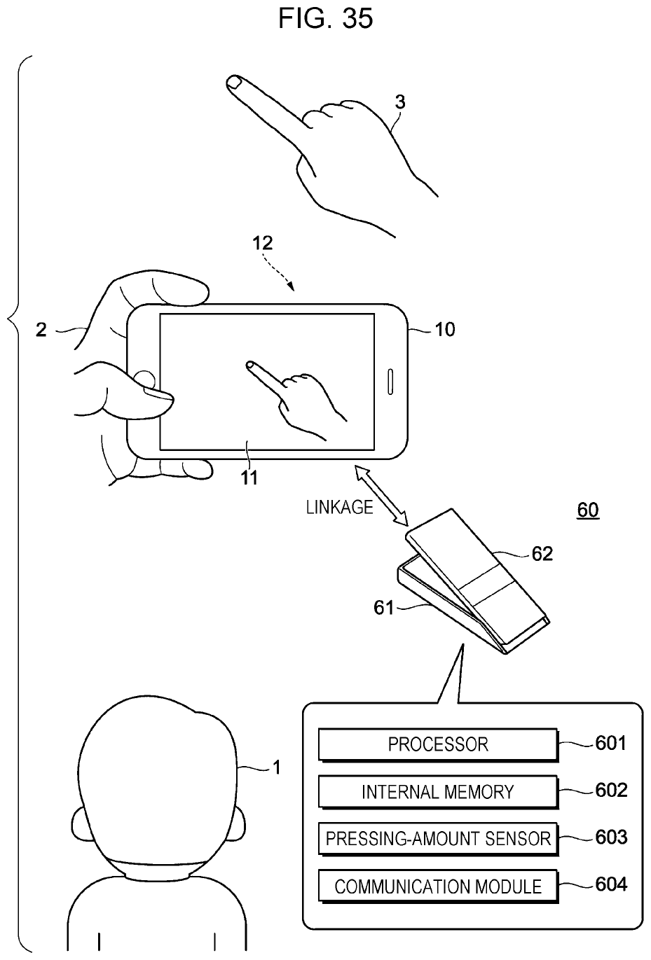

FIG. 35 illustrates a usage example of a portable terminal 10 according to an eighth exemplary embodiment. In FIG. 35, sections corresponding to those in FIG. 1 are given the corresponding reference signs.

The eighth exemplary embodiment shown in FIG. 35 is different from the first exemplary embodiment in that a pedal device 60 operated with a foot is additionally provided.

The pedal device 60 is constituted of a base 61 and a pedal 62. The pedal 62 is movable relative to the base 61. A V-shaped gap formed between the base 61 and the pedal 62 is at maximum in the initial state, and decreases in space as the pedal 62 is pressed.

The pedal device 60 transmits an electric signal indicating a pressing amount of the pedal 62 as a line-thickness command to the portable terminal 10. In this exemplary embodiment, the thickness of the rendered line increases with increasing pressing amount. The pressing amount is given as an angle from the initial position to the position of the pressed pedal 62 or as an amount of movement of a member that moves as the pedal 62 is pressed.

The pedal device 60 has a processor 601, an internal memory 602, a pressing-amount sensor 603, and a communication module 604 used for communicating with external apparatuses. One of the external apparatuses is the portable terminal 10.

The processor 601 is constituted of, for example, a CPU. The processor 601 realizes various types of functions by executing applications and firmware.

The internal memory 602 is a semiconductor memory. The internal memory 602 has a ROM having a BIOS stored therein, and a RAM used as a principal storage device. The processor 601 and the internal memory 602 constitute a so-called computer. The processor 601 uses the RAM as a work space for a program.

The pressing-amount sensor 603 detects an amount of change in the angle of the pedal 62 or an amount of movement of a specific member as the pedal 62 is pressed.

The communication module 604 used is, for example, a USB-compliant communication module, a communication module compliant with Bluetooth (registered trademark), a communication module compliant with a mobile communication system, or a communication module compliant with a wireless LAN. The communication module 604 according to this exemplary embodiment reports information related to the pressing amount detected by the pressing-amount sensor 603 to the portable terminal 10.

In this exemplary embodiment, the user 1 adjusts the pressing amount of the pedal 62 with his/her foot while rendering a line in midair with his/her index finger, so as to simultaneously give a command for the line being rendered.

### Ninth Exemplary Embodiment

### Usage Example

The following description of a ninth exemplary embodiment relates to a case where a pen is used for giving a command for the thickness of a line.

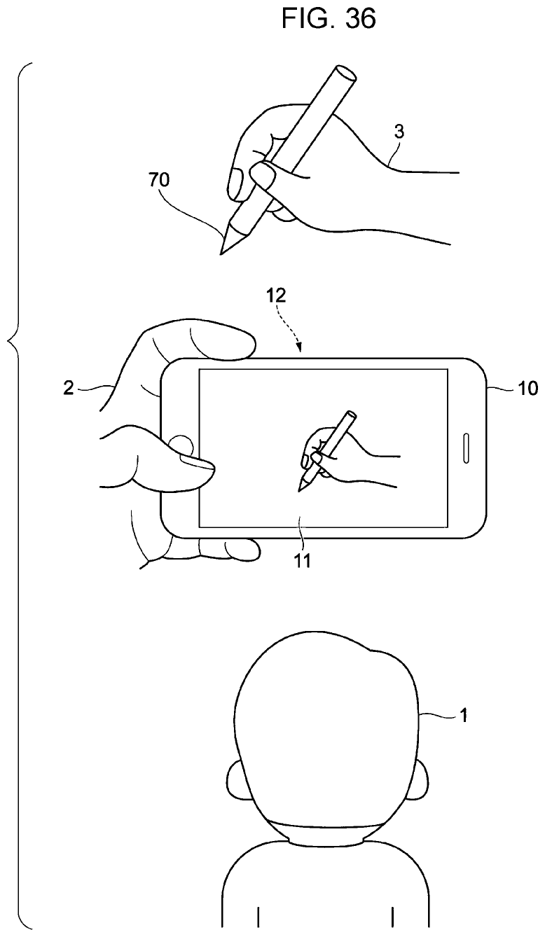

FIG. 36 illustrates a usage example of a portable terminal 10 according to the ninth exemplary embodiment. In FIG. 36, sections corresponding to those in FIG. 1 are given the corresponding reference signs.

In FIG. 36, the user 1 renders a line by moving a pen 70 in midair while holding the pen 70 with the right hand 3. The pen 70 used in this exemplary embodiment may be, for example, a writing instrument, such as a pencil, a ballpoint pen, a fountain pen, a mechanical pencil, or a crayon, or may be a pointing stick or a tree branch. In this exemplary embodiment, it is assumed that a rod-shaped physical object is used as the pen 70.

The pen 70 according to this exemplary embodiment is an example of a physical object used for rendering a line in midair. In this exemplary embodiment, the pen 70 does not have to have a communication function. Although there is no problem in the pen 70 having a communication function, when the pen 70 is to be used in this exemplary embodiment, the communication function is turned off, or the pen 70 is not linked with the portable terminal 10 with respect to the function for rendering a line in midair.

In this exemplary embodiment, the trajectory of the tip of the pen 70 is detected as the direction of a line, and the thickness of the line is designated in accordance with the orientation of the pen 70 relative to the portable terminal 10.

Process

A process executed in the portable terminal 10 used in this exemplary embodiment is the same as that in the first exemplary embodiment. Specifically, the portable terminal 10 operates in accordance with the flowchart shown in FIG. 3. However, for the detection of the line thickness in step S6 (see FIG. 3), the orientation of the pen 70 is used instead of the orientation of the index finger or the hand. In this exemplary embodiment, the processor 101 (see FIG. 2) extracts the pen 70 from an image captured by the camera 12 (see FIG. 36), detects the tilt direction of the pen 70 within the image, and uses the tilt direction as a thickness command.

### Specific Examples Used as Command for Thickness of Line

### First Specific Example

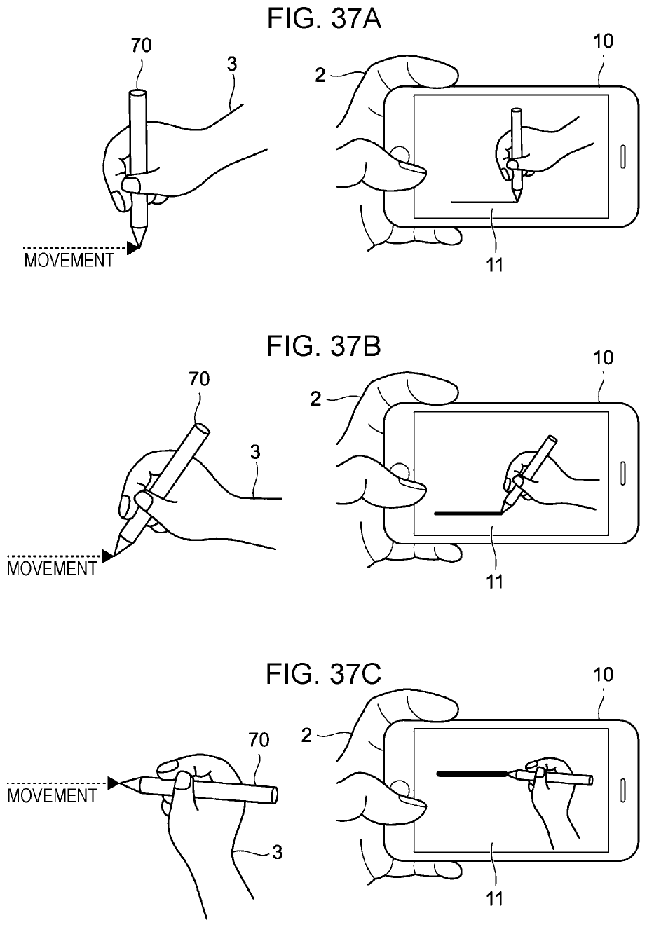

FIGS. 37A to 37C each illustrate a first specific example of a gesture used as a command for the thickness of a line to be rendered in the ninth exemplary embodiment. Specifically, FIG. 37A illustrates an example of a gesture used as a command for a “thin line”, FIG. 37B illustrates an example of a gesture used as a command for a “medium-thick line”, and FIG. 37C illustrates an example of a gesture used as a command for a “thick line”.

In FIGS. 37A to 37C, sections corresponding to those in FIGS. 10A to 10C are given the corresponding reference signs.

In each of FIGS. 37A to 37C, the left column indicates an example of a gesture used for simultaneously giving a command for the rendering of a line and a command for the thickness of the line, and the right column indicates an example of an AR image displayed on the touchscreen 11 of the portable terminal 10. The left column in each of FIGS. 37A to 37C indicates the movement of the pen 70 as viewed from the user.

In FIGS. 37A to 37C, the trajectory of the tip of the pen 70 held with the right hand 3 is used for rendering the line.

In FIG. 37A, the pen 70 is oriented substantially vertically upward. When the right hand 3 is moved in a state where the pen 70 is oriented vertically upward, a “thin line” is rendered on the touchscreen 11.

In FIG. 37B, the pen 70 is tilted at 45° toward the upper right side, as viewed from the user. When the right hand 3 is moved in a state where the pen 70 is tilted toward the upper right side, a “medium-thick line” is rendered on the touchscreen 11.

In FIG. 37C, the pen 70 is tilted substantially in the horizontal direction, as viewed from the user. When the right hand 3 is moved in a state where the pen 70 is tilted in the horizontal direction, a “thick line” is rendered on the touchscreen 11.

As an alternative to this specific example in which three types of thicknesses correspond to three types of tilts, the thickness may be changed continuously in accordance with a freely-chosen angle of the pen 70.

Furthermore, as an alternative to this specific example in which the angle of the pen 70 is changed within a substantially 90° range from the substantially vertically upward position corresponding to the first quadrant to the substantially horizontal position, the angle used for designating the thickness may be larger than or equal to 90° or may be smaller than 90°. For example, a substantially 180° range from the first quadrant to the second quadrant may be used for designating the line thickness.

### Second Specific Example

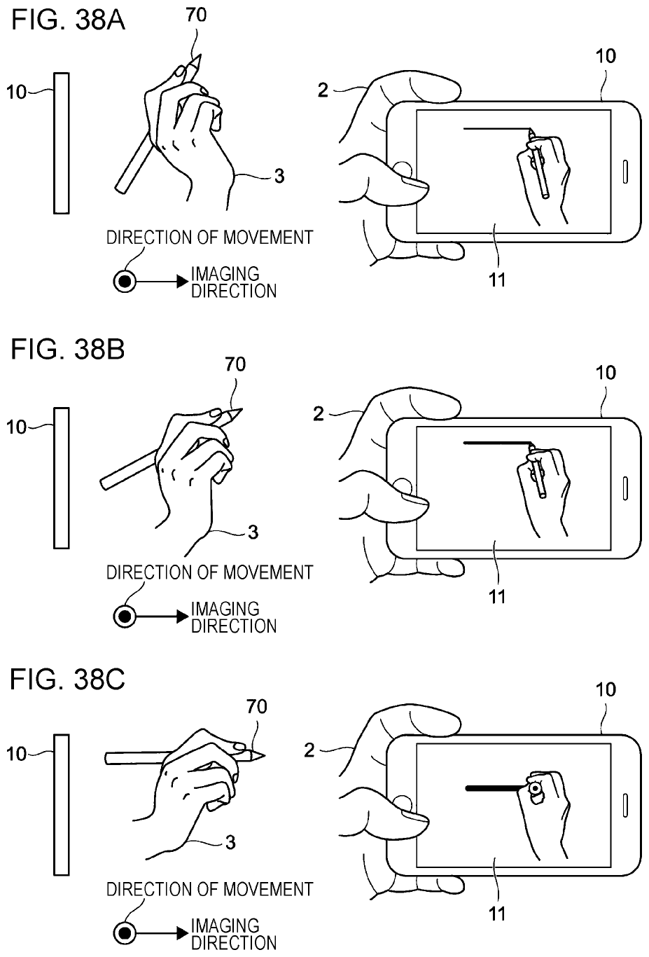

FIGS. 38A to 38C each illustrate a second specific example of a gesture used as a command for the thickness of a line to be rendered in the ninth exemplary embodiment. Specifically, FIG. 38A illustrates an example of a gesture used as a command for a “thin line”, FIG. 38B illustrates an example of a gesture used as a command for a “medium-thick line”, and FIG. 38C illustrates an example of a gesture used as a command for a “thick line”.

In FIGS. 38A to 38C, sections corresponding to those in FIGS. 37A to 37C are given the corresponding reference signs.

In each of FIGS. 38A to 38C, the left column indicates an example of a gesture used for simultaneously giving a command for the rendering of a line and a command for the thickness of the line, and the right column indicates an example of an AR image displayed on the touchscreen 11 of the portable terminal 10.

In the first specific example described with reference to FIGS. 37A to 37C, the direction of the pen 70 within a plane in which the line of vision of the user is defined as the normal corresponds to the line thickness. In contrast, in this specific example, a command for the thickness of a line is given in accordance with the degree of tilt of the pen 70 in the imaging direction. Therefore, the left column in each of FIGS. 38A to 38C indicates the positional relationship among the portable terminal 10, the right hand 3, and the pen 70, as viewed from the right side of the user.

In FIGS. 38A to 38C, the trajectory of the tip of the pen 70 held with the right hand 3 is used for rendering the line. Furthermore, in FIGS. 38A to 38C, the tilt of the pen 70 in the depth direction during the rendering is used as a line-thickness command.

In FIG. 38A, the tip of the pen 70 is oriented substantially vertically upward. When the right hand 3 is moved in a state where the tip of the pen 70 is oriented vertically upward, a “thin line” is rendered on the touchscreen 11.

In FIG. 38B, the pen 70 is tilted at substantially 45° toward relative to the depth direction. When the right hand 3 is moved in this state, a “medium-thick line” is rendered on the touchscreen 11. The length of the pen 70 displayed on the touchscreen 11 appears to be shorter than in the display in FIG. 38A.

In FIG. 38C, the pen 70 is substantially horizontal in the depth direction. When the right hand 3 is moved in this state, a “thick line” is rendered on the touchscreen 11. In the example in FIG. 38C, only an image of an end of the pen 70 is displayed on the touchscreen 11.

As an alternative to this specific example in which three types of thicknesses correspond to three types of tilts, the thickness may be changed continuously in accordance with a freely-chosen angle of the pen 70.

Furthermore, as an alternative to this specific example in which the angle of the pen 70 is changed within a substantially 90° range, the angle used for designating the thickness may be larger than or equal to 90° or may be smaller than 90°. For example, the pen 70 may be changed within a substantially 180° range from the substantially vertically upward position to the substantially vertical position.

The tilt of the pen 70 relative to the depth direction and the thickness of a line to be rendered may be set in a calibration process for the pen 70 used for the rendering.

In the calibration process, images of the pen 70 are captured in various orientations through a guidance message, such as “please point pen tip upward”, and threshold values for determining the length of the image-captured pen 70 on the screen are set, so that the line thickness corresponding to the given command during the rendering process is determinable.

### Third Specific Example

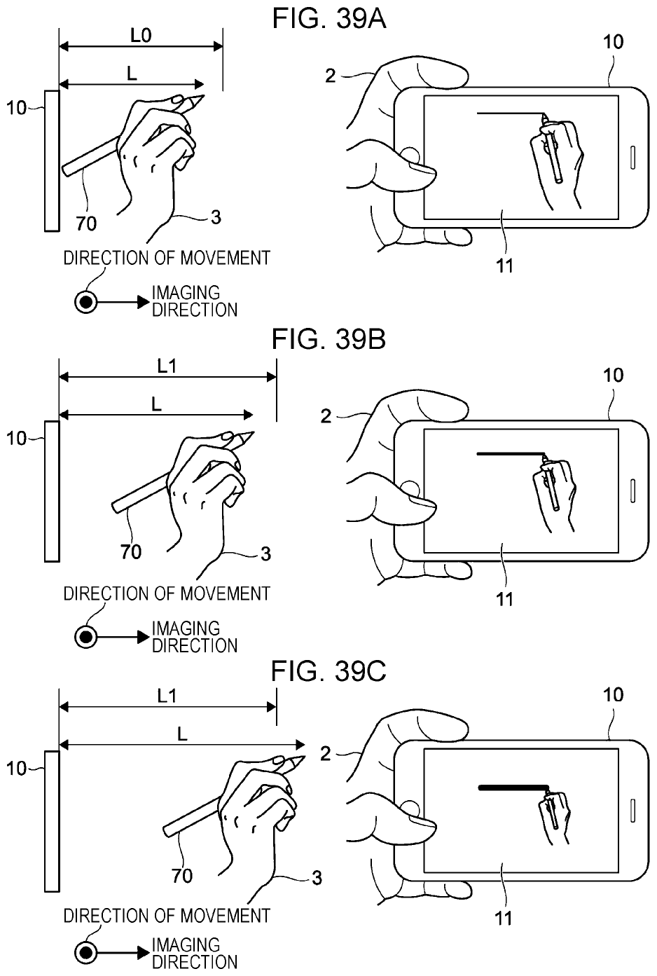

FIGS. 39A to 39C each illustrate a third specific example of a gesture used as a command for the thickness of a line to be rendered in the ninth exemplary embodiment. Specifically, FIG. 39A illustrates an example of a gesture used as a command for a “thin line”, FIG. 39B illustrates an example of a gesture used as a command for a “medium-thick line”, and FIG. 39C illustrates an example of a gesture used as a command for a “thick line”.

In FIGS. 39A to 39C, sections corresponding to those in FIGS. 38A to 38C are given the corresponding reference signs.

In each of FIGS. 39A to 39C, the left column indicates an example of a gesture used for simultaneously giving a command for the rendering of a line and a command for the thickness of the line, and the right column indicates an example of an AR image displayed on the touchscreen 11 of the portable terminal 10.

In FIGS. 39A to 39C, the command for the thickness of the line is given in accordance with variations in the distance L between the portable terminal 10 and the tip of the pen 70. Therefore, similar to FIGS. 38A to 38C, the left column in each of FIGS. 39A to 39C indicates the positional relationship when the portable terminal 10 and the right hand 3 are observed from the right side of the user.

In FIGS. 39A to 39C, the trajectory of the tip of the pen 70 held with the right hand 3 is used for rendering the line. In the case of FIGS. 39A to 39C, the tilt of the pen 70 in midair may be the same regardless of the line thickness corresponding to the command. Needless to say, the tilt of the pen 70 may be changed in midair, but the line thickness is set based on the distance L to the tip of the pen 70 in this exemplary embodiment.

In FIG. 39A, the distance L between the portable terminal 10 and the tip of the pen 70 is smaller than a first threshold value L0. In this case, a “thin line” is rendered on the touchscreen 11 in conjunction with movement of the right hand 3.

In FIG. 39B, the distance L between the portable terminal 10 and the tip of the pen 70 is larger than or equal to the first threshold value L0 but smaller than a second threshold value L1 (>L0). In this case, a “medium-thick line” is rendered on the touchscreen 11 in conjunction with movement of the right hand 3.

In FIG. 39C, the distance L between the portable terminal 10 and the tip of the pen 70 is larger than or equal to the second threshold value L1. In this case, a “thick line” is rendered on the touchscreen 11 in conjunction with movement of the right hand 3.

The first threshold value L0 and the second threshold value L1 are set in advance, but are desirably changeable by the user.

In this specific example, the relationship between the distance L and the line thickness may be opposite from that in FIGS. 39A to 39C. Specifically, the case where the distance L between the portable terminal 10 and the tip of the pen 70 is smaller than the first threshold value L0 may correspond to a thick line, and the case where the distance L between the portable terminal 10 and the tip of the pen 70 is larger than or equal to the second threshold value L1 may correspond to a thin line.

As an alternative to this specific example in which the distance L between the portable terminal 10 and the tip of the pen 70 is measured, the distance L between the portable terminal 10 and the right hand 3 holding the pen 70 may be measured.

For measuring the distance L to the tip of the pen 70 or the distance L to the right hand 3, the distance-measuring sensor 105 (see FIG. 2) is used.

### Tenth Exemplary Embodiment

### Usage Example

The following description of a tenth exemplary embodiment relates to a case where a pen is used for giving a command for the thickness of a line. In this exemplary embodiment, the pen used has a communication function.

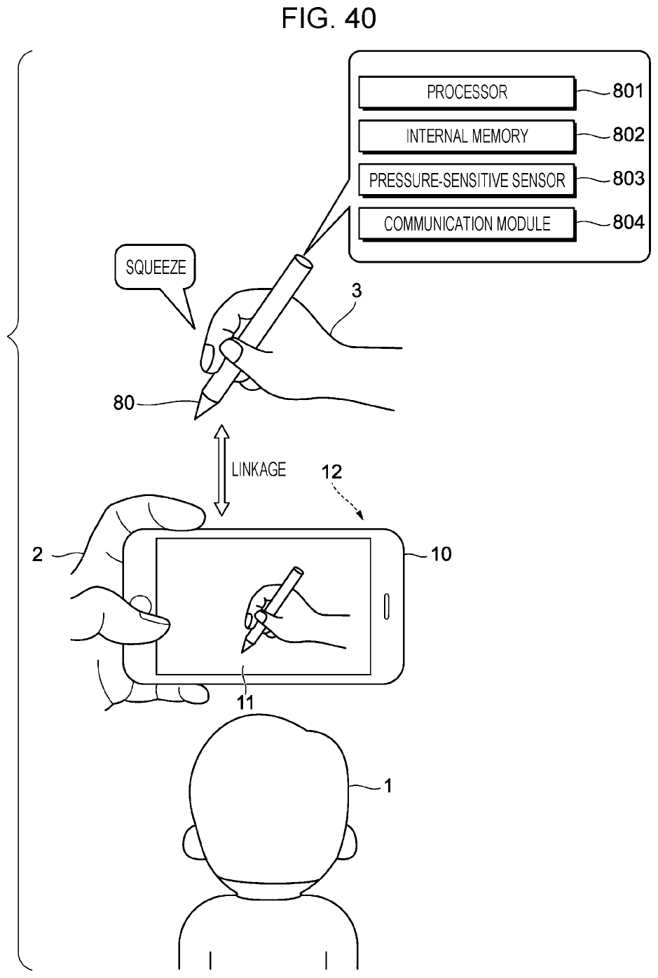

FIG. 40 illustrates a usage example of a portable terminal 10 according to the tenth exemplary embodiment. In FIG. 40, sections corresponding to those in FIG. 36 are given the corresponding reference signs.

In FIG. 40, the user 1 renders a line by moving a pen 80 in midair while holding the pen 80 with the right hand 3. The pen 80 used in this exemplary embodiment has, for example, a pressure-sensitive sensor and a communication function, detects pressure applied to the pen 80 during the rendering process, and notifies the portable terminal 10 of the detected pressure. In this exemplary embodiment, it is assumed that a rod-shaped physical object is used as the pen 80.

The pen 80 according to this exemplary embodiment has a processor 801, an internal memory 802, a pressure-sensitive sensor 803, and a communication module 804 used for communicating with external apparatuses. One of the external apparatuses is the portable terminal 10.

The processor 801 is constituted of, for example, a CPU. The processor 801 realizes various types of functions by executing applications and firmware.

The internal memory 802 is a semiconductor memory. The internal memory 802 has a ROM having a BIOS stored therein, and a RAM used as a principal storage device. The processor 801 and the internal memory 802 constitute a so-called computer. The processor 801 uses the RAM as a work space for a program.

The pressure-sensitive sensor 803 is attached to a shaft of the pen 80. The pressure-sensitive sensor 803 detects gripping strength applied to the shaft of the pen 80 by the user 1.

The communication module 804 used is, for example, a USB-compliant communication module, a communication module compliant with Bluetooth (registered trademark), a communication module compliant with a mobile communication system, or a communication module compliant with a wireless LAN. The communication module 804 according to this exemplary embodiment notifies the portable terminal 10 of a pressure value detected by the pressure-sensitive sensor 803 and information indicating the magnitude of the pressure. The information indicating the magnitude of the pressure includes, for example, a level indicating the magnitude of the pressure in multiple stages.

In this exemplary embodiment, the trajectory of the tip of the pen 80 is detected as the direction of a line, and the thickness of the line is designated in accordance with the magnitude of a gripping force applied to the pen 80 during the rendering process.

Alternatively, the pressure-sensitive sensor 803 may include multiple pressure-sensitive sensors, and the command for the thickness of the line may be given in accordance with variations in the pressure-sensitive sensor 803 to be operated. The multiple pressure-sensitive sensors 803 may be provided at different positions along the outer periphery of the shaft of the pen 80. In that case, the variations in the pressure-sensitive sensor 803 to be operated indicate variations in the direction in which pressure is applied.

Process

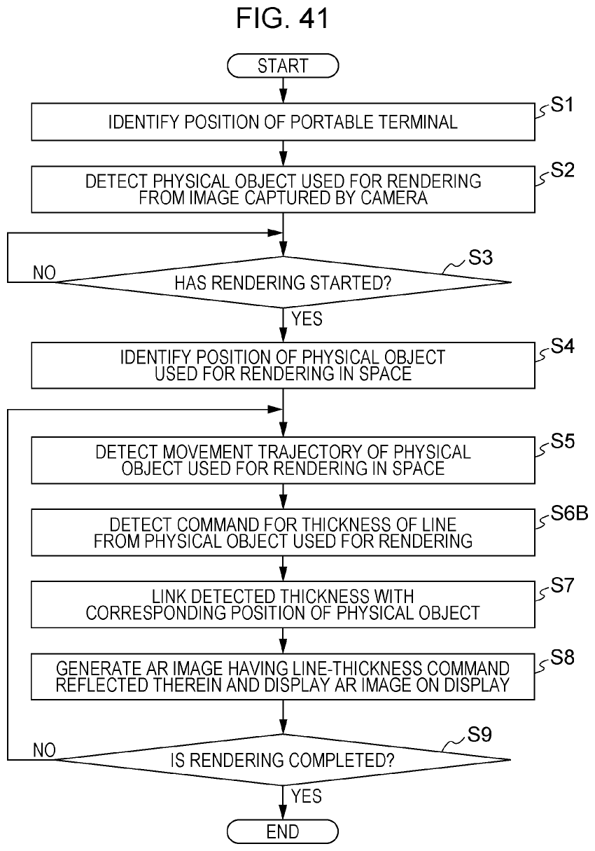

FIG. 41 is a flowchart illustrating an example of a process executed in the portable terminal 10 used in the tenth exemplary embodiment. In FIG. 41, sections corresponding to those in FIG. 3 are given the corresponding reference signs.

The process shown in FIG. 41 is different from that in FIG. 3 in terms of the process after step S5.

Referring to FIG. 41, after step S5, the processor 101 detects a command for the thickness of a line from a physical object used for rendering in step S6B. As mentioned above, in this exemplary embodiment, a line-thickness command is information about a gripping force of the right hand 3 detected during a rendering process using the pen 80.

The process subsequent to the detection of the line-thickness command is the same as that in FIG. 3.

### Specific Examples Used as Command for Thickness of Line

Specific examples of gestures assumed in step S6B (see FIG. 41) will be described below.

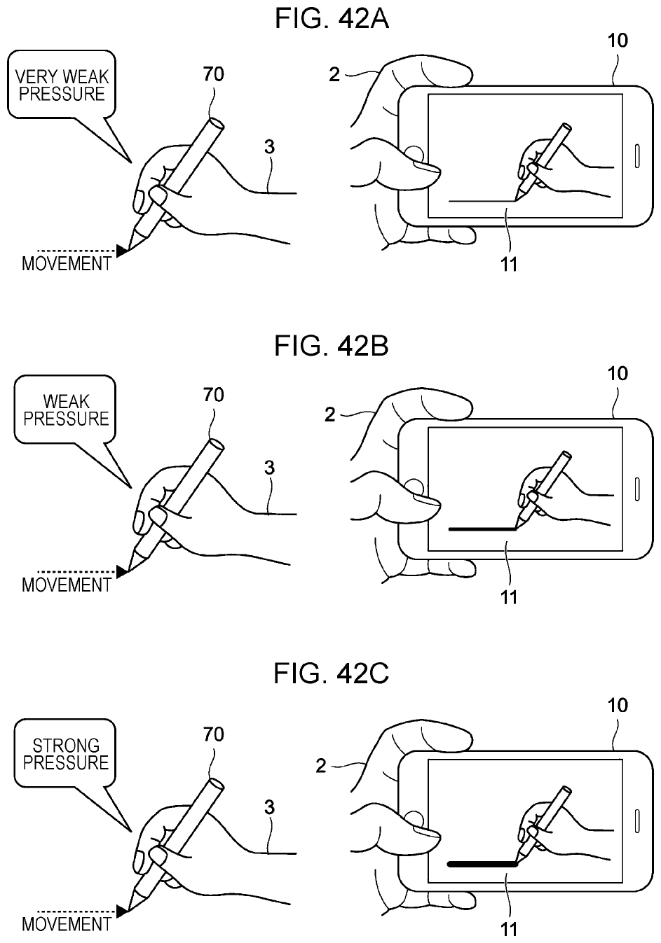

FIGS. 42A to 42C each illustrate a specific example of a gesture used as a command for the thickness of a line to be rendered in the tenth exemplary embodiment. Specifically, FIG. 42A illustrates an example of a gesture used as a command for a “thin line”, FIG. 42B illustrates an example of a gesture used as a command for a “medium-thick line”, and FIG. 42C illustrates an example of a gesture used as a command for a “thick line”.

In each of FIGS. 42A to 42C, the left column indicates an example of a gesture used for simultaneously giving a command for the rendering of a line and a command for the thickness of the line, and the right column indicates an example of an AR image displayed on the touchscreen 11 of the portable terminal 10.

In FIGS. 42A to 42C, the tip of the pen 80 is used for rendering the line.

In FIG. 42A, the user moves the pen 80 in midair while applying very weak pressure thereto. Thus, a “thin line” is rendered on the touchscreen 11 of the portable terminal 10.

In FIG. 42B, the user moves the pen 80 in midair while applying weak pressure thereto. With regard to this weak pressure, the value of pressure detected by the pressure-sensitive sensor 803 is larger than that of the “very weak pressure” in FIG. 42A. In this case, a “medium-thick line” is rendered on the touchscreen 11 of the portable terminal 10.

In FIG. 42C, the user moves the pen 80 in midair while applying strong pressure thereto. With regard to this strong pressure, the value of pressure detected by the pressure-sensitive sensor 803 is larger than that of the “weak pressure” in FIG. 42B. In this case, a “thick line” is rendered on the touchscreen 11 of the portable terminal 10.

It is assumed that the pressure reported from the pressure-sensitive sensor 803 varies depending on the user. Therefore, it is desirable that determination threshold values be set before use by performing a calibration process on the pen 80.

In the calibration process, a value of force applied to the shaft of the pen 80 is detected by the pressure-sensitive sensor 803 in accordance with a guidance message, such as “please hold pen with force used for rendering thin line”. The processor 101 acquiring this value from the pen 80 sets a threshold value for determining the magnitude of the acquired force so as to prepare for a rendering process.

The relationship between the detected pressure and the line thickness is not limited to the exemplified relationship. For example, a thick line may be rendered when “very weak pressure” is detected, and a thin line may be rendered when “strong pressure” is detected.

Furthermore, the types of thicknesses of lines to be rendered are not limited to three types. The thickness may be changed continuously based on the magnitude of the detected pressure.

The method using the pen 80 may be used for giving a command for the line density.

### Eleventh Exemplary Embodiment

### Usage Example

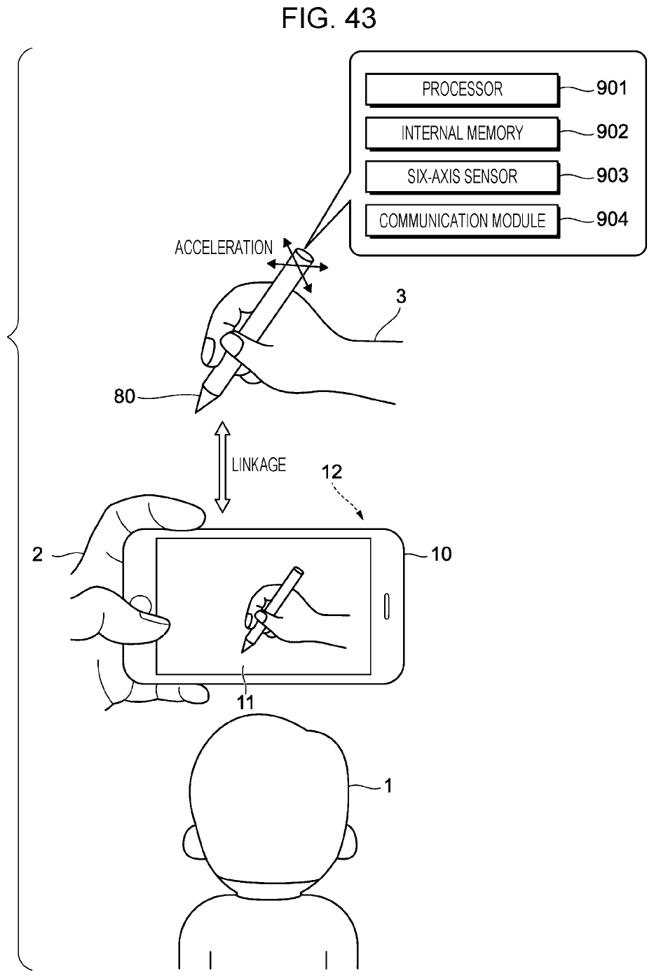

FIG. 43 illustrates a usage example of a portable terminal 10 according to an eleventh exemplary embodiment. In FIG. 43, sections corresponding to those in FIG. 40 are given the corresponding reference signs.

In FIG. 43, the user 1 renders a line by moving a pen 90 in midair while holding the pen 90 with the right hand 3. The pen 90 used in this exemplary embodiment has, for example, an acceleration detecting sensor and a communication function, detects the magnitude of acceleration applied to the pen 90 during the rendering process, and notifies the portable terminal 10 of the detected magnitude of acceleration. In this exemplary embodiment, it is assumed that a rod-shaped physical object is used as the pen 90.

For example, the acceleration occurring when a thick line is rendered tends to increase, as compared with the acceleration occurring when a thin line is rendered. In this exemplary embodiment, the line thickness is detected by utilizing this empirical rule.

The pen 90 according to this exemplary embodiment has a processor 901, an internal memory 902, a six-axis sensor 903, and a communication module 904 used for communicating with external apparatuses. One of the external apparatuses is the portable terminal 10.

The processor 901 is constituted of, for example, a CPU. The processor 901 realizes various types of functions by executing applications and firmware.

The internal memory 902 is a semiconductor memory. The internal memory 902 has a ROM having a BIOS stored therein, and a RAM used as a principal storage device. The processor 901 and the internal memory 902 constitute a so-called computer. The processor 901 uses the RAM as a work space for a program.

The six-axis sensor 903 measures acceleration along three axes (i.e., X axis, Y axis, and Z axis) and angular velocities along the same three axes. For example, the six-axis sensor 903 is attached within a shaft of the pen 90 and measures the acceleration and the angular velocity when a line is rendered using the pen 90. In this exemplary embodiment, the six-axis sensor 903 is disposed at one of the opposite ends of the pen 90. It is desirable that the six-axis sensor 903 be disposed near the top of the pen 90, that is, the end opposite from the pen tip. The opposite ends of the pen 90 are likely to move by a large amount, so that acceleration occurring during a rendering process may be readily measured.

The communication module 904 used is, for example, a USB-compliant communication module, a communication module compliant with Bluetooth (registered trademark), a communication module compliant with a mobile communication system, or a communication module compliant with a wireless LAN. The communication module 904 according to this exemplary embodiment notifies the portable terminal 10 of an acceleration value detected by the six-axis sensor 903 and information indicating the magnitude of the acceleration. The information indicating the magnitude of the acceleration includes, for example, a level indicating the magnitude of the acceleration in multiple stages.

In this exemplary embodiment, the trajectory of the tip of the pen 90 is detected as the direction of a line, and the thickness of the line is designated in accordance with the magnitude of the acceleration of the pen 90 during the rendering process.

Process

A process executed in the portable terminal 10 used in this exemplary embodiment is the same as that in the tenth exemplary embodiment. Specifically, the portable terminal 10 operates in accordance with the flowchart shown in FIG. 41. However, for the detection of the line thickness in step S6 (see FIG. 3), the magnitude of acceleration in the pen 90 is used.

### Specific Examples Used as Command for Thickness of Line

Specific examples of gestures assumed in step S6B (see FIG. 41) will be described below.

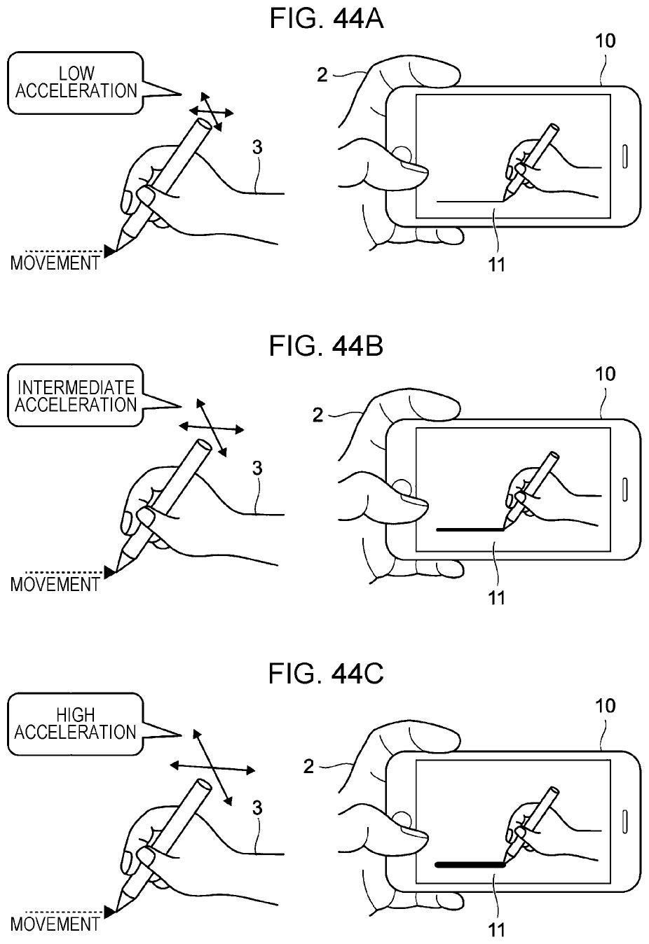

FIGS. 44A to 44C each illustrate a specific example of a gesture used as a command for the thickness of a line to be rendered in the eleventh exemplary embodiment. Specifically, FIG. 44A illustrates an example of a gesture used as a command for a “thin line”, FIG. 44B illustrates an example of a gesture used as a command for a “medium-thick line”, and FIG. 44C illustrates an example of a gesture used as a command for a “thick line”.

In each of FIGS. 44A to 44C, the left column indicates an example of a gesture used for simultaneously giving a command for the rendering of a line and a command for the thickness of the line, and the right column indicates an example of an AR image displayed on the touchscreen 11 of the portable terminal 10.

In FIGS. 44A to 44C, the tip of the pen 90 is used for rendering the line.

In FIG. 44A, low acceleration is detected in the pen 90. This acceleration is detected when, for example, the pen 90 is moved slowly in midair. In this case, a “thin line” is rendered on the touchscreen 11 of the portable terminal 10.

In FIG. 44B, intermediate acceleration is detected in the pen 90. This acceleration is detected when, for example, the pen 90 is moved quickly. This intermediate acceleration is detected when the pen 90 is moved faster than in the case in FIG. 44A. In this case, a “medium-thick line” is rendered on the touchscreen 11 of the portable terminal 10.

In FIG. 44C, high acceleration is detected in the pen 90. This acceleration is detected when, for example, the pen 90 is moved vigorously. In this exemplary embodiment, this high acceleration is detected when the pen 90 is moved faster than in the case in FIG. 44B. For example, such high acceleration is likely to occur in a case of movement where the pen 90 is strongly pressed against an imaginary plane in which a line is rendered, or in a case of specific movement for starting or finishing the rendering of a line. In this case, a “thick line” is rendered on the touchscreen 11 of the portable terminal 10.

It is assumed that the acceleration reported from the six-axis sensor 903 varies depending on the user. Therefore, it is desirable that determination threshold values be set before use by performing a calibration process on the pen 90.

In the calibration process, a value of force applied to the shaft of the pen 90 is detected by the six-axis sensor 903 in accordance with a guidance message, such as “please move pen while focusing on rendering thin line”. The processor 101 acquiring this value and the direction of the acceleration from the pen 90 sets a threshold value for determining the magnitude of the acquired acceleration so as to prepare for a rendering process.

The relationship between the magnitude of the detected acceleration and the line thickness is not limited to the exemplified relationship. For example, a thick line may be rendered when “low acceleration” is detected, and a thin line may be rendered when “high acceleration” is detected.

Furthermore, the types of thicknesses of lines to be rendered are not limited to three types. The thickness may be changed continuously based on the magnitude of the detected acceleration.

It is possible to focus on the magnitude of acceleration acting away from the user or the magnitude of acceleration acting toward the user, instead of the magnitude of acceleration acting in the rendering direction. When a line is to be rendered on paper, there is a tendency in which a thin line is rendered by pressing the writing instrument onto the paper with a small force, and a thick line is rendered by pressing the writing instrument onto the paper with a large force. Thus, the line thickness may be increased when the acceleration acting away from the user is high, and the line thickness may be decreased when the acceleration acting away from the user is low. When a line is to be rendered in midair, a motion of the pen 90 pulled toward the user may correspond to a thin line.

The method using the pen 90 may be used for giving a command for the line density.

### Twelfth Exemplary Embodiment

### Usage Example

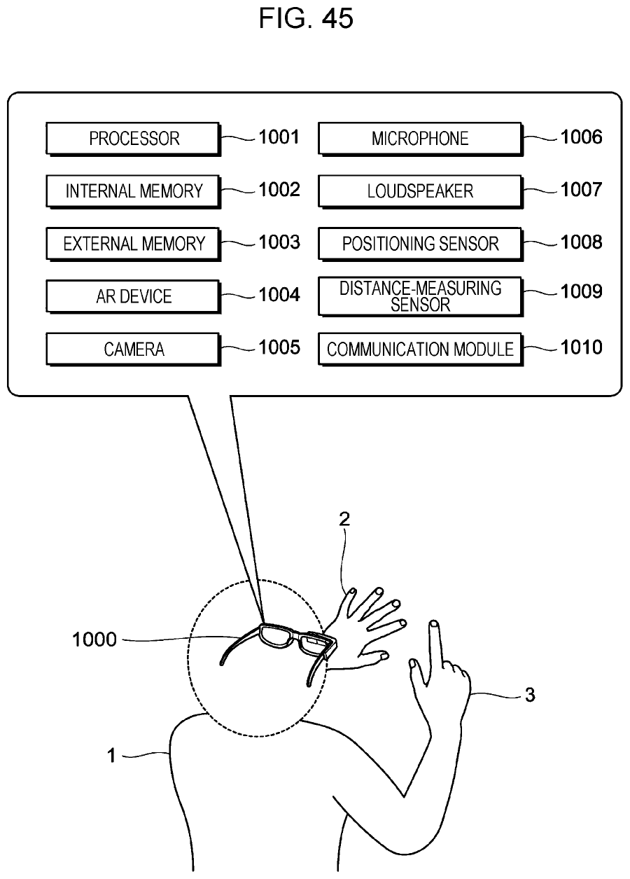

FIG. 45 illustrates a usage example of a portable terminal 1000 according to a twelfth exemplary embodiment. In FIG. 45, it is assumed that the portable terminal 1000 is an eyeglasses-type device worn on the head of the user 1. In FIG. 45, it is assumed that the portable terminal 1000 is a pair of smartglasses. The portable terminal 1000 may have various external appearances and may be of a goggle type or a headset type instead of an eyeglasses type.

In the case of the portable terminal 1000 in FIG. 45, the user 1 is capable of using both hands.

The portable terminal 1000 according to this exemplary embodiment has a processor 1001, an internal memory 1002, an external memory 1003, an AR device 1004, a camera 1005, a microphone 1006, a loudspeaker 1007, a positioning sensor 1008, a distance-measuring sensor 1009, and a communication module 1010.

The processor 1001 is constituted of, for example, a CPU. The processor 1001 realizes various types of functions by executing applications and firmware.

Each of the internal memory 1002 and the external memory 1003 is a semiconductor memory.

The internal memory 1002 has a ROM having a BIOS stored therein, and a RAM used as a principal storage device. The processor 1001 and the internal memory 1002 constitute a so-called computer. The processor 1001 uses the RAM as a work space for a program.

The external memory 1003 is an auxiliary storage device and stores programs therein.

The AR device 1004 allows the user 1 to view an AR image and may be of a retinal projection type that directly projects a video image onto the retinas of the user 1 or a transmissive type that projects an image onto glasses via a light guide. Since both types are already put to practical use, detailed structures thereof will be omitted. With either type, the user 1 perceives that he/she is rendering a line in the space in front of him/her.

The camera 1005 used is, for example, a CMOS image sensor or a CCD image sensor. The camera 1005 is used for capturing an image of a gesture performed using the left hand 2 and the right hand 3 by the user 1 wearing the portable terminal 1000.

The microphone 1006 is a device that converts user's voice or ambient sound into an electric signal.

The loudspeaker 1007 is a device that converts the electric signal into sound and outputs the sound.

The positioning sensor 1008 is constituted of, for example, an indoor positioning module or a GPS module that measures the position of the portable terminal 1000 by detecting a GPS signal. Examples of an indoor positioning module include a module that measures the position of the portable terminal 1000 by receiving a BLE beacon, a module that measures the position of the portable terminal 1000 by receiving a WiFi (registered trademark) signal, a module that measures the position of the portable terminal 1000 in accordance with autonomous navigation, and a module that measures the position of the portable terminal 1000 by receiving an IMES signal.

For example, if the camera 1005 includes stereo cameras, the distance-measuring sensor 1009 used is a module that calculates the distance to a physical object by using a parallax between the multiple cameras 1005. Another example of the distance-measuring sensor 1009 used is a TOF sensor that calculates the distance to a physical object by measuring the time it takes for radiated light to return after being reflected by the physical object.

The communication module 1010 used is, for example, a USB-compliant communication module, a communication module compliant with a mobile communication system, or a communication module compliant with a wireless LAN.

### Specific Examples Used as Command for Thickness of Line

In this exemplary embodiment, the portable terminal 1000 allows the user 1 to render a line in midair by using the right hand 3 and to give a command for the thickness of the line by using the left hand 2.

A process executed in the portable terminal 1000 is basically the same as that in the first exemplary embodiment. Specifically, the portable terminal 1000 operates in accordance with the flowchart shown in FIG. 3. However, for the detection of the line thickness in step S6 (see FIG. 3), an image of the left hand 2 of the user 1 is used.

### First Specific Example

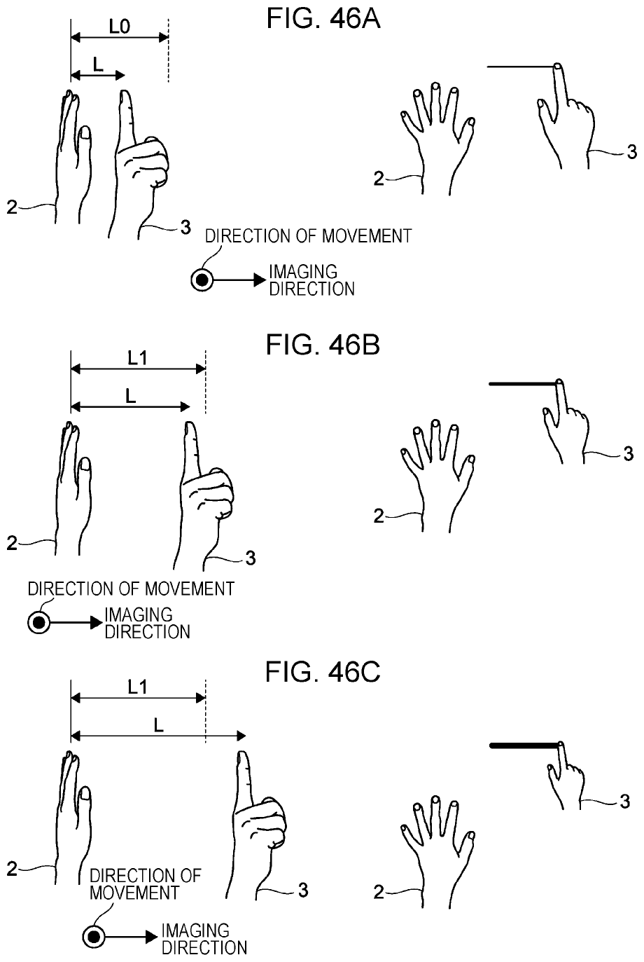

FIGS. 46A to 46C each illustrate a first specific example of a gesture used as a command for the thickness of a line to be rendered in the twelfth exemplary embodiment. Specifically, FIG. 46A illustrates an example of a gesture used as a command for a “thin line”, FIG. 46B illustrates an example of a gesture used as a command for a “medium-thick line”, and FIG. 46C illustrates an example of a gesture used as a command for a “thick line”.

In each of FIGS. 46A to 46C, the left column indicates an example of a gesture used for simultaneously giving a command for the rendering of a line and a command for the thickness of the line, and the right column indicates an example of an AR image to be viewed by the user 1 through the portable terminal 1000.

In FIGS. 46A to 46C, the fingertip of the index finger of the right hand 3 is used for rendering the line. In the case of FIGS. 46A to 46C, the left hand 2 is set as a reference position in the imaging direction, and the distance L between the left hand 2 serving as the reference position and the right hand 3 is used for giving the line-thickness command. The processor 1001 (see FIG. 45) according to this exemplary embodiment uses the distance-measuring sensor 1009 (see FIG. 45) to measure the distance from the portable terminal 1000 to the left hand 2 and the distance from the portable terminal 1000 to the right hand 3, and calculates the distance L between the left hand 2 and the right hand 3 based on a difference between the two calculated distances.

In FIG. 46A, the distance L between the index finger of the right hand 3 used for rendering a line in midair and the left hand 2 is smaller than a first threshold value L0. In this case, the AR device 1004 (see FIG. 45) renders a “thin line” in midair in conjunction with the rendering using the index finger.

In FIG. 46B, the distance L between the index finger of the right hand 3 used for rendering a line in midair and the left hand 2 is larger than or equal to the first threshold value L0 but smaller than a second threshold value L1 (>L0). In this case, the AR device 1004 renders a “medium-thick line” in midair in conjunction with movement of the index finger.

In FIG. 46C, the distance L between the index finger of the right hand 3 used for rendering a line in midair and the left hand 2 is larger than or equal to the second threshold value L1. In this case, the AR device 1004 renders a “thick line” in midair in conjunction with movement of the index finger.

In this specific example, the user is capable of freely setting the reference position. Furthermore, as compared with a case where the portable terminal 10 (see FIGS. 14A to 14C) measures the distance L to the right hand 3 serving as a reference position, the movement of the index finger in the imaging direction during the rendering process may be readily reflected on the line thickness.

The first threshold value L0 and the second threshold value L1 used for the determination may be set before use by performing a calibration process. In the calibration process, the user 1 is prompted to perform a gesture in accordance with a guidance message, such as “please indicate distance between left hand and right hand when rendering thin line”. By setting threshold values for differentiating between distances L individually measured for different line thicknesses, lines with thicknesses desired by the user may be rendered.

The relationship between the detected distance L and the line thickness is not limited to the exemplified relationship. For example, a “thick line” may be rendered when the distance L is smaller than the first threshold value L0, and a “thin line” may be rendered when the distance L is larger than or equal to the second threshold value L1.

Furthermore, the types of thicknesses of lines to be rendered may be three or more types. The line thickness may be changed continuously in accordance with the distance L.

As an alternative to this specific example in which the line thickness is changed in accordance with the distance L, the line density may be changed.

### Second Specific Example

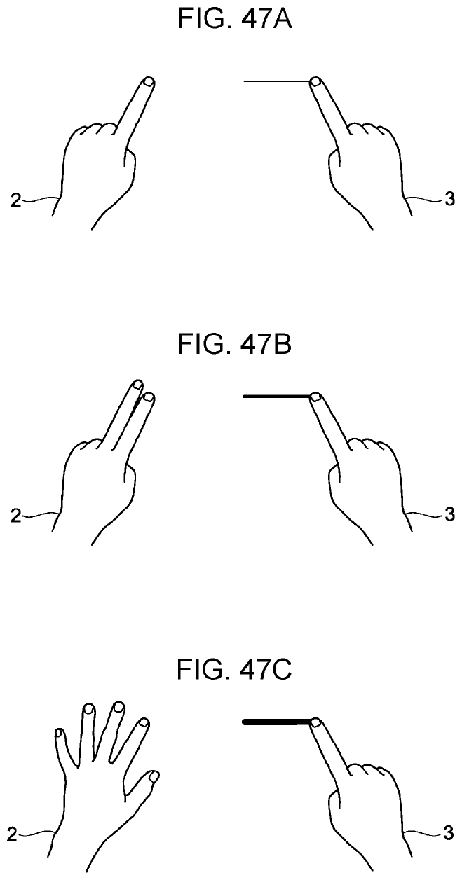

FIGS. 47A to 47C each illustrate a second specific example of a gesture used as a command for the thickness of a line to be rendered in the twelfth exemplary embodiment. Specifically, FIG. 47A illustrates an example of a gesture used as a command for a “thin line”, FIG. 47B illustrates an example of a gesture used as a command for a “medium-thick line”, and FIG. 47C illustrates an example of a gesture used as a command for a “thick line”.

In FIGS. 47A to 47C, the command for the thickness of the line is given in accordance with the number of fingers used in the left hand 2, and the command for the rendering of the line is given in accordance with movement of the index finger of the right hand 3.

The gesture in FIG. 47A involves pointing one finger, namely, the index finger, of the left hand 2 upward. This gesture corresponds to a command for a thin line. Therefore, a “thin line” is rendered in midair as the index finger of the right hand 3 is moved.

The gesture in FIG. 47B involves pointing two fingers, namely, the index finger and the middle finger, of the left hand 2 upward. This gesture corresponds to a command for a medium-thick line. Therefore, a “medium-thick line” is rendered in midair as the index finger of the right hand 3 is moved.

The gesture in FIG. 47C involves spreading out the five fingers of the left hand 2. This gesture corresponds to a command for a thick line. Therefore, a “thick line” is rendered in midair as the index finger of the right hand 3 is moved.

In this specific example, the left hand 2 is used for giving the line-thickness command. Therefore, the user may concentrate on the right hand 3 for the rendering.

The relationship between the number of fingers used in the left hand 2 and the line thickness is not limited to the exemplified relationship. For example, a “thick line” may be rendered when the number of fingers is one, and a “thin line” may be rendered when the number of fingers is five.

Furthermore, the types of thicknesses of lines to be rendered may be three or more types.

As an alternative to this specific example in which the line thickness is changed in accordance with the number of fingers used in the left hand 2 that is not used for rendering a line, the line density may be changed.

### Other Specific Examples

The method of giving a line-thickness command by using the left hand 2 may be combined with any of the methods in the first exemplary embodiment, including the method involving changing the distance between two fingers as described in the second specific example (see FIGS. 7A to 7C), the method involving changing the shape of a hand as described in the third specific example (see FIGS. 9A to 9C), the method involving changing the orientation of a finger as described in the fourth specific example (see FIGS. 10A to 10C), the method involving changing an area to be image-captured by rotating a wrist as described in the fifth specific example (see FIGS. 11A to 11C), the method involving changing the inclination of a finger in the imaging direction as described in the sixth specific example (see FIGS. 12A to 12C), the method involving changing how a fingernail appears as described in the seventh specific example (see FIGS. 13A to 13C), the method involving changing the distance L to the left hand 2 as described in the eighth specific example (see FIGS. 14A to 14C), the method involving changing a mark to be image-captured as described in the ninth specific example (see FIGS. 15A to 15C), the method involving changing the color of a mark to be image-captured as described in the tenth specific example (see FIGS. 16A to 16C), and the method involving changing the degree of muscle tension in the wrist of the left hand 2 as described in the eleventh specific example (see FIGS. 18A to 18C).

Furthermore, when a command for the line thickness or the line density is to be given by using the left hand 2, the user may receive feedback of the received line thickness or line density.

A command for the line thickness or the line density may be given in accordance with various orientations, relative to the imaging direction, of a rod-shaped member held with the left hand 2.

### Thirteenth Exemplary Embodiment

In a thirteenth exemplary embodiment, an operation performed on a button by using the left hand 2 is used for giving a command for the thickness of a line.

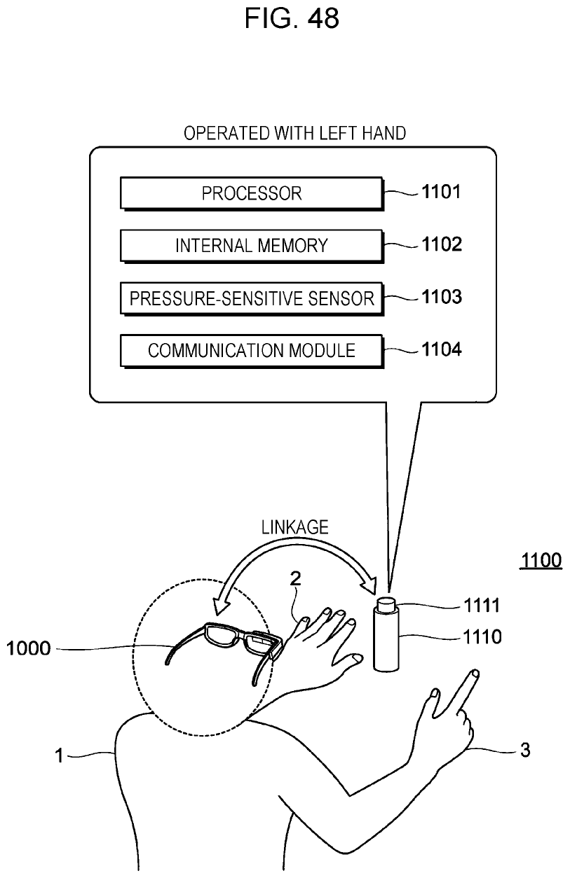

FIG. 48 illustrates a usage example of a portable terminal 1000 according to the thirteenth exemplary embodiment. In FIG. 48, sections corresponding to those in FIG. 45 are given the corresponding reference signs.

The portable terminal 1000 shown in FIG. 48 is different from that in the twelfth exemplary embodiment in that the portable terminal 1000 is linked with a push-button switch 1100 by wireless communication.

The push-button switch 1100 is constituted of a device unit 1110 and a push button 1111.

The push-button switch 1100 has a processor 1101, an internal memory 1102, a pressure-sensitive sensor 1103, and a communication module 1104 used for communicating with external apparatuses. One of the external apparatuses is the portable terminal 1000.

The processor 1101 is constituted of, for example, a CPU. The processor 1101 realizes various types of functions by executing applications and firmware.

The internal memory 1102 is a semiconductor memory. The internal memory 1102 has a ROM having a BIOS stored therein, and a RAM used as a principal storage device. The processor 1101 and the internal memory 1102 constitute a so-called computer. The processor 1101 uses the RAM as a work space for a program.

The pressure-sensitive sensor 1103 detects the pressing amount of the push button 1111. The pressure-sensitive sensor 1103 is merely an example and may be a simple switch that detects the number of times the push button 1111 is operated.

The communication module 1104 used is, for example, a USB-compliant communication module, a communication module compliant with Bluetooth (registered trademark), a communication module compliant with a mobile communication system, or a communication module compliant with a wireless LAN. The communication module 1104 according to this exemplary embodiment notifies the portable terminal 1000 of information related to the pressing amount detected by the pressure-sensitive sensor 1103.

In this exemplary embodiment, the user 1 operates the button 1111 of the push-button switch 1100 while rendering a line in midair with, for example, the index finger, so as to give a command for the thickness of the line being rendered. For example, a “thin line” is rendered if the pressing amount is small, a “medium-thick line” is rendered if the pressing amount is intermediate, and a “thick line” is rendered if the pressing amount is large.

Alternatively, a line-density command may be given in accordance with the amount by which the button 1111 of the push-button switch 1100 is operated.

As an alternative to this exemplary embodiment in which a line-thickness command is given using the freely-usable left hand 2, the line-thickness command may be given in accordance with the pressing amount of the pedal device 60 (see FIG. 35) as described in the eighth exemplary embodiment.

### Fourteenth Exemplary Embodiment

In the portable terminal 10 (see FIG. 1) or the portable terminal 1000 (see FIG. 45) according to any of the above exemplary embodiments, a command received during a line rendering process through a user's gesture is reflected on the line thickness or the line density. Alternatively, a process for rendering an AR image in midair may partially or entirely be executed in an external apparatus.

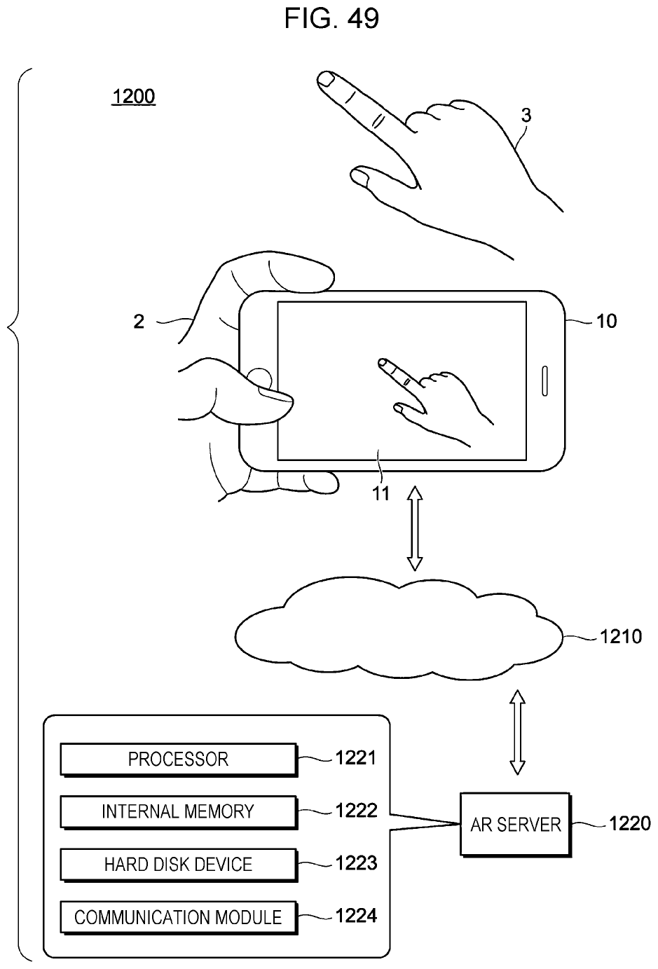

FIG. 49 illustrates an example of an AR system 1200 used in a fourteenth exemplary embodiment.

The AR system 1200 shown in FIG. 49 is constituted of a portable terminal 10, a network 1210, and an AR server 1220.

The network 1210 is, for example, a LAN or the Internet. For communication on the network 1210, a wireless USB, a mobile communication system, or WiFi (registered trademark) is used. The mobile communication system may be any one of a fourth generation (i.e., 4G) mobile communication system, a fifth generation (i.e., 5G) mobile communication system, and a sixth generation (i.e., 6G) mobile communication system. The wireless LAN uses, for example, any one of 11a, 11b, 11g, 11n, 11ac, 11ad, and 11ax of the IEEE 802.11 family.

The AR server 1220 has a processor 1221, an internal memory 1222, a hard disk device 1223, and a communication module 1224 used for communicating with an external apparatus. The AR server 1220 is an example of an information processing apparatus.

The processor 1221 is constituted of, for example, a CPU. The processor 1221 realizes various types of functions by executing applications and firmware.

The internal memory 1222 is a semiconductor memory. The internal memory 1222 has a ROM having a BIOS stored therein, and a RAM used as a principal storage device. The processor 1221 and the internal memory 1222 constitute a so-called computer. The processor 1221 uses the RAM as a work space for a program.

The hard disk device 1223 is an auxiliary storage device and stores programs therein.

The communication module 1224 used is, for example, a USB-compliant communication module, a communication module compliant with a mobile communication system, or a communication module compliant with a wireless LAN.

The mobile communication system according to this exemplary embodiment may be any one of a fourth generation (i.e., 4G) mobile communication system, a fifth generation (i.e., 5G) mobile communication system, and a sixth generation (i.e., 6G) mobile communication system.

The AR server 1220 used in this exemplary embodiment receives an image including a user's gesture from the portable terminal 10 and determines the thickness and direction of a line to be rendered in midair as an AR image. Moreover, the AR server 1220 notifies the portable terminal 10 of the generated AR image and the absolute coordinates at which the AR image is to be rendered. Accordingly, a line is rendered in midair as an AR image in front of the user.

Although the portable terminal 10 is used in FIG. 49, the portable terminal 1000 worn on the head may be used as an alternative.

Moreover, if the pedal device 60 (see FIG. 35) or the push-button switch 1100 (see FIG. 48) is to be used for giving a line-thickness command or a line-density command, the AR server 1220 may be notified of information about an operation performed thereon. The AR server 1220 may be a cloud server or an on-premises server. The AR server 1220 may provide a function for rendering an AR image in midair as a cloud service.

### Other Exemplary Embodiments

Although exemplary embodiments of the disclosure have been described above, the technical scope of the disclosure is not limited to the above exemplary embodiments. It is clear from the scope of the claims that exemplary embodiments obtained by adding various modifications or alterations to the above exemplary embodiments are included in the technical scope of the disclosure.

In the above exemplary embodiments, an AR image is rendered in accordance with a gesture. Alternatively, an image to be rendered may be a mixed reality (MR) image. An MR image has a higher degree of fusion with the real world than an AR image. Therefore, an MR image is recognizable simultaneously by multiple users from multiple directions.

In the above exemplary embodiments, the orientation of the index finger is used for giving a line-thickness command or a line-density command. Alternatively, a body part to be used for giving a command may be, for example, a foot, the head, the waist, or an arm. For example, the various types of devices shown in FIGS. 23A to 23F may be used for giving a line-thickness command or a line-density command.

In one of the above exemplary embodiments, the wearable terminal 20 (see FIG. 17) is described as an example of a device worn on a hand during rendering. Alternatively, a ring-type wearable terminal may be used.

In the above exemplary embodiments, a line-thickness command or a line-density command is given in accordance with the degree of opening between fingers. Alternatively, a line-thickness command or a line-density command may be given in accordance with the degree of bending of a finger or fingers during rendering. For example, when the index finger of the right hand is used for rendering a line in midair, the degree of bending of the middle finger of the right hand may be adjusted in three levels, namely, “straightened out”, “slightly bent”, and “completely bent”, thereby adjusting the thickness or density of the line. Furthermore, for example, when the index finger of the right hand is used for rendering a line in midair, the degree of bending of the middle finger of the left hand may be adjusted in three levels, namely, “straightened out”, “slightly bent”, and “completely bent”, thereby adjusting the thickness or density of the line. The expression “completely bent” refers to a state where the finger is bent to an extent that the fingertip thereof is close to the palm of the hand. The degree of bending is not limited to the above-described example so long as it is determinable from an image captured by the camera 12.

Likewise, when a line is to be rendered in midair while a physical object, such as a pen-like device, is being held, a finger or fingers of the hand holding the device or a finger or fingers of the hand not holding the device may be bent to adjust the thickness or density of the line.

In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The exemplary embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
detect a command for a thickness or a density of a line or a group of lines being rendered while a user is rendering the line or the group of lines in midair by using a gesture, and
store the detected thickness or the detected density in association with a trajectory.

2. The information processing apparatus according to claim 1, wherein the processor is configured to detect a command for a direction of the line being rendered while the line or the group of lines is being rendered.

3. The information processing apparatus according to claim 2, wherein the processor is configured to detect movement of the user giving the command for the thickness or the density of the line from a captured image of the user performing the rendering.

4. The information processing apparatus according to claim 3, wherein the processor is configured to detect, from the image, a specific motion appearing in a hand used for the rendering.

5. The information processing apparatus according to claim 4, wherein the processor is configured to determine the thickness or the density of the line or the group of lines in accordance with an orientation of a finger used for rendering the line, the orientation of the finger being detected from the image.

6. The information processing apparatus according to claim 1, wherein the processor is configured to
detect a feature appearing at a tip of a physical object used for the rendering, and
determine the thickness or the density of the line or the group of lines in accordance with the detected feature.

7. The information processing apparatus according to claim 6, wherein the feature is a structure, an image, text, a shape, a color, or a combination thereof for designating the thickness or the density of the line or the group of lines, and wherein the thickness or the density of the line or the group of lines is determined in accordance with the feature detected during the rendering.

8. The information processing apparatus according to claim 1, wherein the processor is configured to determine the thickness or the density of the line or the group of lines in accordance with a specific motion appearing at a hand not used for rendering the line or the group of lines, the specific motion being detected from a captured image of the user performing the rendering.

9. The information processing apparatus according to claim 8, wherein the processor is configured to determine the thickness or the density of the line or the group of lines in accordance with an orientation of an area of a body not used for rendering the line or the group of lines.

10. The information processing apparatus according to claim 1, wherein the processor is configured to determine the thickness or the density of the line or the group of lines in accordance with a distance to a hand used for the rendering in front of the user.

11. The information processing apparatus according to claim 1, wherein the processor is configured to
detect a position of a hand not used for rendering the line or the group of lines as a reference position in a depth direction, and
determine the thickness or the density of the line or the group of lines in accordance with a positional relationship that a physical object used for the rendering has with the reference position in the depth direction.

12. The information processing apparatus according to claim 1, wherein the processor is configured to determine the thickness or the density of the line or the group of lines in accordance with information detected by a device worn on a hand used for the rendering.

13. The information processing apparatus according to claim 1, wherein the processor is configured to detect a specific motion as the command for the thickness or the density of the line or the group of lines, the specific motion being detected from a captured image of the user performing the rendering and appearing at a physical object used for the rendering.

14. The information processing apparatus according to claim 13, wherein the processor is configured to determine the thickness or the density of the line or the group of lines in accordance with an orientation of the physical object detected from the image.

15. The information processing apparatus according to claim 13, wherein the processor is configured to determine the thickness or the density of the line or the group of lines in accordance with information detected by a device worn on a hand used for the rendering by the physical object.

16. The information processing apparatus according to claim 1, wherein the processor is configured to detect movement of the user giving the command for the thickness or the density of the line or the group of lines based on information detected by a sensor of a rod-shaped physical object used for the rendering.

17. The information processing apparatus according to claim 16, wherein the processor is configured to determine the thickness or the density of the line or the group of lines in accordance with pressure detected by the sensor.

18. The information processing apparatus according to claim 17, wherein the processor is configured to detect the thickness or the density in accordance with pressure from a specific direction.

19. The information processing apparatus according to claim 16, wherein the processor is configured to determine the thickness or the density of the line or the group of lines in accordance with acceleration detected by the sensor.

20. A non-transitory computer readable medium storing a program causing a computer to execute a process for processing information, the process comprising:
detecting a command for a thickness or a density of a line or a group of lines being rendered while a user is rendering the line or the group of lines in midair by using a gesture; and
storing the detected thickness or the detected density in association with a trajectory.
